(19) United States
(12) Patent Application Publication
(10) Pub. No.: US 2013/0041119 A1
(43) Pub. Date: Feb. 14, 2013

(54) OLEFIN POLYMER PRODUCING METHOD, ETHYLENE POLYMER, AND MOLD PRODUCT

(71) Applicants: Naoko OCHI, Ichihara-shi (JP); Yoshinobu NOZUE, Ichihara-shi (JP)

(72) Inventors: Naoko OCHI, Ichihara-shi (JP); Yoshinobu NOZUE, Ichihara-shi (JP)

(73) Assignee: SUMITOMO CHEMICAL COMPANY, LIMITED, Tokyo (JP)

(21) Appl. No.: 13/570,338

(22) Filed: Aug. 9, 2012

(30) Foreign Application Priority Data
Aug. 11, 2011 (JP) 2011-175678

(51) Int. Cl. C08F 10/02; C08F 10/08; C08F 10/14; C08F 10/06

(52) U.S. Cl. 526/117; 526/113; 526/352

(57) ABSTRACT

A method for producing an olefin polymer, including: polymerizing olefin monomers using the following substance (A1), the following substance (A2), and an activating agent (B):

the substance (A1): a complex represented by the following general formula (1-1) or (1-2)

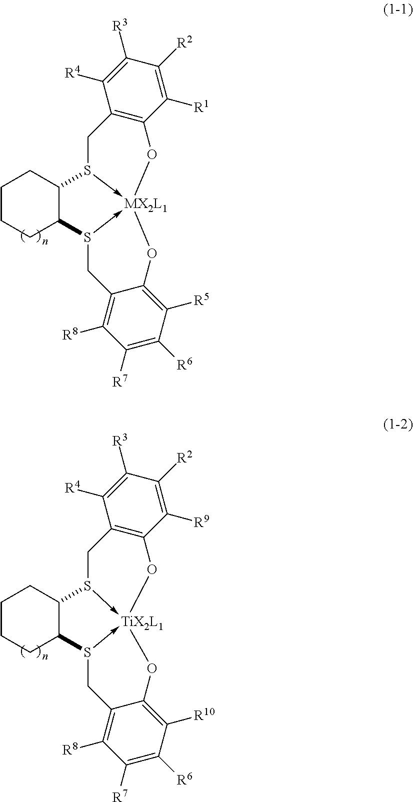

the substance (A2): a transition metal compound represented by the following general formula (8) or a μ-oxo-type dimer of a transition metal compound represented by the general formula (8)

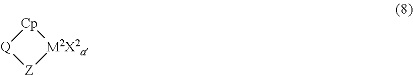

This Nonprovisional application claims priority under 35 U.S.C. §119 on Patent Application No. 2011-175678 filed in Japan on Aug. 11, 2011, the entire contents of which are hereby incorporated by reference.

### TECHNICAL FIELD

The present invention relates to a method for producing an olefin polymer, an ethylene-based polymer, and an article which is obtained by extruding the ethylene-based polymer.

### BACKGROUND ART

An olefin polymer such as polyethylene and polypropylene is widely used for various articles due to its excellent mechanical properties etc. and low cost.

Conventionally, a technique of using a catalyst containing (i) a transition metal component comprising a transition metal compound (e.g., a metallocene complex or a non-metallocene compound) and (ii) an organic metal component comprising an aluminoxane and the like has been known as a method for producing an olefin polymer. For example, there have been disclosed a method of polymerizing olefin monomers in the presence of a catalyst containing two metallocene complexes (Patent Literature 1) and a method of polymerizing olefine monomers in the presence of a catalyst containing (i) two metallocene complexes or (ii) a bisphenoxyimine complex and a metallocene complex (Patent Literature 2).

However, the catalysts for polymerizing olefin monomers are not good enough in terms of obtaining an olefin polymer having excellent moldability.

### CITATION LIST

### Patent Literatures

### Patent Literature 1

Japanese Patent Application Publication, Tokukai, No. 2006-321991 A

### Patent Literature 2

Japanese Patent Application Publication, Tokukai, No. 2006-233208 A

### SUMMARY OF INVENTION

### Technical Problem

In view of the problem, an object of the present invention is to provide (i) a method for producing an olefin polymer which has excellent moldability, (ii) an ethylene-based polymer which has excellent moldability, and (iii) an article which is obtained by extruding the ethylene-based polymer.

### Solution to Problem

The present invention relates to a method for producing an olefin polymer, the method comprising:
polymerizing olefin monomers using the following substance (A1), the following substance (A2), and an activating agent (B),
the substance (A1) being a complex represented by the following general formula (1-1) or (1-2),

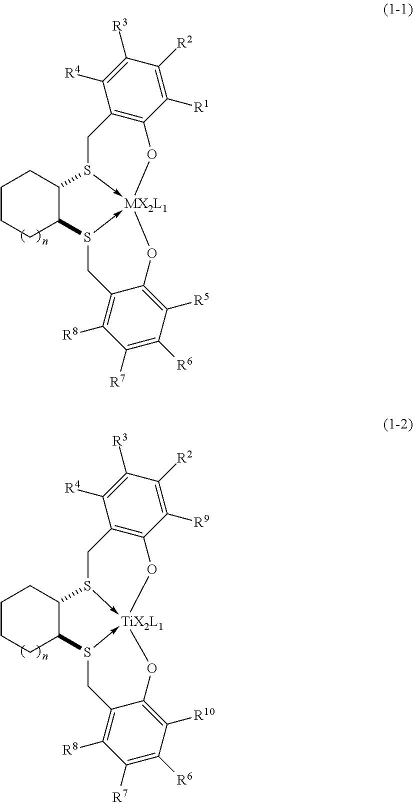

where:
n is 1, 2, or 3;
M is a zirconium atom or a hafnium atom;
R¹ and R⁵ are independently:
   a hydrogen atom,
   a halogen atom,
   an alkyl group having 1 to 20 carbon atoms,
   a cycloalkyl group having 3 to 10 ring carbon atoms,
   an alkenyl group having 2 to 20 carbon atoms,
   an alkynyl group having 2 to 20 carbon atoms,
   an aralkyl group having 7 to 30 carbon atoms,
   an alkoxy group having 1 to 20 carbon atoms,
   an aralkyloxy group having 7 to 30 carbon atoms,
an aryloxy group having 6 to 30 carbon atoms, or
a substituted silyl group;
R² to R⁴ and R⁶ to R¹⁰ are independently
   a hydrogen atom,
   a halogen atom,
   an alkyl group having 1 to 20 carbon atoms,
   a cycloalkyl group having 3 to 10 ring carbon atoms,
   an alkenyl group having 2 to 20 carbon atoms,
   an alkynyl group having 2 to 20 carbon atoms,
   an aralkyl group having 7 to 30 carbon atoms,
   an aryl group having 6 to 30 carbon atoms,
   an alkoxy group having 1 to 20 carbon atoms,
   an aralkyloxy group having 7 to 30 carbon atoms,
   an aryloxy group having 6 to 30 carbon atoms,
   a substituted silyl group, or
   a heterocyclic compound residue having 3 to 20 ring carbon atoms;
the alkyl groups, the cycloalkyl groups, the alkenyl groups, the alkynyl groups, the aralkyl groups, the aryl groups, the alkoxy groups, the aralkyloxy groups, the aryloxy groups, and the heterocyclic compound residues represented by R¹ to R¹⁰ each may have a substituent;
notwithstanding the above definitions of R¹ to R¹⁰, at least one pair of groups selected from among the following pairs, R¹ and R², R² and R³, R³ and R⁴, R⁵ and R⁶, R⁶ and R⁷, R⁷ and R⁸, R² and R⁹, and R⁶ and R¹⁰, may be linked to form a ring which may have a substituent;
each x is independently:
   a hydrogen atom,
   a halogen atom,
   an alkyl group having 1 to 20 carbon atoms,
   a cycloalkyl group having 3 to 10 ring carbon atoms,
   an alkenyl group having 2 to 20 carbon atoms,
   an aralkyl group having 7 to 30 carbon atoms,
   an aryl group having 6 to 30 carbon atoms,
   an alkoxy group having 1 to 20 carbon atoms,
   an aralkyloxy group having 7 to 30 carbon atoms,
   an aryloxy group having 6 to 30 carbon atoms,
   a substituted silyl group,
   a substituted amino group,
   a substituted thiolate group, or
   a carboxylato group having 1 to 20 carbon atoms;
the alkyl group, the cycloalkyl group, the alkenyl group, the aralkyl group, the aryl group, the alkoxy group, the aralkyloxy group, and the aryloxy group represented by X may have a substituent;
adjacent X groups may be linked to each other to form a ring;
L is independently a neutral Lewis base, and 1 is 0, 1, or 2; when 1 is 2, the L groups are the same or different, and
the substance (A2) being a transition metal compound represented by the general formula (8) or a μ-oxo-type dimer of a transition metal compound represented by the general formula (8):

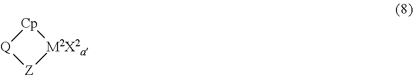

where:
M² is a transition metal atom of any of Groups 4 to 11 of the periodic table of the elements;
Cp is a group having a cyclopentadienide skeleton, and Z is a group having a cyclopentadienide skeleton or a group containing a hetero atom;
Q is a bridging group which links a cyclopentadienyl group to Z; Cp and Z are the same or different when each of Cp and Z is a group having a cyclopentadienide skeleton;
each X² is independently:
   a hydrogen atom,
   a halogen atom,
   an alkyl group having 1 to 20 carbon atoms,
   a cycloalkyl group having 3 to 10 ring carbon atoms,
   an alkenyl group having 2 to 20 carbon atoms,
   an aralkyl group having 7 to 30 carbon atoms,
   an aryl group having 6 to 30 carbon atoms,
   an alkoxy group having 1 to 20 carbon atoms,
   an aralkyloxy group having 7 to 30 carbon atoms,
   an aryloxy group having 6 to 30 carbon atoms,
   a substituted silyl group,
   a substituted amino group,
   a substituted thiolate group, or
   a carboxylato group having 1 to 20 carbon atoms; and
   a′ is a number which satisfies 1≦a′≦3.

Furthermore, the present invention relates to an ethylene-based polymer that satisfies the following requirements (1) to (5):
(1) the density is 850 to 980 kg/m³;
(2) the melt flow rate is within the range of 0.01 to 100 g/10 min, where the melt flow rate is measured by method A provided in JIS K7210-1995 at a temperature of 190° C. and under an applied load of 21.18 N;
(3) the molecular weight distribution curve measured by gel permeation chromatography has bimodal molecular weight distribution, the molecular weight distribution curve exhibiting a higher molecular weight peak having a peak top molecular weight of 50,000 or more, and a lower molecular weight peak having a peak top molecular weight of 10,000 or less;
(4) the weight-average molecular weight to number-average molecular weight ratio is from 4 to 55; and
(5) the number of branches having 5 or more carbon atoms measured by ¹³C-NMR is 0.2 to 0.7 per 1000 carbon atoms.

The present invention also relates to an article produced by extruding the ethylene-based polymer.

### ADVANTAGEOUS EFFECTS OF INVENTION

The present invention enables production of an olefin polymer which has excellent moldability.

### DESCRIPTION OF EMBODIMENTS

In the present invention, the term “polymerization” encompasses copolymerization as well as homopolymerization, and the term “polymer” encompasses copolymer as well as homopolymer.

Substance (A1)

The following description will discuss a substance (A1).

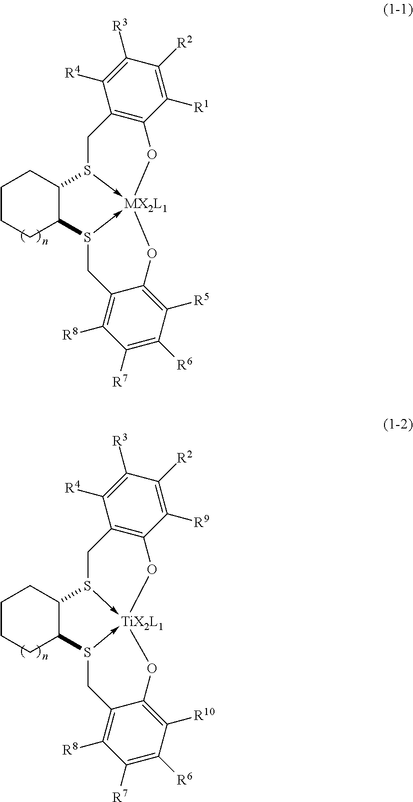

M represents a zirconium atom or a hafnium atom.
n is 1, 2 or 3, and preferably 2 or 3.

It is preferable that R¹ and R⁵ be independently
a hydrogen atom,
a halogen atom,
an alkyl group having 1 to 20 carbon atoms,
a cycloalkyl group having 3 to 10 ring carbon atoms,
an aralkyl group having 7 to 30 carbon atoms,
an alkoxy group having 1 to 20 carbon atoms,
an aralkyloxy group having 7 to 30 carbon atoms,
an aryloxy group having 6 to 30 carbon atoms, or
a substituted silyl group.

It is more preferable that R¹ and R⁵ be independently
a halogen atom,
an alkyl group having 1 to 20 carbon atoms,
a cycloalkyl group having 3 to 10 ring carbon atoms,
an aralkyl group having 7 to 30 carbon atoms,
a substituted silyl group.

It is still more preferable that R¹ and R⁵ be the same and be
an alkyl group having 1 to 20 carbon atoms,
a cycloalkyl group having 3 to 10 ring carbon atoms,
an aralkyl group having 7 to 30 carbon atoms, or
a substituted silyl group.

It is preferable that R⁹ and R¹⁰ be independently
a halogen atom,
an alkyl group having 1 to 20 carbon atoms,
a cycloalkyl group having 3 to 10 ring carbon atoms,
an aralkyl group having 7 to 30 carbon atoms,
an aryl group having 6 to 30 carbon atoms,
a substituted silyl group, or
a heterocyclic compound residue having 3 to 20 carbon atoms.

It is more preferable that R⁹ and R¹⁰ be independently
an alkyl group having 1 to 20 carbon atoms,
a cycloalkyl group having 3 to 10 ring carbon atoms,
an aralkyl group having 7 to 30 carbon atoms,
an aryl group having 6 to 30 carbon atoms, or
a heterocyclic compound residue having 3 to 20 carbon atoms.

It is still more preferable that R⁹ and R¹⁰ be the same and be
an alkyl group having 1 to 20 carbon atoms,
a cycloalkyl group having 3 to 10 ring carbon atoms,
an aralkyl group having 7 to 30 carbon atoms,
an aryl group having 6 to 30 carbon atoms, or
a heterocyclic compound residue having 3 to 20 carbon atoms.

It is preferable that R² to R⁴ and R⁶ to R⁸ be independently
a hydrogen atom,
a halogen atom,
an alkyl group having 1 to 20 carbon atoms,
a cycloalkyl group having 3 to 10 ring carbon atoms,
an aralkyl group having 7 to 30 carbon atoms,
an aryl group having 6 to 30 carbon atoms,
an alkoxy group having 1 to 20 carbon atoms,
an aryloxy group having 6 to 30 carbon atoms,
a substituted silyl group.

It is more preferable that R² to R⁴ and R⁶ to R⁸ be independently
a hydrogen atom,
an alkyl group having 1 to 20 carbon atoms,
a cycloalkyl group having 3 to 10 ring carbon atoms,
an aralkyl group having 7 to 30 carbon atoms,
an aryl group having 6 to 30 carbon atoms, or
a substituted silyl group.

It is more preferable that R², R⁴, R⁶ and R⁸ be a hydrogen atom.

It is more preferable that R³ and R⁷ be independently
an alkyl group having 1 to 20 carbon atoms,
a cycloalkyl group having 3 to 10 ring carbon atoms,
an aralkyl group having 7 to 30 carbon atoms,
an aryl group having 6 to 30 carbon atoms, or
a substituted silyl group.

It is still more preferable that R³ and R⁷ be the same and be
an alkyl group having 1 to 20 carbon atoms,
a cycloalkyl group having 3 to 10 ring carbon atoms,
an aralkyl group having 7 to 30 carbon atoms,
an aryl group having 6 to 30 carbon atoms, or
a substituted silyl group,
most preferably
an alkyl group having 1 to 20 carbon atoms.

The alkyl groups, the cycloalkyl groups, the aralkyl groups, the aryl groups, the alkoxy groups, the aralkyloxy groups, the aryloxy groups, and the heterocyclic compound residues represented by R¹ to R¹¹ each may have a substituent.

Examples of the halogen atom of R¹ to R¹⁰ include a fluorine atom, a chlorine atom, a bromine atom, and an iodine atom.

Examples of the substituted or unsubstituted alkyl group having 1 to 20 carbon atoms of R¹ to R¹⁰ include perfluoromethyl group, perfluoroethyl group, perfluoro-n-propyl group, perfluoroisopropyl group, perfluoro-n-butyl group, perfluoro-sec-butyl group, perfluoroisobutyl group, perfluoro-tert-butyl group, perfluoro-n-pentyl group, perfluoroisopentyl group, perfluoro-tert-pentyl group, perfluoroneopentyl group, perfluoro-n-hexyl group, perfluoro-n-heptyl group, perfluoro-n-octyl group, perfluoro-n-decyl group, perfluoro-n-dodecyl group, perfluoro-n-pentadecyl group, perfluoro-n-eicosyl group, methyl group, ethyl group, n-propyl group, isopropyl group, n-butyl group, sec-butyl group, isobutyl group, tert-butyl group, n-pentyl group, isopentyl group, tert-pentyl group, neopentyl group, n-hexyl group, thexyl group, neohexyl group, n-heptyl group, n-octyl group, n-decyl group, n-dodecyl group, n-pentadecyl group, or n-eicosyl group.

The substituted or unsubstituted alkyl group having 1 to 20 carbon atoms of R¹, R⁵, R⁹, and R¹¹ is preferably an alkyl group having 4 to 10 carbon atoms such as n-butyl group, sec-butyl group, isobutyl group, tert-butyl group, n-pentyl group, isopentyl group, tert-pentyl group, neopentyl group, n-hexyl group, thexyl group, neohexyl group, n-heptyl group, n-octyl group, or n-decyl group, more preferably an alkyl group having 4 to 6 carbon atoms such as n-butyl group, sec-butyl group, isobutyl group, tert-butyl group, n-pentyl group, isopentyl group, tert-pentyl group, neopentyl group, or thexyl group, further more preferably a tertiary alkyl group having 4 to 6 carbon atoms such as tert-butyl group, tert-pentyl group, or thexyl group.

The substituted or unsubstituted alkyl group having 1 to 20 carbon atoms of R² to R⁴ and R⁶ to R⁸ is preferably an alkyl group having 1 to 10 carbon atoms such as perfluoromethyl group, methyl group, ethyl group, n-propyl group, isopropyl group, n-butyl group, sec-butyl group, isobutyl group, tert-butyl group, n-pentyl group, isopentyl group, tert-pentyl group, neopentyl group, n-hexyl group, thexyl group, neohexyl group, n-heptyl group, n-octyl group, or n-decyl group, more preferably an alkyl group having 1 to 8 carbon atoms such as perfluoromethyl group, methyl group, isopropyl group, isobutyl group, tert-butyl group, isopentyl group, tert-pentyl group, neopentyl group, or thexyl group, further more preferably an alkyl group having 1 to 4 carbon atoms such as perfluoromethyl group, methyl group, isopropyl group, isobutyl group, or tert-butyl group.

Examples of the substituted or unsubstituted cycloalkyl group having 3 to 10 ring carbon atoms of R¹ to R¹⁰ include cyclopropyl group, cyclobutyl group, cyclopentyl group, cyclohexyl group, cycloheptyl group, cyclooctyl group, 1-methylcyclopentyl group, 1-methylcyclohexyl group, 1-phenylcyclohexyl group, 1-indanyl group, 2-indanyl group, norbornyl group, bornyl group, menthyl group, 1-adamantyl group, or 2-adamantyl group. The substituted or unsubstituted cycloalkyl group having 3 to 10 ring carbon atoms of R¹ to R¹⁰ is preferably a cycloalkyl group having 5 to 10 ring carbon atoms, such as cyclopentyl group, cyclohexyl group, cycloheptyl group, cyclooctyl group, 1-methylcyclopentyl group, 1-methylcyclohexyl group, 1-indanyl group, 2-indanyl group, norbornyl group, bornyl group, menthyl group, 1-adamantyl group, or 2-adamantyl group, more preferably a cycloalkyl group having 6 to 10 ring carbon atoms, such as cyclohexyl group, 1-methylcyclohexyl group, norbornyl group, bornyl group, 1-adamantyl group, or 2-adamantyl group. These cycloalkyl groups may have, as a substituent, a hydrocarbyl group having 1 to 10 carbon atoms.

Examples of the substituted or unsubstituted alkenyl group having 2 to 20 carbon atoms of R¹ to R¹⁰ include vinyl group, allyl group, propenyl group, 2-methyl-2-propenyl group, homoallyl group, pentenyl group, hexenyl group, heptenyl group, octenyl group, nonenyl group, or decenyl group, and preferably an alkenyl group having 3 to 6 carbon atoms, more preferably an allyl group or a homoallyl group.

Examples of the substituted or unsubstituted alkynyl group having 2 to 20 carbon atoms of R¹ to R¹⁰ is include ethynyl group, 1-propynyl group, 2-propynyl group, 1-butynyl group, 3-methyl-1-butynyl group, 3,3-dimethyl-1-butynyl group, 2-butynyl group, 3-butynyl group, 1-pentynyl group, 4-methyl-1-pentynyl group, 2-pentynyl group, 3-pentynyl group, 4-pentynyl group, 4-methyl-1-pentenyl group, 1-hexynyl group, 1-octynyl group, or phenylethynyl group, and preferably an alkynyl group having 3 to 8 carbon atoms, more preferably 3-methyl-1-butynyl group, 3,3-dimethyl-1-butynyl group, 4-methyl-1-pentenyl group, or phenylethynyl group.

Examples of the substituted or unsubstituted aralkyl group having 7 to 30 carbon atoms of R¹ to R¹⁰ include benzyl group, (2-methylphenyl)methyl group, (3-methylphenyl)methyl group, (4-methylphenyl)methyl group, (2,3-dimethylphenyl)methyl group, (2,4-dimethylphenyl)methyl group, (2,5-dimethylphenyl)methyl group, (2,6-dimethylphenyl)methyl group, (3,4-dimethylphenyl)methyl group, (3,5-dimethylphenyl)methyl group, (2,3,4-trimethylphenyl)methyl group, (2,3,5-trimethylphenyl)methyl group, (2,3,6-trimethylphenyl)methyl group, (3,4,5-trimethylphenyl)methyl group, (2,4,6-trimethylphenyl)methyl group, (2,3,4,5-tetramethylphenyl)methyl group, (2,3,4,6-tetramethylphenyl)methyl group, (2,3,5,6-tetramethylphenyl)methyl group, (pentamethylphenyl)methyl group, (ethylphenyl)methyl group, (n-propylphenyl)methyl group, (isopropylphenyl)methyl group, (n-butylphenyl)methyl group, (sec-butylphenyl)methyl group, (tert-butylphenyl)methyl group, (isobutylphenyl)methyl group, (n-pentylphenyl)methyl group, (neopentylphenyl)methyl group, (n-hexylphenyl)methyl group, (n-octylphenyl)methyl group, (n-decylphenyl)methyl group, naphthylmethyl group, anthracenylmethyl group, dimethyl(phenyl)methyl group, dimethyl(4-methylphenyl)methyl group, dimethyl(1-naphthyl)methyl group, dimethyl(2-naphthyl)methyl group, methyl(diphenyl)methyl group, methylbis(4-methylphenyl)methyl group, or triphenylmethyl group, and preferably benzyl group, naphthylmethyl group, anthracenylmethyl group, dimethyl(phenyl)methyl group, dimethyl(4-methylphenyl)methyl group, dimethyl(1-naphthyl)methyl group, dimethyl(2-naphthyl)methyl group, methyl(diphenyl)methyl group, methylbis(4-methylphenyl)methyl group, or triphenylmethyl group, more preferably a tertiary aralkyl group having 9 to 20 carbon atoms such as dimethyl(phenyl)methyl group, dimethyl(4-methylphenyl)methyl group, dimethyl(1-naphthyl)methyl group, dimethyl(2-naphthyl)methyl group, methyl(diphenyl)methyl group, methylbis(4-methylphenyl)methyl group, or triphenylmethyl group.

Examples of the substituted or unsubstituted aryl group having 6 to 30 carbon atoms of R² to R⁴ and R⁶ to R¹ include phenyl group, 2-tolyl group, 3-tolyl group, 4-tolyl group, 2,3-xylyl group, 2,4-xylyl group, 2,5-xylyl group, 2,6-xylyl group, 3,4-xylyl group, 3,5-xylyl group, 2,3,4-trimethylphenyl group, 2,3,5-trimethylphenyl group, 2,3,6-trimethylphenyl group, 2,4,6-trimethylphenyl group, 3,4,5-trimethylphenyl group, 2,3,4,5-tetramethylphenyl group, 2,3,4,6-tetramethylphenyl group, 2,3,5,6-tetramethylphenyl group, pentamethylphenyl group, ethylphenyl group, n-propylphenyl group, isopropylphenyl group, n-butylphenyl group, sec-butylphenyl group, tert-butylphenyl group, isobutylphenyl group, n-pentylphenyl group, neopentylphenyl group, n-hexylphenyl group, n-octylphenyl group, n-decylphenyl group, n-dodecylphenyl group, n-tetradecylphenyl group, naphthyl group, anthracenyl group, 3,5-diisopropylphenyl group, 2,6-diisopropylphenyl group, 3,5-ditert-butylphenyl group, 2-fluorophenyl group, 3-fluorophenyl group, 4-fluorophenyl group, pentafluorophenyl group, 2-trifluoromethylphenyl group, 3-trifluoromethylphenyl group, 4-trifluoromethylphenyl group, 2,3-difluorophenyl group, 2,4-difluorophenyl group, 2,5-difluorophenyl group, 2,6-difluorophenyl group, 2-chlorophenyl group, 2,3-dichlorophenyl group, 2,4-dichlorophenyl group, 2,5-dichlorophenyl group, 2-bromophenyl group, 3-bromophenyl group, 4-bromophenyl group, 2,3-dibromophenyl group, 2,4-dibromophenyl group, or 2,5-dibromophenyl group, and preferably a phenyl group having 6 to 20 carbon atoms such as phenyl group, 2-tolyl group, 3-tolyl group, 4-tolyl group, 2,3-xylyl group, 2,4-xylyl group, 2,5-xylyl group, 2,6-xylyl group, 3,4-xylyl group, 3,5-xylyl group, 2,3,4-trimethylphenyl group, 2,3,5-trimethylphenyl group, 2,3,6-trimethylphenyl group, 2,4,6-trimethylphenyl group, 3,4,5-trimethylphenyl group, ethylphenyl group, n-propylphenyl group, isopropylphenyl group, 3,5-diisopropylphenyl group, 2,6-diisopropylphenyl group, or 3,5-ditert-butylphenyl group; a fluorinated phenyl group such as 2-fluorophenyl group, 3-fluorophenyl group, 4-fluorophenyl group, pentafluorophenyl group, 2,3-difluorophenyl group, 2,4-difluorophenyl group, 2,5-difluorophenyl group, or 2,6-difluorophenyl group; or a fluorinated alkylphenyl group such as 2-trifluoromethylphenyl group, 3-trifluoromethylphenyl group, or 4-trifluoromethylphenyl group, more preferably phenyl group, 2-tolyl group, 3-tolyl group, 4-tolyl group, 2,6-xylyl group, 3,5-xylyl group, 2,4,6-trimethylphenyl group, 3,5-diisopropylphenyl group, 2,6-diisopropylphenyl group, 3,5-ditert-butylphenyl group, 2-fluorophenyl group, pentafluorophenyl group, 2,3-difluorophenyl group, 2,4-difluorophenyl group, 2,5-difluorophenyl group, 2,6-difluorophenyl group, or 2,4,6-trifluorophenyl group.

Examples of the substituted silyl group of R¹ to R¹⁰ include trimethylsilyl group, triethylsilyl group, tri-n-propylsilyl group, triisopropylsilyl group, tri-n-butylsilyl group, triisobutylsilyl group, tert-butyldimethylsilyl group, methyldiphenylsilyl group, dimethyl(phenyl)silyl group, tert-butyldiphenylsilyl group, triphenylsilyl group, methylbis(trimethylsilyl)silyl group, dimethyl(trimethylsilyl)silyl group, or tris(trimethylsilyl)silyl group, and preferably a trialkylsilyl group having 3 to 20 carbon atoms such as trimethylsilyl group, triethylsilyl group, tri-n-propylsilyl group, triisopropylsilyl group, or tert-butyldimethylsilyl group; or silyl group having, a hydrocarbylsilyl group having 3 to 20 carbon atoms as a substituent, such as methylbis(trimethylsilyl)silyl group, dimethyl(trimethylsilyl)silyl group, or tris(trimethylsilyl)silyl group.

Examples of the substituted or unsubstituted alkoxy group having 1 to 20 carbon atoms of R¹ to R¹⁰ include perfluoromethoxy group, perfluoroethoxy group, perfluoro-n-propoxy group, perfluoroisopropoxy group, perfluoro-n-butoxy group, perfluoro-sec-butoxy group, perfluoroisobutoxy group, perfluoro-n-pentyloxy group, perfluoroneopentyloxy group, perfluoro-n-hexyloxy group, perfluoro-n-heptyloxy group, perfluoro-n-octyloxy group, perfluoro-n-decyloxy group, perfluoro-n-dodecyloxy group, perfluoro-n-pentadecyloxy group, perfluoro-n-eicosyloxy group, methoxy group, ethoxy group, n-propoxy group, isopropoxy group, n-butoxy group, sec-butoxy group, isobutoxy group, n-pentyloxy group, neopentyloxy group, n-hexyloxy group, n-heptyloxy group, n-octyloxy group, n-decyloxy group, n-dodecyloxy group, n-pentadecyloxy group, or n-eicosyloxy group, and preferably an alkoxy group having 1 to 4 carbon atoms, more preferably methoxy group, ethoxy group, n-propoxy group, isopropoxy group, or n-butoxy group.

Examples of the aryloxy group having 6 to 30 carbon atoms of R¹ to R¹⁰ include phenoxy group, 2,3,4-trimethylphenoxy group, 2,3,5-trimethylphenoxy group, 2,3,6-trimethylphenoxy group, 2,4,6-trimethylphenoxy group, 3,4,5-trimethylphenoxy group, 2,3,4,5-tetramethylphenoxy group, 2,3,4,6-tetramethylphenoxy group, 2,3,5,6-tetramethylphenoxy group, pentamethylphenoxy group, 2,6-diisopropylphenoxy group, 2-fluorophenoxy group, 3-fluorophenoxy group, 4-fluorophenoxy group, pentafluorophenoxy group, 2-trifluoromethylphenoxy group, 3-trifluoromethylphenoxy group, 4-trifluoromethylphenoxy group, 2,3-difluorophenoxy group, 2,4-fluorophenoxy group, 2,5-difluorophenoxy group, 2-chlorophenoxy group, 2,3-dichlorophenoxy group, 2,4-dichlorophenoxy group, 2,5-dichlorophenoxy group, 2-bromophenoxy group, 3-bromophenoxy group, 4-bromophenoxy group, 2,3-dibromophenoxy group, 2,4-dibromophenoxy group, or 2,5-dibromophenoxy group, and preferably an aryloxy group having 6 to 14 carbon atoms, more preferably 2,4,6-trimethylphenoxy group, 3,4,5-trimethylphenoxy group, 2,6-diisopropylphenoxy group, or a pentafluorophenoxy group.

Examples of the substituted or unsubstituted aralkyloxy group having 7 to 30 carbon atoms of R¹ to R¹⁰ include benzyloxy group, (2-methylphenyl)methoxy group, (3-methylphenyl)methoxy group, (4-methylphenyl)methoxy group, (2,3-dimethylphenyl)methoxy group, (2,4-dimethylphenyl)methoxy group, (2,5-dimethylphenyl)methoxy group, (2,6-dimethylphenyl)methoxy group, (3,4-dimethylphenyl)methoxy group, (3,5-dimethylphenyl)methoxy group, (2,3,4-trimethylphenyl)methoxy group, (2,3,5-trimethylphenyl)methoxy group, (2,3,6-trimethylphenyl)methoxy group, (2,4,5-trimethylphenyl)methoxy group, (2,4,6-trimethylphenyl)methoxy group, (3,4,5-trimethylphenyl)methoxy group, (2,3,4,5-tetramethylphenyl)methoxy group, (2,3,4,6-tetramethylphenyl)methoxy group, (2,3,5,6-tetramethylphenyl)methoxy group, (pentamethylphenyl)methoxy group, (ethylphenyl)methoxy group, (n-propylphenyl)methoxy group, (isopropylphenyl)methoxy group, (n-butylphenyl)methoxy group, (sec-butylphenyl)methoxy group, (tert-butylphenyl)methoxy group, (n-hexyl phenyl)methoxy group, (n-octylphenyl)methoxy group, (n-decylphenyl)methoxy group, (n-tetradecylphenyl)methoxy group, naphthylmethoxy group, or anthracenylmethoxy group, and preferably an aralkyloxy group having 7 to 12 carbon atoms, more preferably benzyloxy group.

Examples of the substituted or unsubstituted heterocyclic compound residue having a 3 to 20 ring carbon atoms of R² to R⁴ and R⁶ to R¹⁰ include thienyl group, furil group, 1-pyrrolyl group, 1-imidazolyl group, 1-pyrazolyl group, pyridyl group, pyrazinyl group, pyrimidinyl group, pyridazinyl group, 2-isoindolyl group, 1-indolyl group, quinolyl group, dibenzo-1H-pyrrol-1-yl group, or N-carbazolyl group, and preferably thienyl group, furil group, 1-pyrrolyl group, pyridyl group, pyrimidinyl group, 2-isoindolyl group, 1-indolyl group, quinolyl group, dibenzo-1H-pyrrol-1-yl group, or N-carbazolyl group.

At least one pair of groups selected from among the following pairs, R¹ and R², R² and R³, R³ and R⁴, R⁵ and R⁶, R⁶ and R⁷, R⁷ and R⁸, R² and R⁹, and R⁶ and R¹⁰, may be linked to form a ring which may have a substituent, notwithstanding the above definitions of R¹ to R¹⁰. The ring is preferably a 4- to 10-membered hydrocarbyl ring or heterocyclic ring containing two carbon atoms on a benzene ring. The 4- to 10-membered ring may have a substituent.

Specifically, examples of the ring include a cyclobutene ring, a cyclopentene ring, a cyclopentadiene ring, a cyclohexene ring, a cyclohepten ring, a cyclooctane ring, a benzene ring, a naphthalene ring, a furan ring, a 2,5-dimethylfuran ring, a thiophene ring, a 2,5-dimethylthiophene ring, or a pyridine ring, and preferably a cyclopentene ring, a cyclopentadiene ring, a cyclohexene ring, a benzene ring or a naphthalene ring, more preferably a cyclopentene ring, a cyclohexene ring, a benzene ring, or a naphthalene ring each of which is formed by linkage between R¹ and R², R⁵ and R⁶, R² and

R⁹, and/or R⁶ and R¹⁰ Examples of the halogen atom, the alkyl group having 1 to 20 carbon atoms, the cycloalkyl group having 3 to 10 ring carbon atoms, the alkenyl group having 2 to 20 carbon atoms, the aralkyl group having 7 to 30 carbon atoms, the aryl group having 6 to 30 carbon atoms, the alkoxy group having 1 to 20 carbon atoms, the aralkyloxy group having 7 to 30 carbon atoms, the aryloxy group having 6 to 30 carbon atoms, and the substituted silyl group of X are the same as the examples of R² to R⁴ and R⁶ to R⁸.

Examples of the substituted amino group of X include a hydrocarbylamino group having 2 to 14 carbon atoms such as dimethylamino group, diethylamino group, di-n-butylamino group, di-n-propylamino group, diisopropylamino group, dibenzylamino group, or diphenylamino group, and preferably dimethylamino group, diethylamino group, di-n-propylamino group, diisopropylamino group, or dibenzylamino group.

Examples of the substituted thiolate group of X include a hydrocarbyl thiolate group having 6 to 12 carbon atoms such as thiophenoxy group, 2,3,4-trimethylthiophenoxy group, 2,3,5-trimethylthiophenoxy group, 2,3,6-trimethylthiophenoxy group, 2,4,6-trimethylthiophenoxy group, 3,4,5-trimethylthiophenoxy group, 2,3,4,5-tetramethylthiophenoxy group, 2,3,4,6-tetramethylthiophenoxy group, 2,3,5,6-tetramethylphenoxy group, pentamethylphenoxy group, 2-fluorothiophenoxy group, 3-fluorothiophenoxy group, 4-fluorophenoxy group, pentafluorothiophenoxy group, 2-trifluoromethylthiophenoxy group, 3-trifluoromethylthiophenoxy group, 4-trifluoromethylthiophenoxy group, 2,3-difluorothiophenoxy group, 2,4-fluorothiophenoxy group, 2,5-difluorothiophenoxy group, 2-chlorothiophenoxy group, 2,3-dichlorothiophenoxy group, 2,4-dichlorothiophenoxy group, 2,5-dichlorothiophenoxy group, 2-bromothiophenoxy group, 3-bromothiophenoxy group, 4-bromothiophenoxy group, 2,3-dibromothiophenoxy group, 2,4-dibromothiophenoxy group, or 2,5-dibromothiophenoxy group, and preferably thiophenoxy group, 2,4,6-trimethylthiophenoxy group, 3,4,5-trimethylthiophenoxy group, 2,3,4,5-tetramethylthiophenoxy group, 2,3,4,6-tetramethylthiophenoxy group, 2,3,5,6-tetramethylthiophenoxy group, pentamethylthiophenoxy group, or pentafluorothiophenoxy group.

Examples of the carboxylato group having 1 to 20 carbon atoms of X is, for example, acetate group, propionate group, butyrate group, pentanate group, hexanoate group, 2-ethylhexanoate group, or trifluoroacetate group, and preferably a hydrocarbyl carboxylato group having 2 to 10 carbon atoms, more preferably acetate group, propionate group, 2-ethylhexanoate group, or trifluoroacetate group.

X is preferably a fluorine atom, a chlorine atom, a bromine atom, an alkyl group having 1 to 20 carbon atoms, an aralkyl group having 7 to 30 carbon atoms, an alkoxy group having 1 to 20 carbon atoms, an aryloxy group having 6 to 30 carbon atoms, or a hydrocarbylamino group having 1 to 20 carbon atoms, more preferably a chlorine atom, a bromine atom, an alkyl group having 1 to 6 carbon atoms, an aralkyl group having 7 to 10 carbon atoms, an alkoxy group having 1 to 6 carbon atoms, an aryloxy group having 6 to 10 carbon atoms, or a hydrocarbylamino group having 2 to carbon atoms, further more preferably a chlorine atom, methyl group, ethyl group, n-butyl group, tert-butyl group, benzyl group, methoxy group, ethoxy group, isopropoxy group, tert-butoxy group, phenoxy group, dimethylamino group, or diethylamino group, especially preferably a chlorine atom, methyl group, benzyl group, isopropoxy group, phenoxy group, or dimethylamino group, most preferably a chlorine atom or benzyl group.

The two X groups may be linked to form a ring which may have a substituent.

R¹ to R¹⁰ and X may independently have a substituent partially containing any of a halogen atom, an oxygen atom, a silicon atom, a nitrogen atom, a phosphorus atom, and a sulfur atom.

L is independently a neutral Lewis base, and 1 is 0, 1, or 2, when 1 is 2, the L groups may be the same or different.

Examples of L include an ether, an amine, a thioether or the like. Specific examples of L include tetrahydrofuran, diethyl ether, 1,4-dioxane, and pyridine. L is preferably tetrahydrofuran.

1 is preferably 1 or 0, more preferably 0.

Examples of the complex represented by Formula (1-1) include the following compounds:

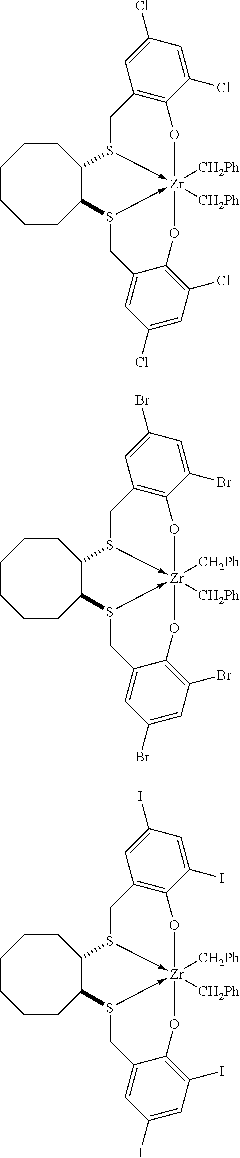

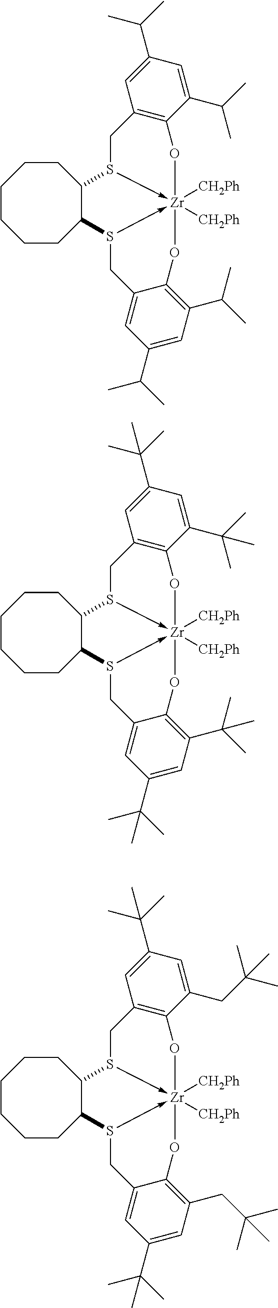

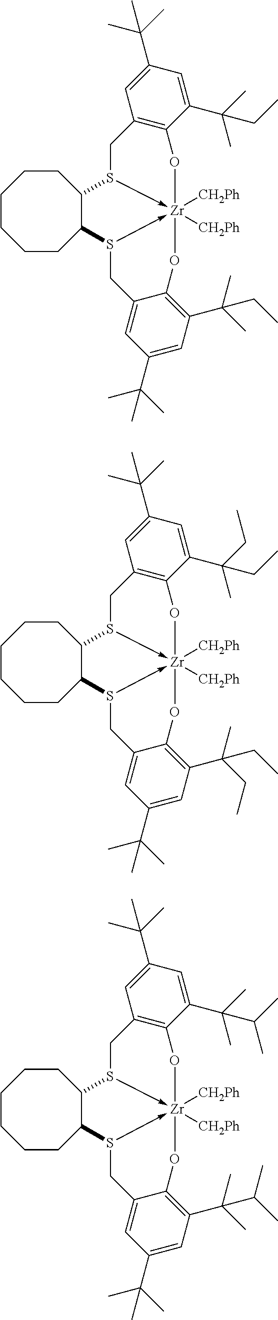

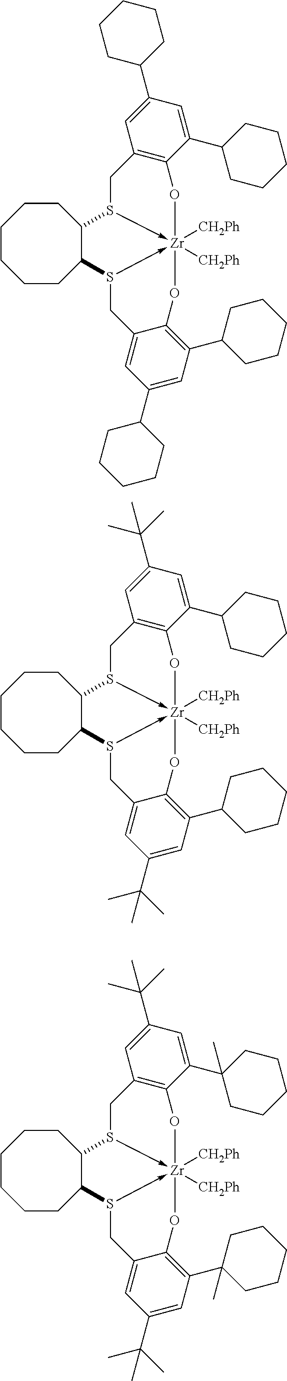

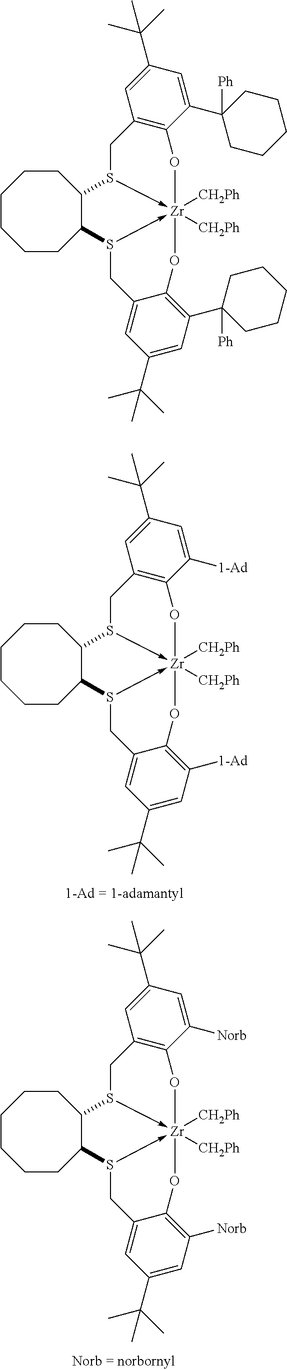

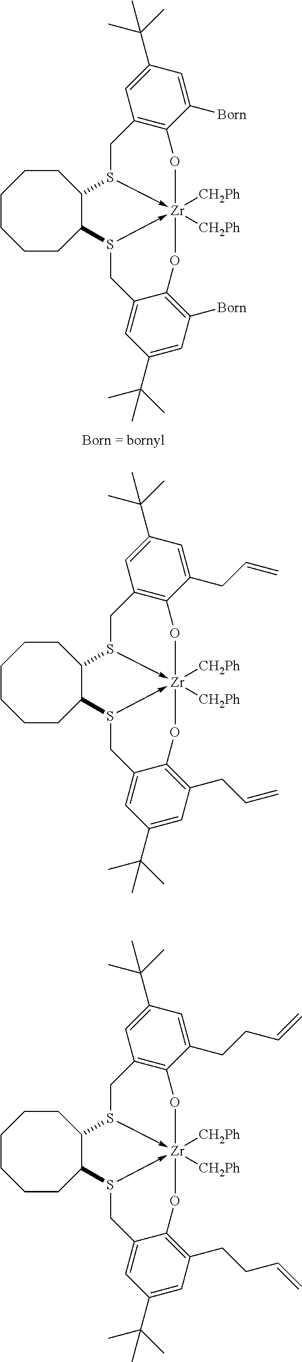

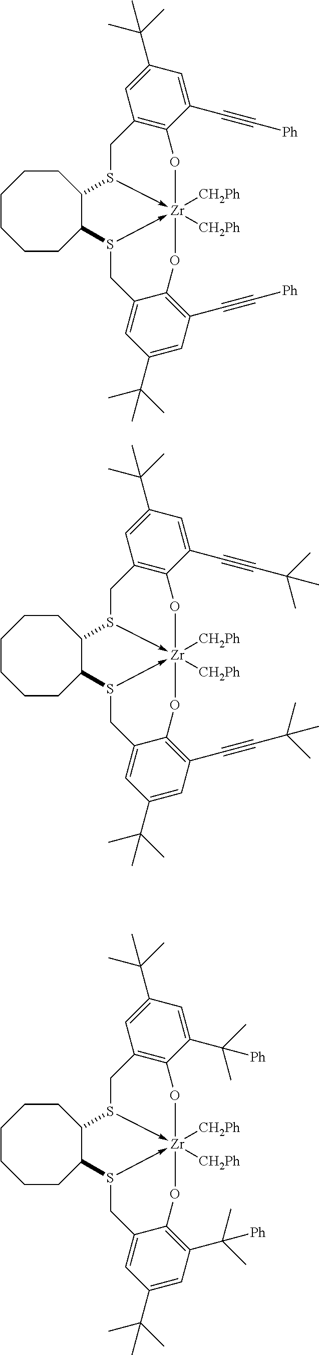

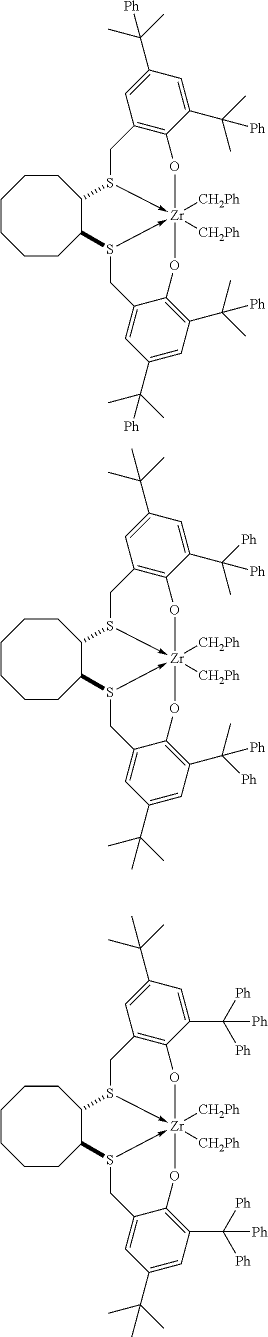

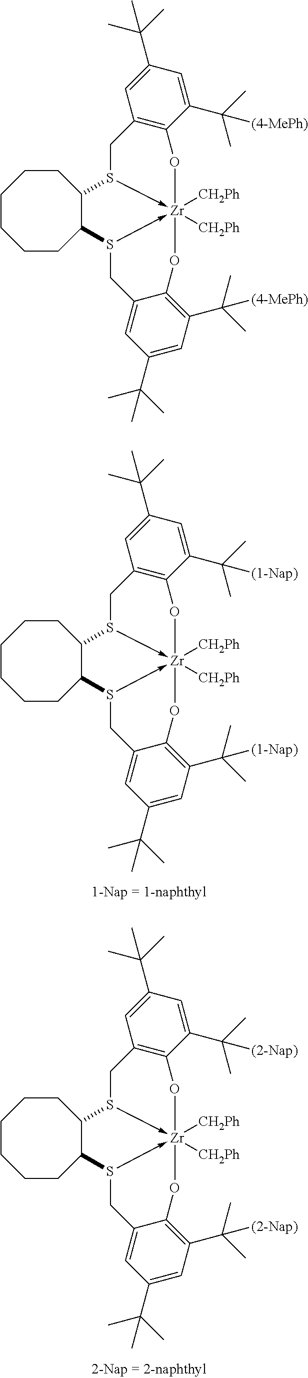

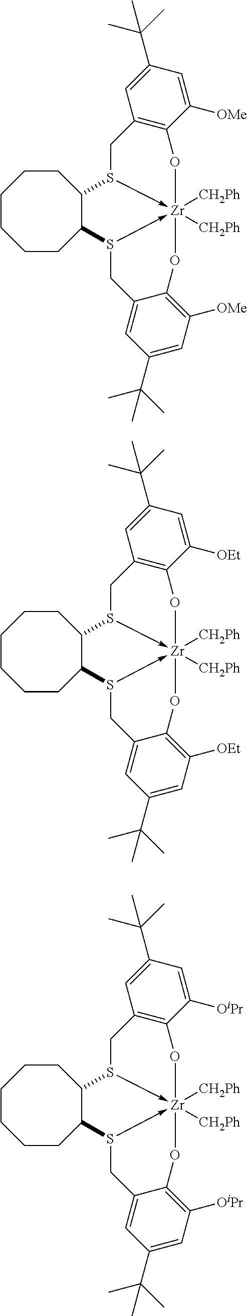

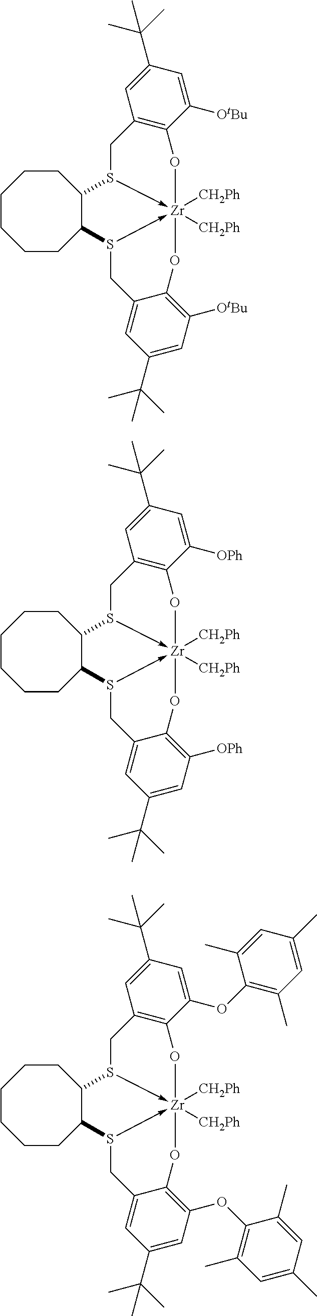

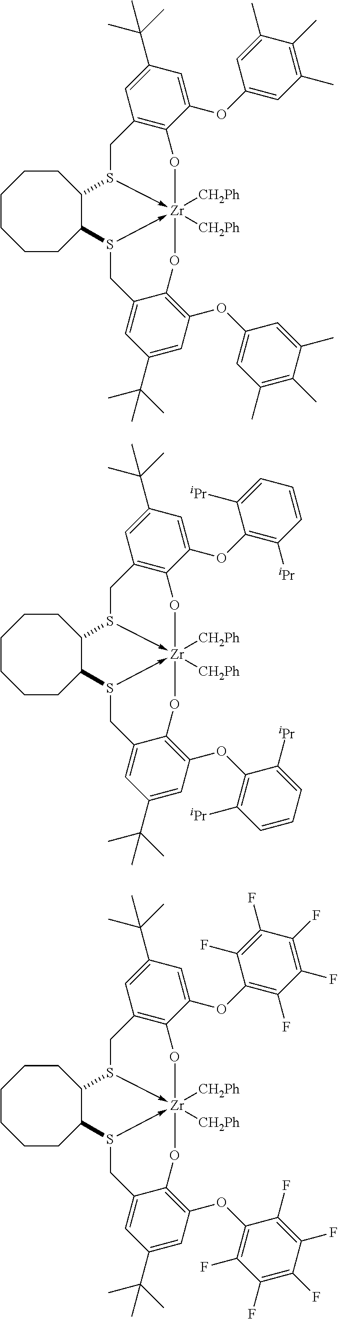

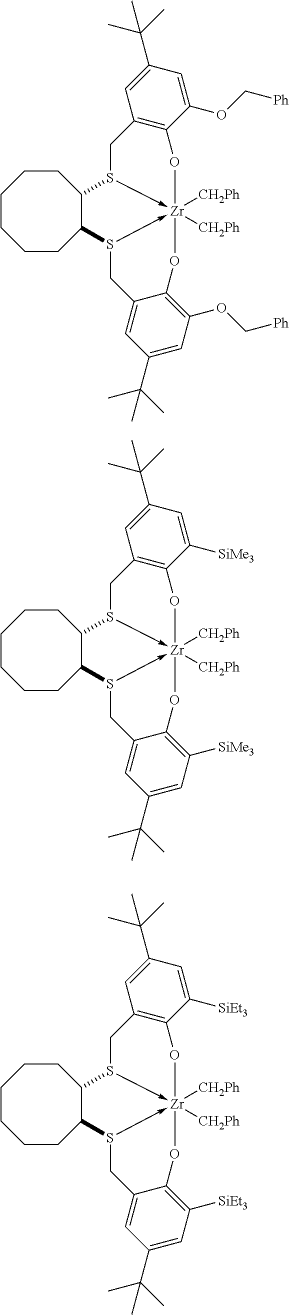

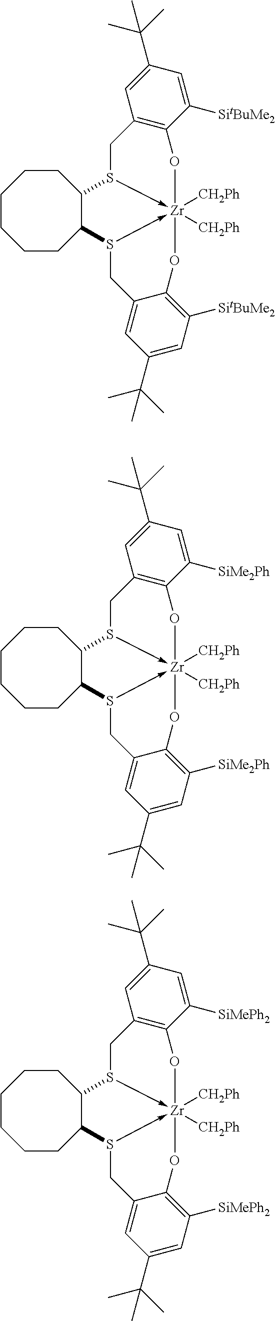

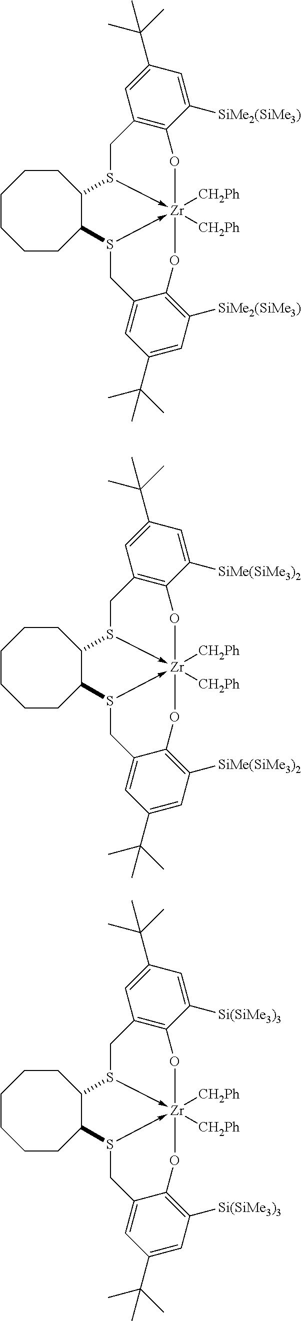

The examples of the complex (1-1) include, in addition to the compounds as shown above, the above compounds modified such that each of the benzyl groups directly bonded to a zirconium atom is substituted with a chlorine atom, a methyl group, a dimethylamino group, an isopropoxy group, a tert-butoxy group, or a phenoxy group.

The examples of the complex (1-1) further include the above compounds modified such that the zirconium atom is substituted with a hafnium atom.

The examples of the complex (1-1) still further include the above compounds modified such that R³ and R⁷ are independently a hydrogen atom or a methyl group.

The examples of the complex (1-1) still further include the above compounds modified such that the cyclooctane ring bound to the sulfur atoms is substituted with a cycloheptane ring or a cyclohexane ring.

Preferable examples of the complex (1-1) include the following compounds:

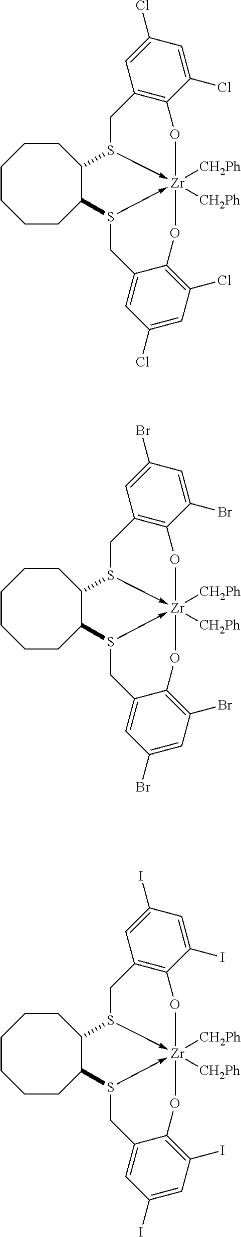

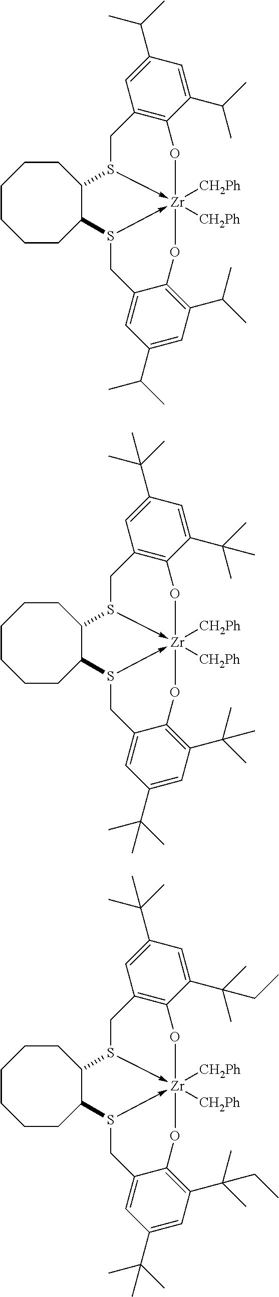

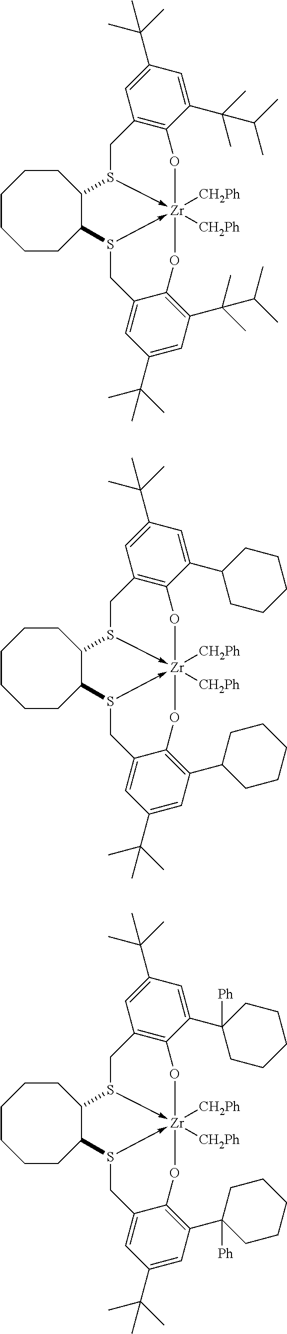

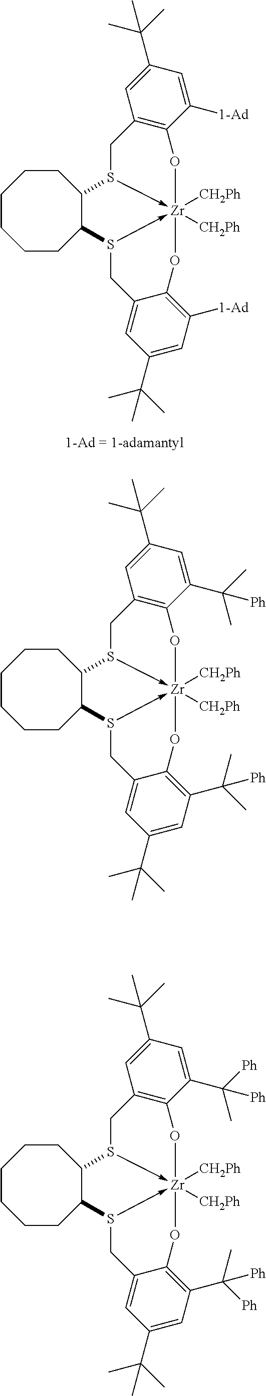

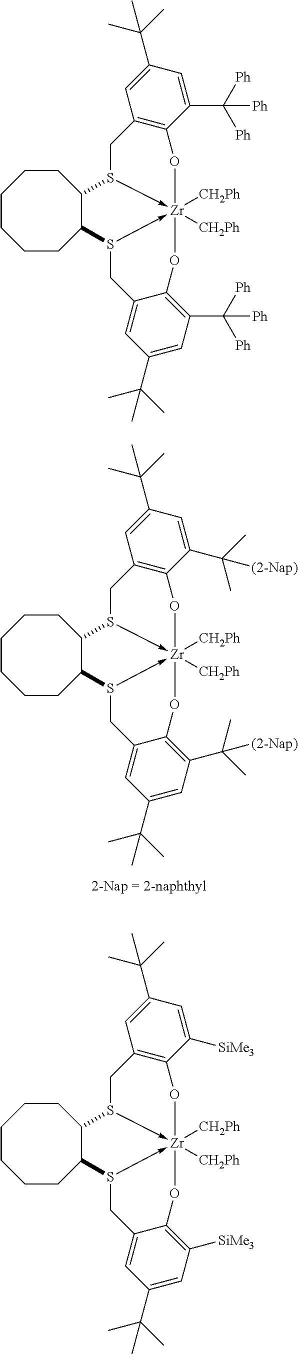

The preferable examples of the complex (1-1) include, in addition to the compounds as shown above, the above compounds modified such that each of the benzyl groups directly bonded to the zirconium atom is substituted with a chlorine atom or a methyl group.

The preferable examples of the complex (1-1) further include the above compounds modified such that the zirconium atom is substituted with a hafnium atom.

The preferable examples of the complex (1-1) still further include the above compounds modified such that R³ and R⁷ are independently a hydrogen atom or a methyl group.

The preferable examples of the complex (1-1) still further include the above compounds modified such that the cyclooctane ring bound to the sulfur atoms is substituted with a cycloheptane ring.

More preferable examples of the complex (1-1) include the following compounds:

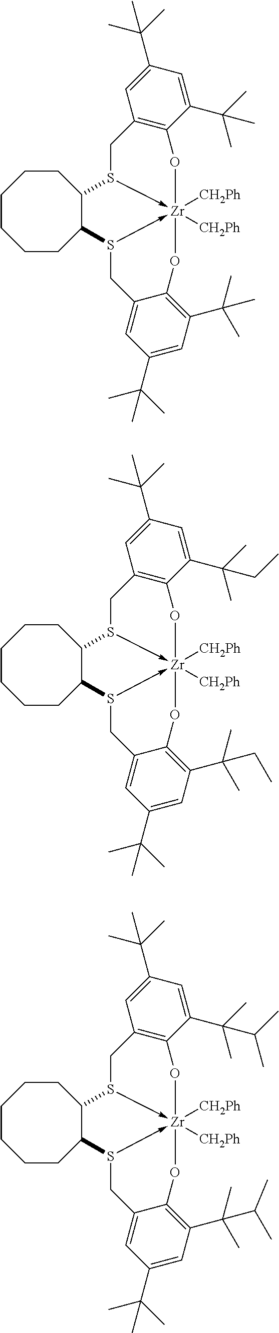

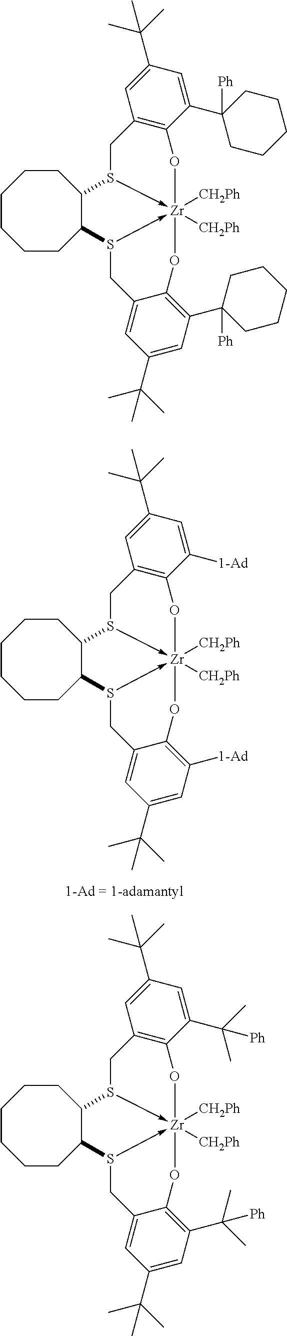

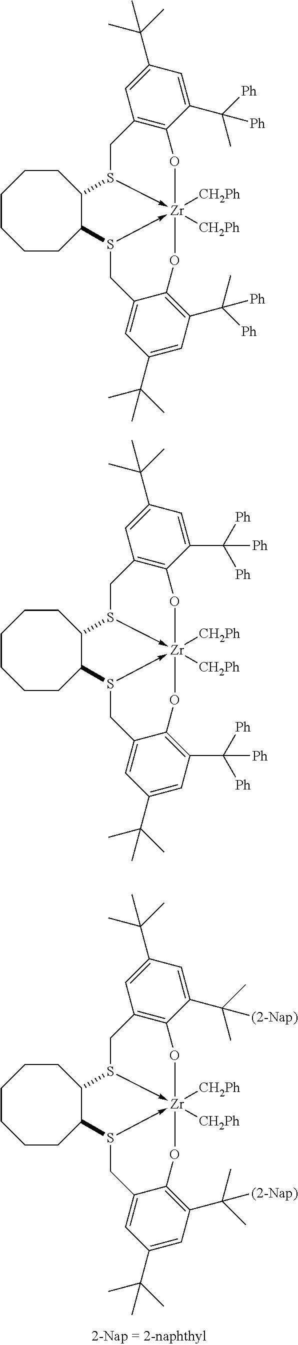

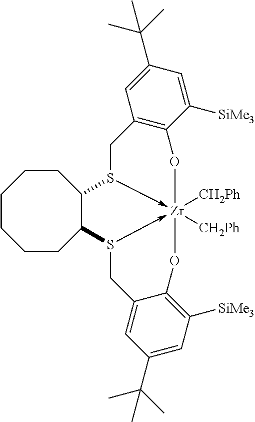

The more preferable examples of the complex (1-1) include, in addition to the compounds as shown above, the above compounds modified such that each of the benzyl groups directly bonded to the zirconium atom is substituted with a chlorine atom.

The more preferable examples of the complex (1-1) still further include the above compounds modified such that R³ and R⁷ are a methyl group.

Examples of the complex represented by Formula (1-2) include the following compounds:

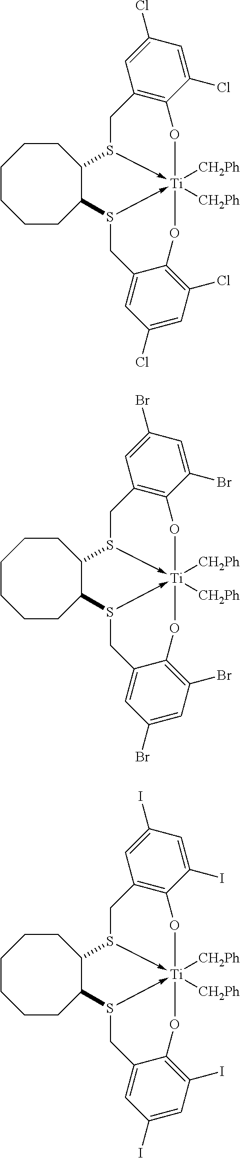

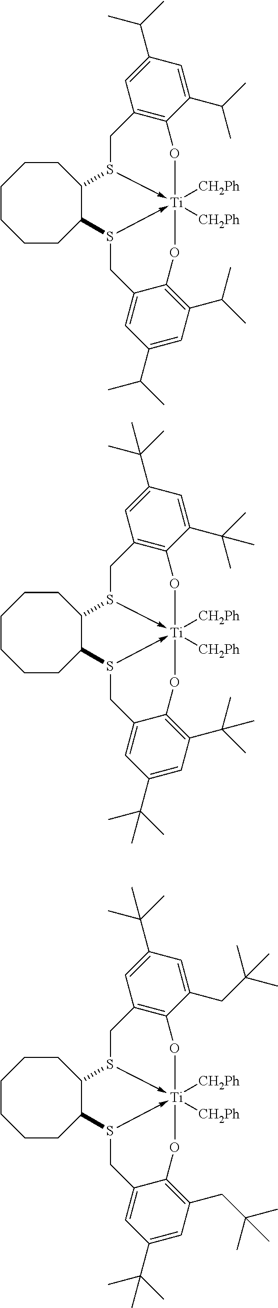

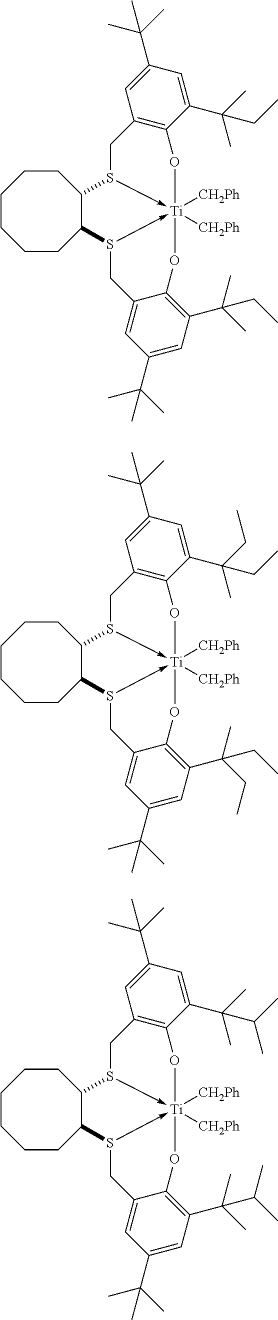

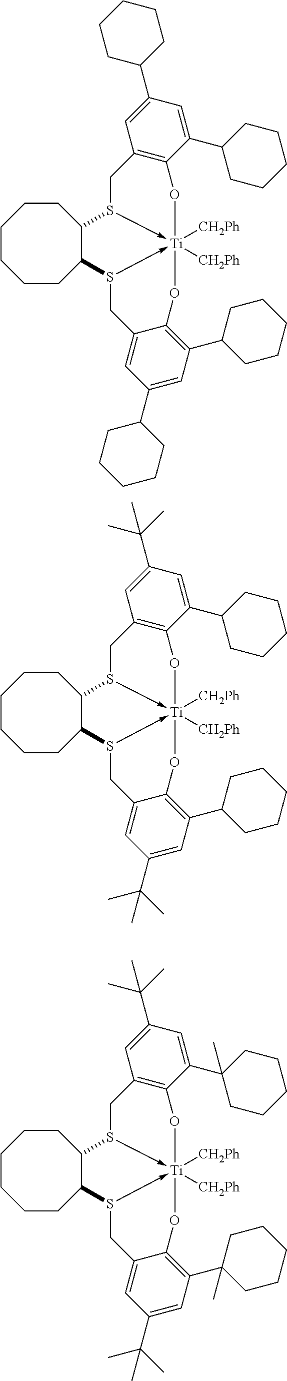

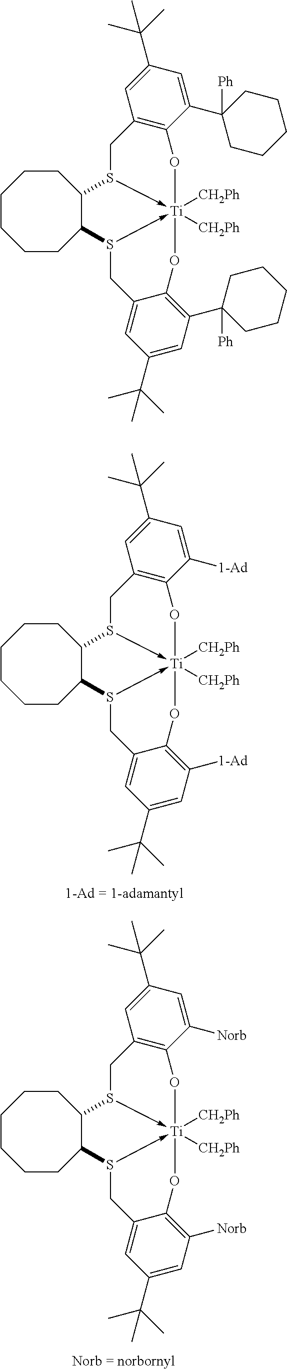

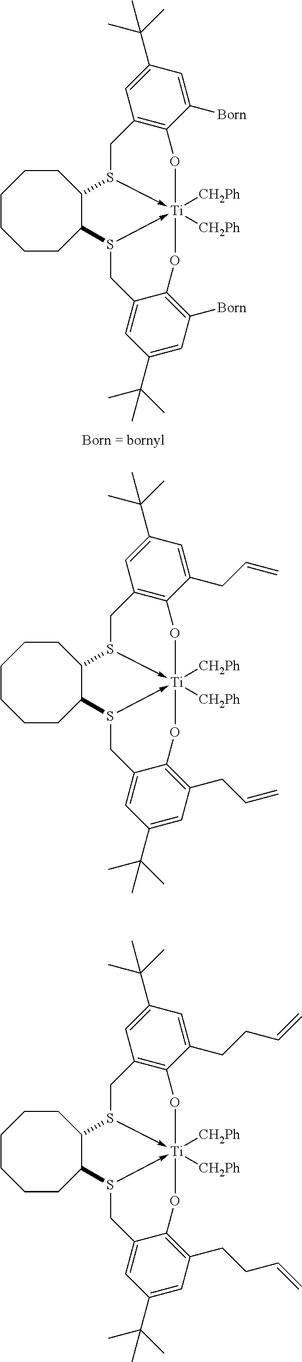

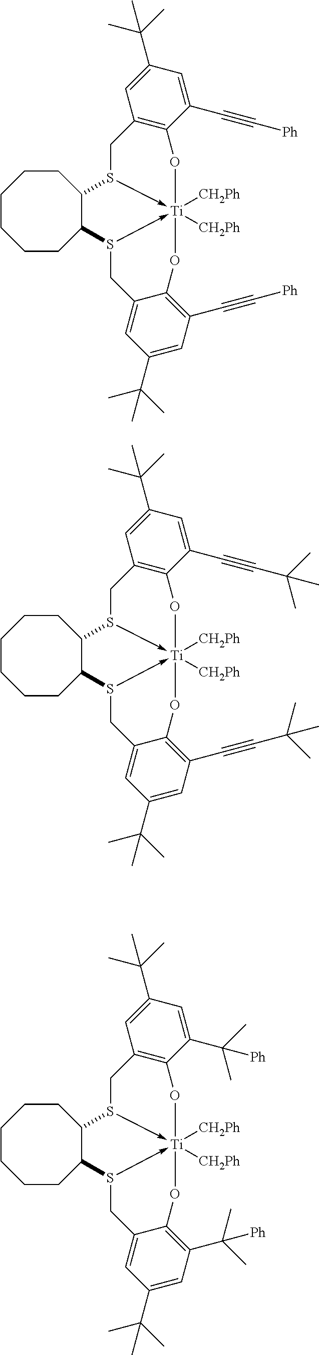

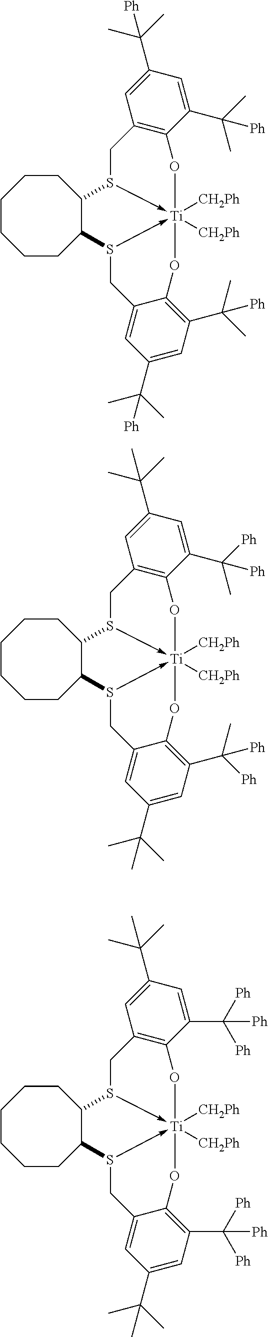

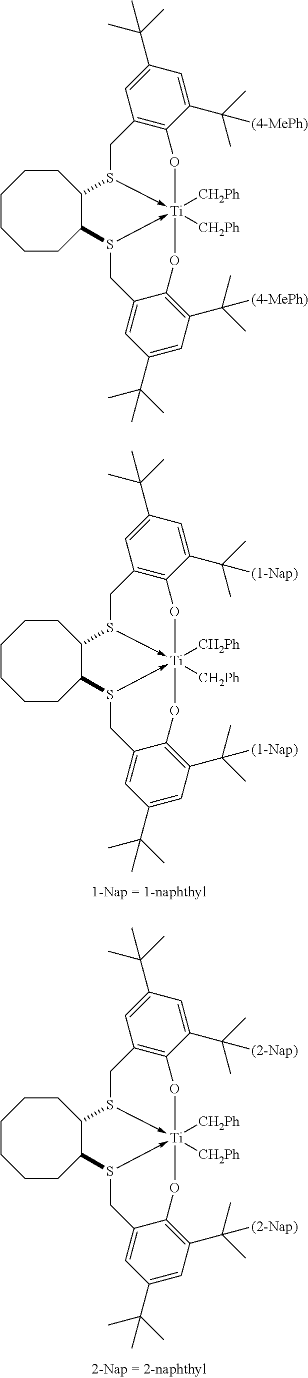

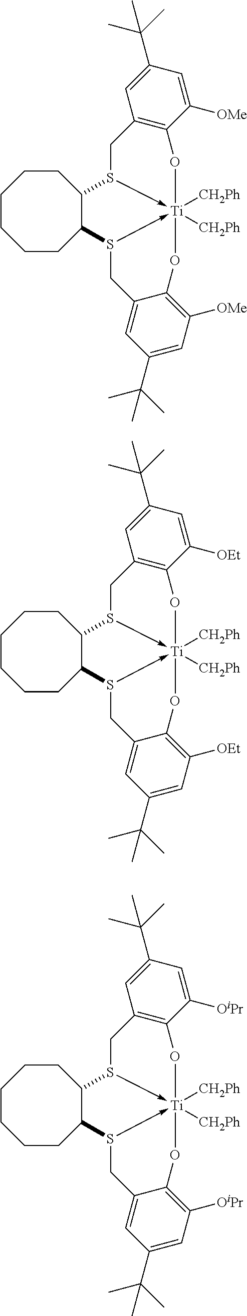

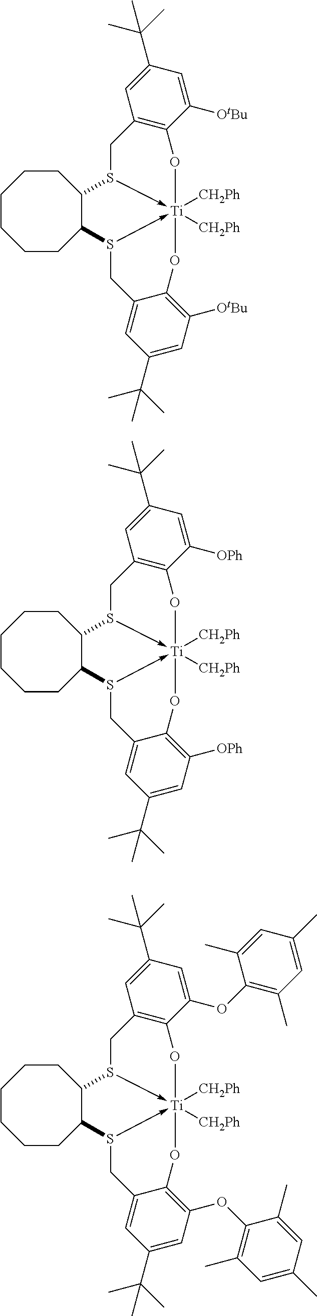

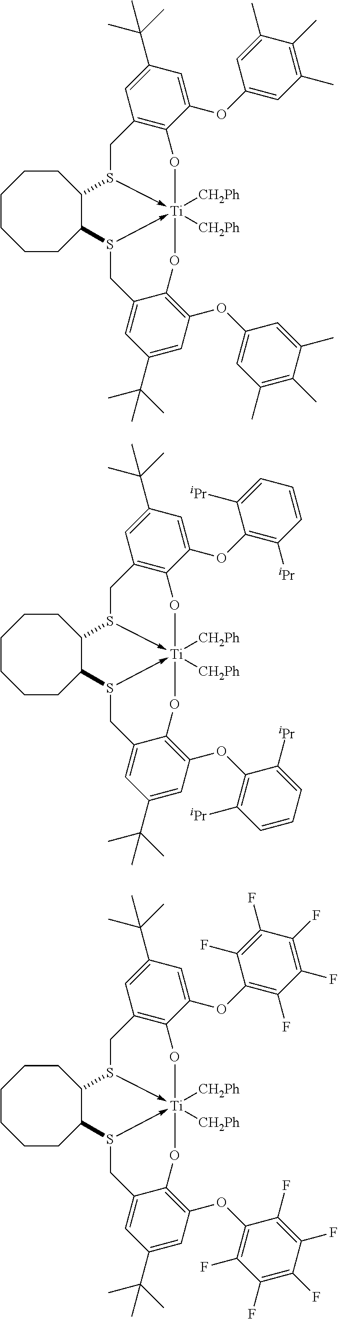

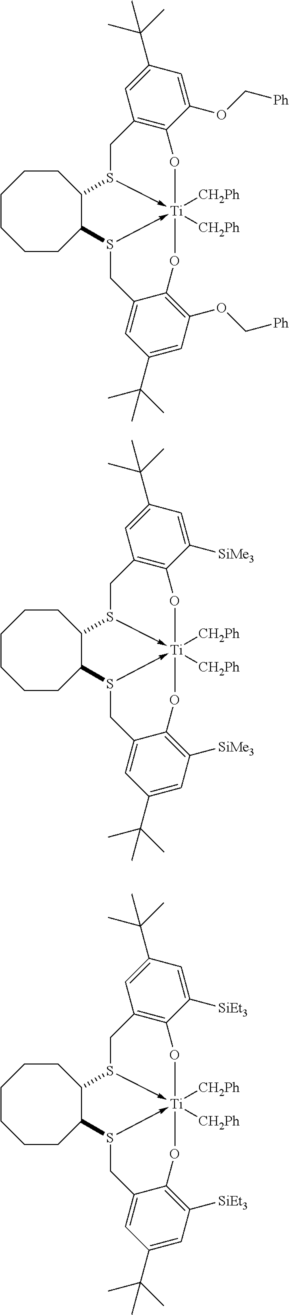

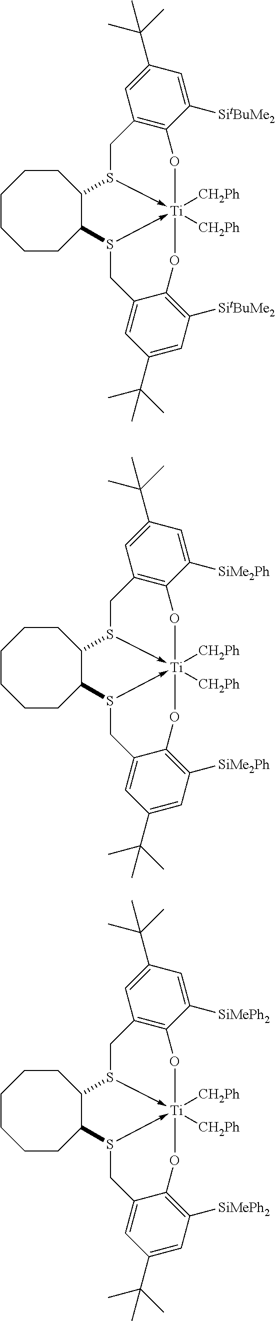

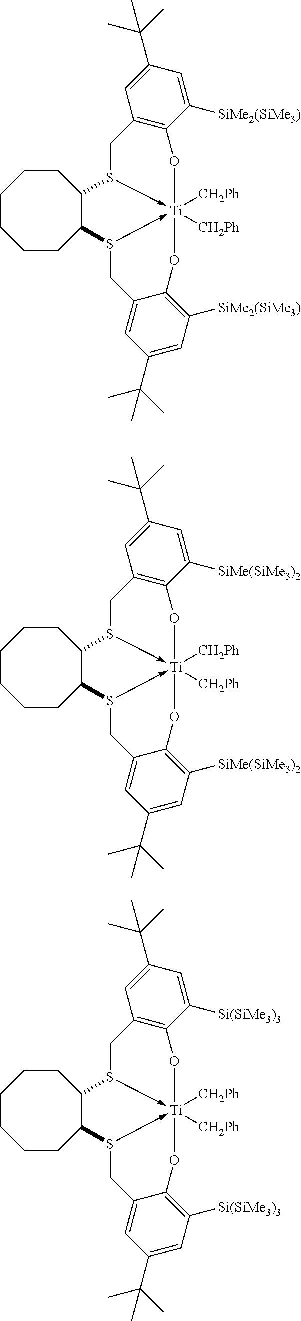

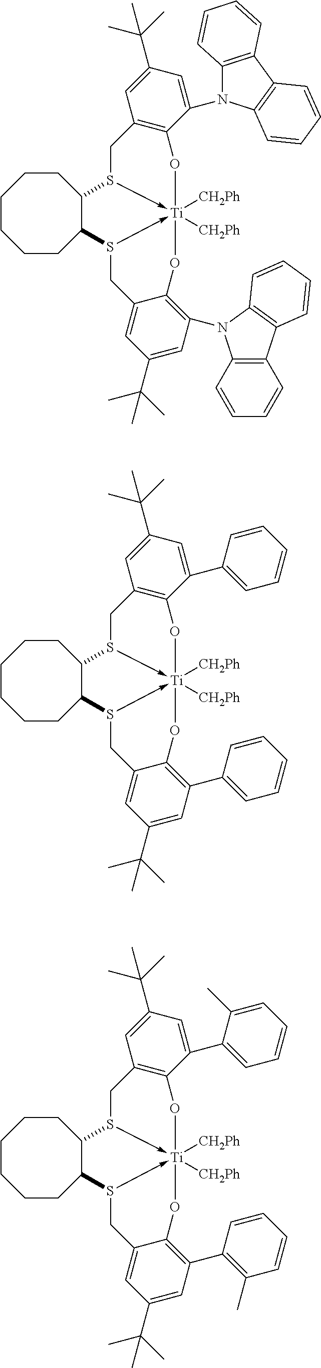

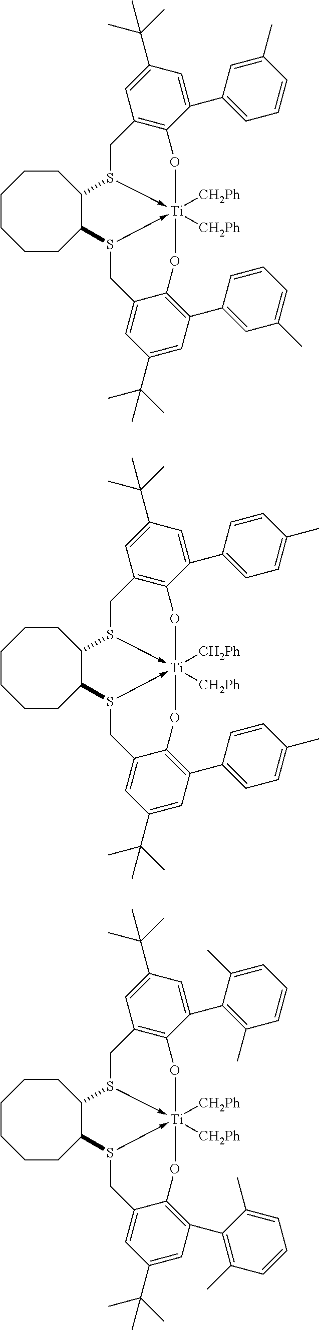

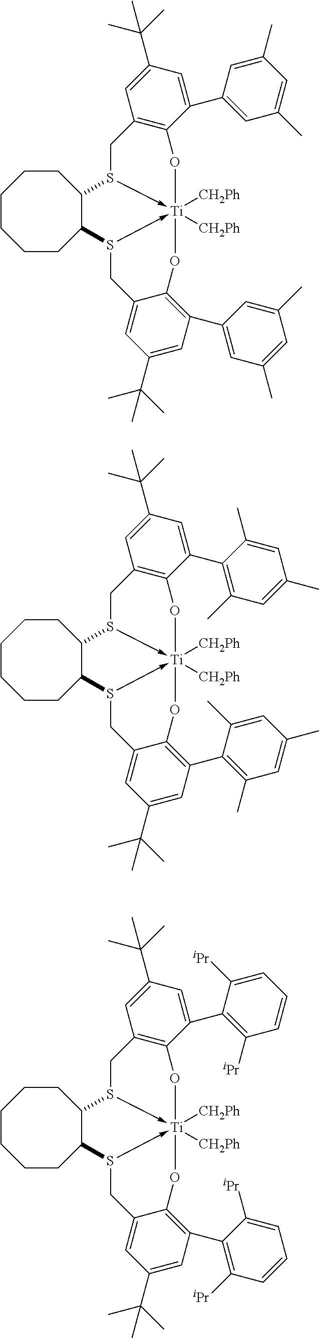

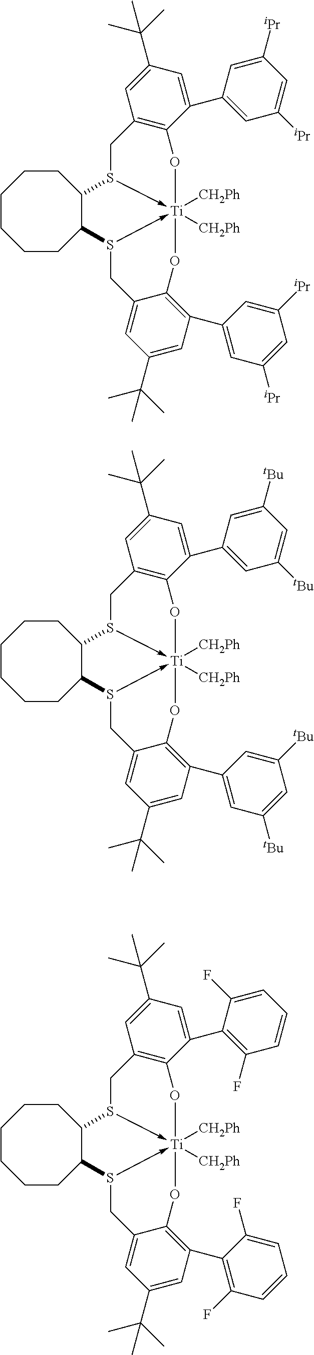

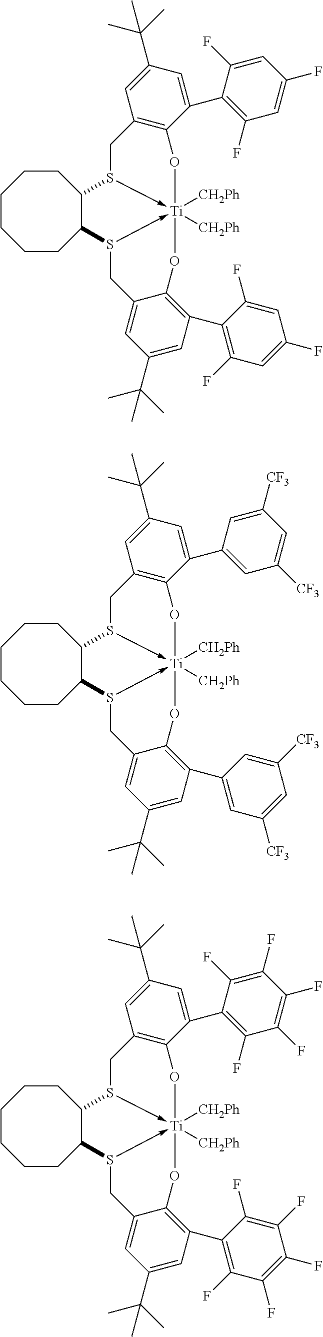

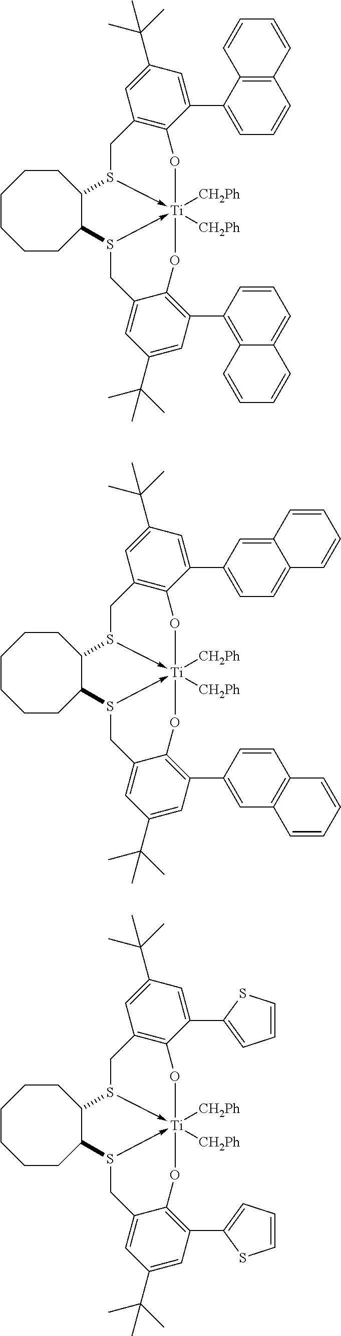

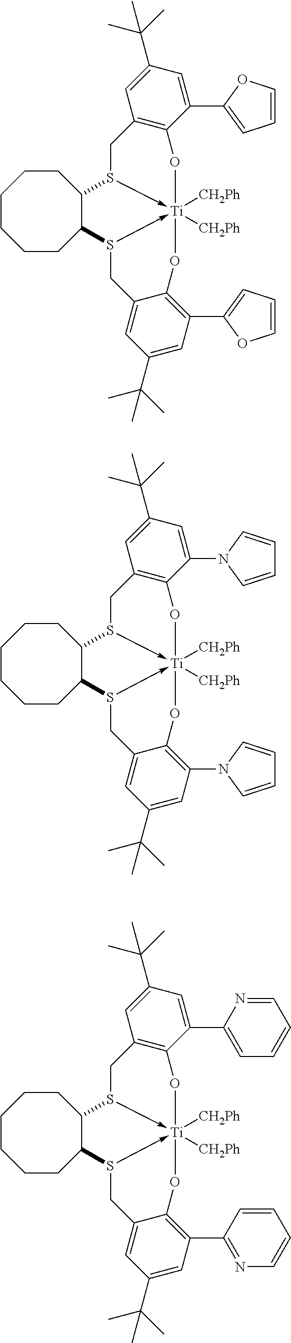

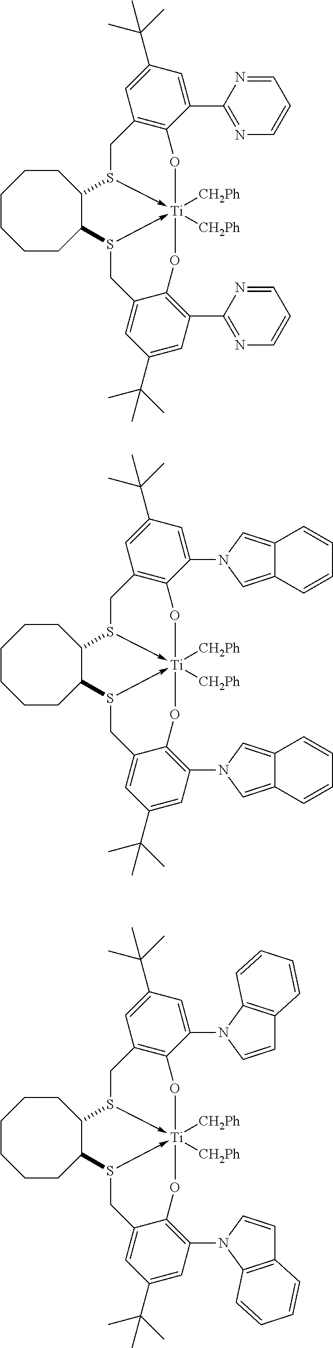

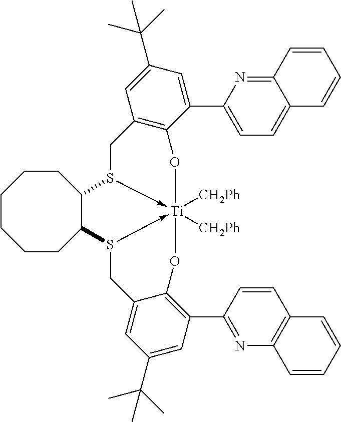

The examples of the complex (1-2) include, in addition to the compounds as shown above, the above compounds modified such that each of the benzyl groups directly bonded to the titanium atom is substituted with a chlorine atom, a methyl group, a dimethylamino group, an isopropoxy group, a tert-butoxy group, or a phenoxy group.

The examples of the complex (1-2) still further include the above compounds modified such that R³ and R⁷ are independently a hydrogen atom or a methyl group.

The examples of the complex (1-2) still further include the above compounds modified such that the cyclooctane ring bound to the sulfur atoms is substituted with a cycloheptane ring or a cyclohexane ring.

Preferable examples of the complex (1-2) include the following compounds:

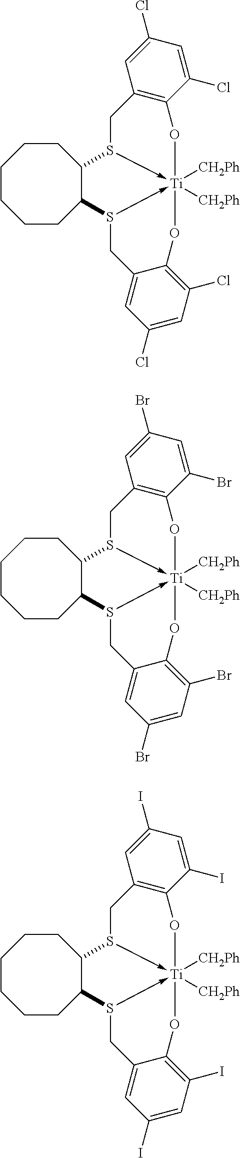

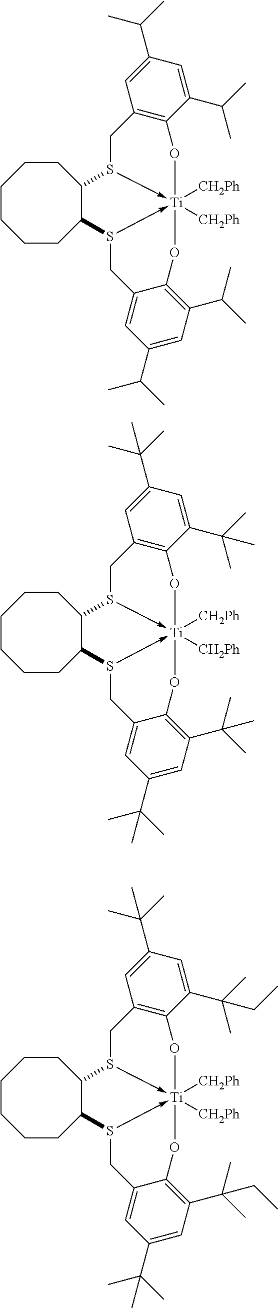

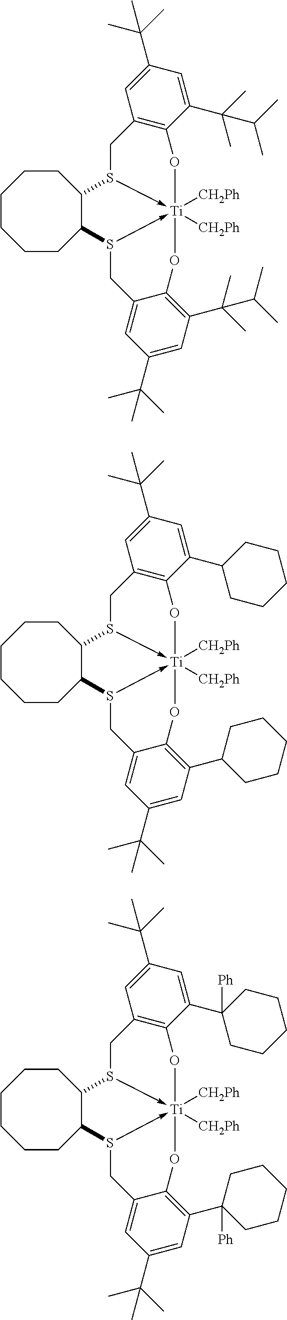

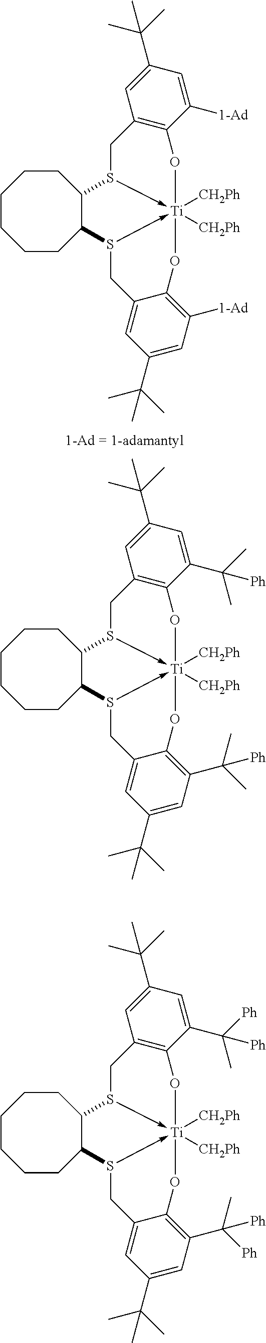

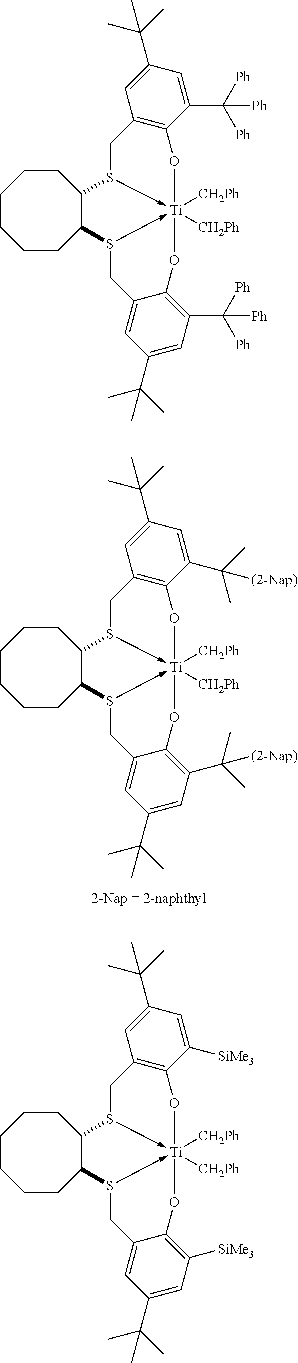

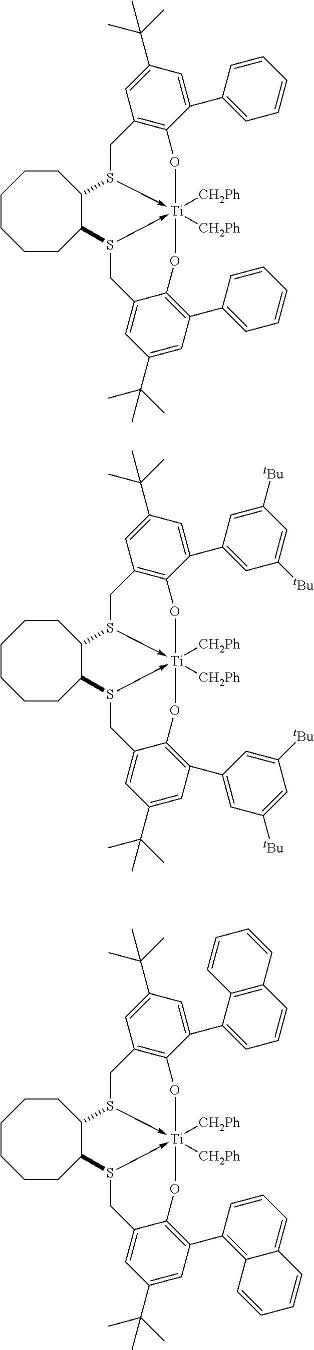

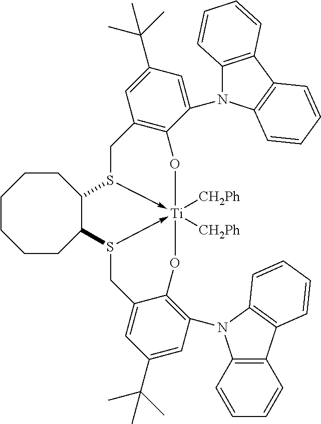

The preferable examples of the complex (1-2) include, in addition to the compounds as shown above, the above compounds modified such that each of the benzyl groups directly bonded to the titanium atom is substituted with a chlorine atom or a methyl group.

The preferable examples of the complex (1-2) still further include the above compounds modified such that R³ and R⁷ are independently substituted with a hydrogen atom or a methyl group.

The preferable examples of the complex (1-2) still further include the above compounds modified such that the cyclooctane ring bound to the sulfur atoms is substituted with a cycloheptane ring or a cyclohexane ring.

More preferable examples of the complex (1-2) include the following compounds:

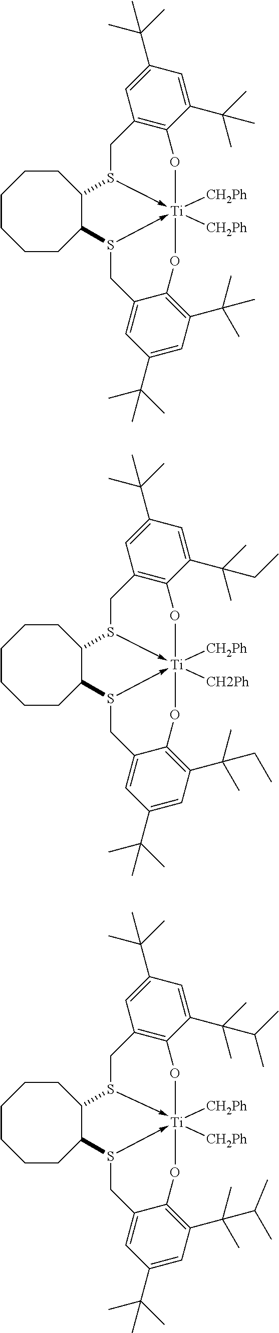

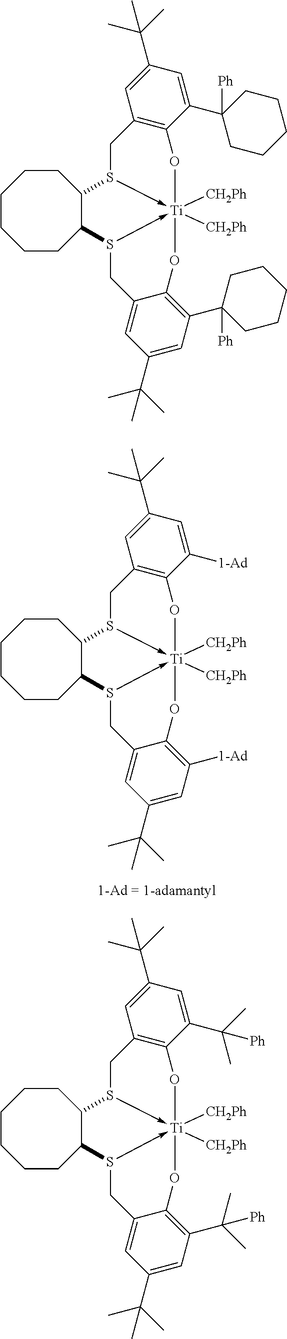

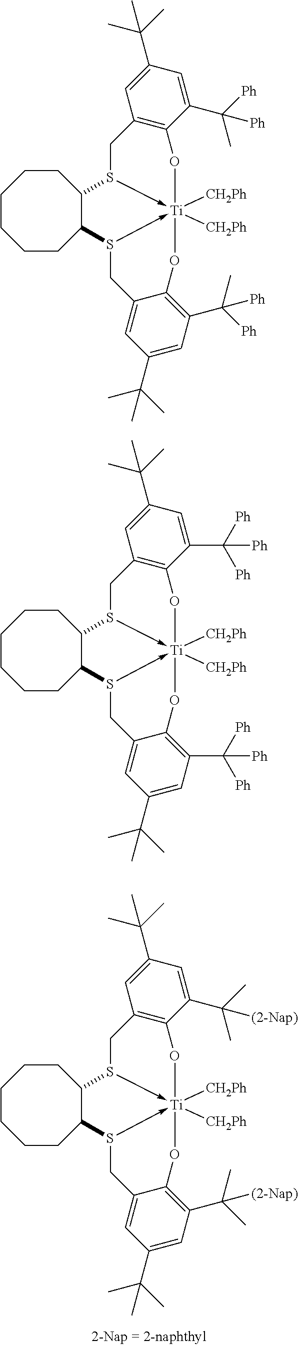

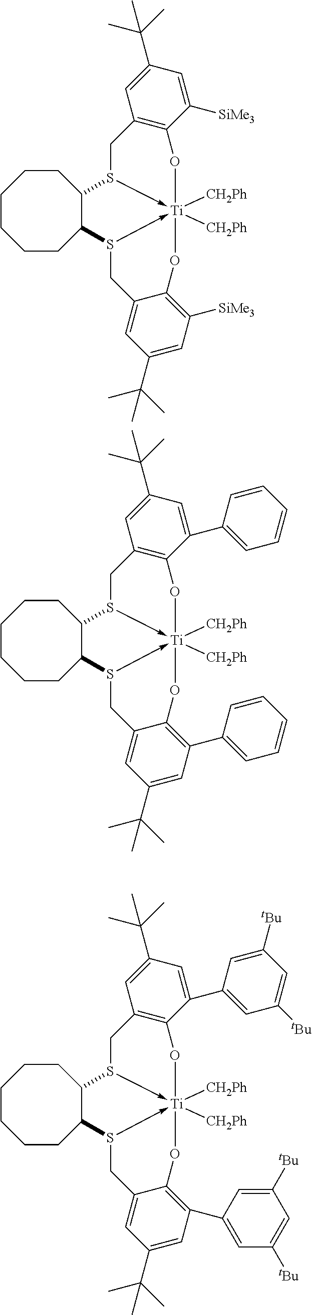

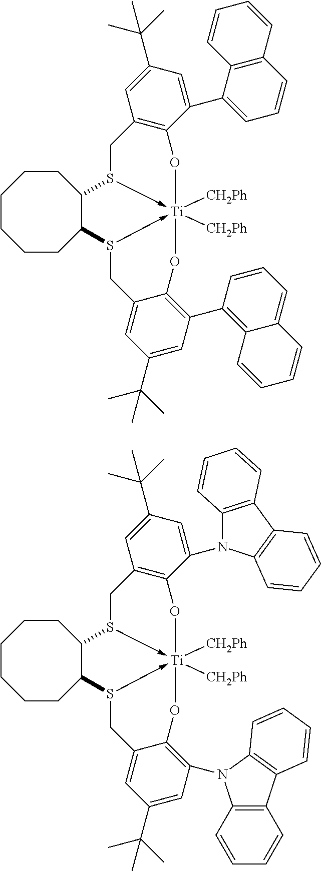

The more preferable examples of the complex (1-2) encompass, in addition to the compounds as shown above, the above compounds modified such that each of the benzyl groups directly bonded to the titanium atom is substituted with a chlorine atom.

The more preferable examples of the complex (1-2) still further include the above compounds modified such that R³ and R⁷ are a methyl group.

The more preferable examples of the complex (1-2) still further include the above compounds modified such that the cyclooctane ring bound to the sulfur atoms is substituted with a cycloheptane ring or a cyclohexane ring.

The complexes represented by a general formula (1-1) or (1-2) can each be synthesized by, for example, a method described in Journal of American Chemical Society, 2009, Volume 131, 13566-13567. Specifically, (i) the compound represented by general formula (1-1) can be produced under Scheme 1-1 with use of a compound represented by general formula (2-1) and a compound represented by general formula (3-1) as starting materials, and (ii) the compound represented by general formula (1-2) can be produced under Scheme 1-2 with use of a compound represented by general formula (2-2) and a compound represented by general formula (3-2) as starting materials. The description below of the present specification refers to (i) a complex represented by general formula (1-1) or (1-2) also as a complex represented by general formula (1), (ii) a compound represented by general formula (2-1) or (2-2) also as a compound represented by general formula (2), and (iii) a compound represented by general formula (3-1) or (3-2) also as a compound represented by general formula (3).

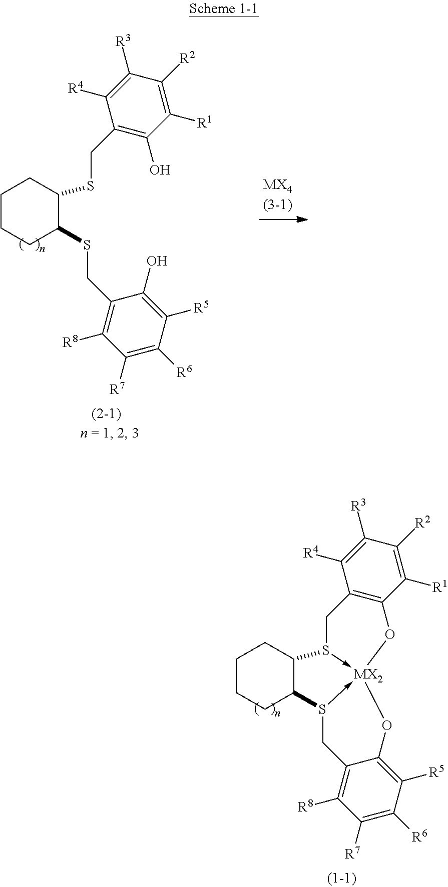

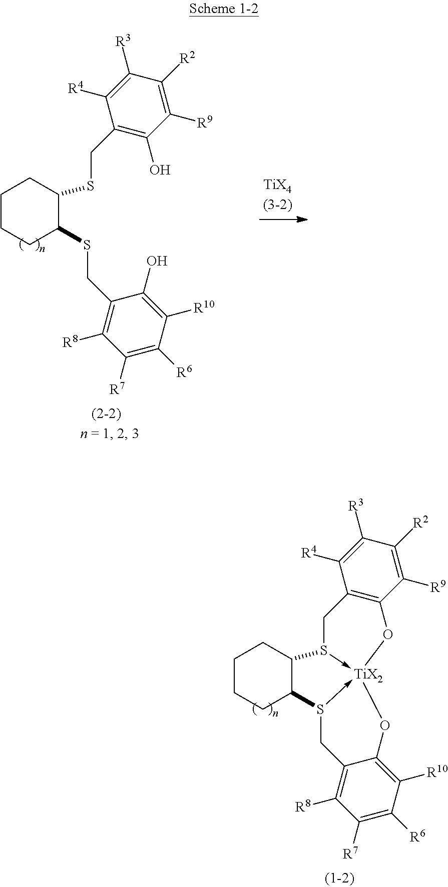

M and X in the compound (3-1) are the same as M and X in general formula (1-1), respectively. Examples of MX₄ include Zr(CH₂Ph)₄, ZrCl₂ (CH₂Ph)₂, Zr(CH₂SiMe₃)₄, ZrF₄, ZrCl₄, ZrBr₄, ZrI₄, Zr(OMe)₄, Zr(OEt)₄, Zr(O-i-Pr)₄, ZrCl₂(O-i-Pr)₂, Zr(O-n-Bu)₄, Zr(O-i-Bu)₄, Zr(O-t-Bu)₄, Zr(OPh)₄, Zr(NMe₂)₄, ZrCl₂(NMe₂)₂, Zr(NEt₂)₄, Hf(CH₂Ph)₄, HfCl₂(CH₂Ph)₂, Hf(CH₂SiMe₃)₄, HfF₄, HfCl₄, HfBr₄, HfI₄, Hf(OMe)₄, Hf(OEt)₄, Hf(O-i-Pr)₄, HfCl₂(O-i-Pr)₂, Hf(O-n-Bu)₄, Hf(O-i-Bu)₄, Hf(O-t-Bu)₄, Hf(OPh)₄, Hf(NMe₂)₄, HfCl₂ (NMe₂)₂, and Hf(NEt₂)₄. MX₄ is preferably Zr(CH₂Ph)₄, ZrCl₂ (CH₂Ph)₂, Zr(CH₂SiMe₃)₄, ZrCl₄, ZrBr₄, Zr(OMe)₄, Zr(OEt)₄, Zr(O-i-Pr)₄, Zr(O-i-Bu)₄, Zr(O-t-Bu)₄, Zr(OPh)₄, Zr(NMe₂)₄, ZrCl₂(NMe₂)₂, Zr(NEt₂)₄, Hf(CH₂Ph)₄, HfCl₂(CH₂Ph)₂, Hf(CH₂SiMe₃)₄, HfCl₄, HfBr₄, Hf(OMe)₄, Hf(OEt)₄, Hf(O-i-Pr)₄, Hf(O-i-Bu)₄, Hf(O-t-Bu)₄, Hf(OPh)₄, Hf(NMe₂)₄, HfCl₂ (NMe₂)₂, or Hf(NEt₂)₄.

X in the compound (3-2) is the same as X in the general formula (1-2). Examples of TiX₄ include Ti(CH₂Ph)₄, TiCl₂ (CH₂Ph)₂, Ti(CH₂SiMe₃)₄, TiF₄, TiCl₄, TiBr₄, TiI₄, Ti(OMe)₄, Ti(OEt)₄, Ti(O-i-Pr)₄, TiCl₂(O-i-Pr)₂, Ti(O-n-Bu)₄, Ti(O-i-Bu)₄, Ti(O-t-Bu)₄, Ti(OPh)₄, Ti(NMe₂)₄, TiCl₂(NMe₂)₂, and Ti(NEt₂)₄. TiX₄ is preferably Ti(CH₂Ph)₄, TiCl₂ (CH₂Ph)₂, Ti(CH₂SiMe₃)₄, TiCl₄, TiBr₄, Ti(OMe)₄, Ti(OEt)₄, Ti(O-i-Pr)₄, Ti(O-i-Bu)₄, Ti(O-t-Bu)₄, Ti(OPh)₄, Ti(NMe₂)₄, TiCl₂(NMe₂)₂, or Ti(NEt₂)₄.

The complex (1) may be produced by (i) directly reacting the compound (2) and the compound (3) or (ii) as necessary, reacting the compound (2) with a base and then with the compound (3). These reactions are normally performed in a solvent. The base to be used is, for example, an organolithium reagent, a Grignard reagent, or a metal hydride. Specific examples of the base encompass n-butyllithium, sec-butyllithium, tert-butyllithium, lithium diisopropylamide, lithium hexamethyldisilazane, potassium hexamethyldisilazane, sodium hydride, and potassium hydride. The base is preferably n-butyllithium, lithium diisopropylamide, potassium hexamethyldisilazane, sodium hydride, or potassium hydride.

The compound obtained by the reaction of the compound (2) with the base, the compound (1), and the compound (3) are normally unstable with respect to air and moisture. Therefore, it is preferable that the above reactions be carried out under dehydrated and deoxygenated conditions, and more specifically in an atmosphere of dry nitrogen or dry argon.

The amount of the compound (2) used needs only to be not smaller than 1 molar equivalent relative to the compound (3), preferably in a range from 1.0 to 1.5 molar equivalents. In cases where the reason lefts over the compound (2), the compound (3) may be further added in the reaction.

The reaction of the compounds (2) and (3) is carried out at a temperature in a range from −100° C. to 150° C. and preferably in a range from −80° C. to 50° C. Note that the present invention is not limited to this temperature range.

With regard to a length of time the reaction of the compounds (2) and (3) is carried out, the reaction needs only to be carried out, until a yield of product reaches the highest, preferably for 5 minutes to 48 hours, and more preferably for 10 minutes to 24 hours.

The reaction of the compound (2) and the base is carried out at a temperature in a range from −100° C. to 150° C. and preferably in a range from −80° C. to 50° C. Note that the present invention is not limited to this temperature range.

With regard to a length of time the reaction of the compound (2) and the base is carried out, the reaction needs only to be carried out, until a yield of product reaches the highest, for 5 minutes to 24 hours, preferably for 10 minutes to 12 hours, and more preferably for 30 minutes to 3 hours.

The reaction of (i) the compound formed by the reaction of the compound (2) and the base and (ii) the compound (3) is carried out at a temperature in a range from −100° C. to 150° C. and preferably in a range from −80° C. to 50° C. Note that the present invention is not limited to this temperature range.

With regard to a length of time the reaction of (i) the compound formed by the reaction of the compound (2) and the base and (ii) the compound (3) is carried out, the reaction needs only to be carried out, until a yield of product reaches the highest, for 5 minutes to 48 hours and preferably for 10 minutes to 24 hours.

The reactions may be carried out with any solvent generally used for reactions similar to the above-described reactions, and examples of the solvent for use in the reactions include a hydrocarbon solvent or an ethers type solvent, preferably toluene, benzene, o-xylene, m-xylene, p-xylene, hexane, pentane, heptane, cyclohexane, diethyl ether, or tetrahydrofuran, and more preferably diethyl ether, toluene, tetrahydrofuran, hexane, pentane, heptane, or cyclohexane.

The compound (2) can be synthesized in accordance with a method described in Journal of American Chemical Society, 2009, Volume 131, 13566-13567, for example. More specifically, the compound (2) can be produced by scheme 2 shown below. However, a method for producing the compound (2) should not be limited to the scheme 2. The following will describe the steps of the scheme 2 in detail.

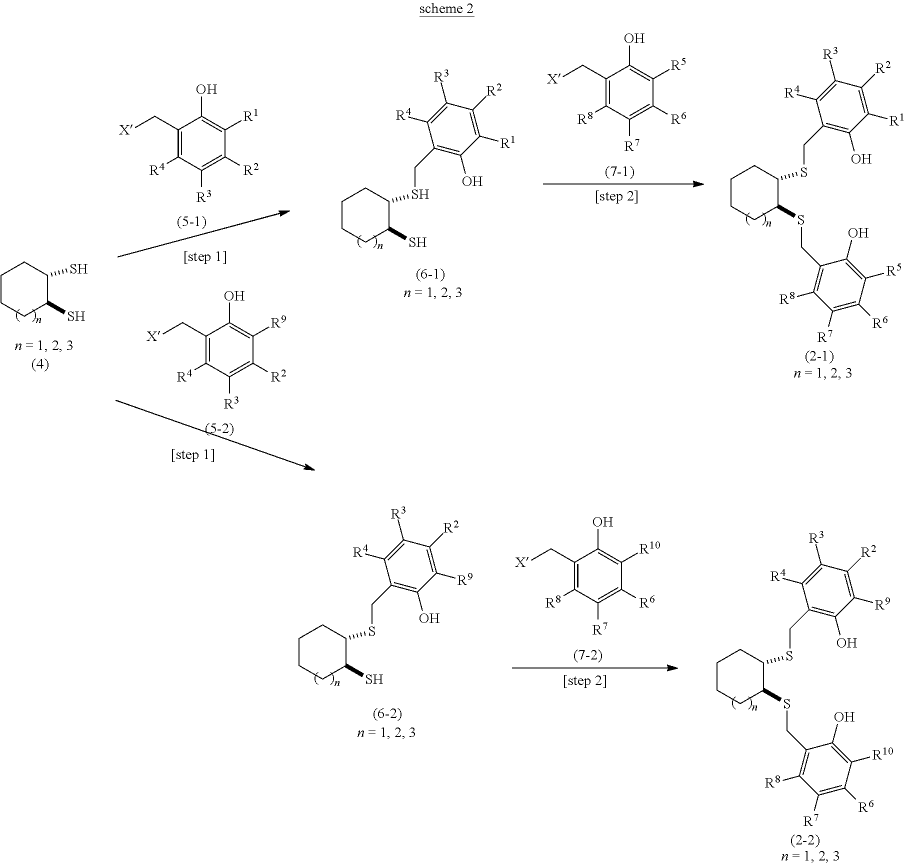

In the scheme 2, R¹ to R¹⁰ and n in the compounds are the same as R¹ to R¹⁰ and n in the complex (1).

Hereinafter, a compound represented by general formula (5-1) or (5-2), a compound represented by general formula (6-1) or (6-2), and a compound represented by general formula (7-1) or (7-2) can also be referred to as the compound represented by general formula (5), the compound represented by general formula (6), and the compound represented by general formula (7), respectively.

X′ represents an anionic leaving group and is, for example, a halogen atom, an acetate group, a trifluoroacetate group, a benzoate group, a CF₃SO₃ group, a CH₃SO₃ group, a 4-MeC₆H₄SO₃ group, a PhSO₃ group, or the like, and preferably a chlorine atom, a bromine atom, an iodine atom, a CF₃SO₃ group, a CH₃SO₃ group, a 4-MeC₆H₄SO₃ group, or a PhSO₃ group.

[Step 1]

A compound (6) can be synthesized by causing a compound (4) to react with a compound (5) of 1.0 to 4.0 equivalents, preferably 1.0 to 1.5 equivalents under the presence of a base.

The base is exemplified by, but is not particularly limited to, an inorganic base, such as potassium carbonate, calcium carbonate, sodium carbonate, sodium bicarbonate, potassium bicarbonate, and calcium bicarbonate, and an amine base such as triethylamine and triisobytylamine, and preferably an amine base.

The reaction in the step 1 can be carried out in an atmosphere of air, helium, argon, or nitrogen, preferably in an atmosphere of helium, argon, or nitrogen, and more preferably in an atmosphere of nitrogen or argon.

After the completion of the reaction, the compound (6) may be purified. A method for the purification is exemplified by the following method. The reaction solution is mixed with an aqueous solution of ammonium chloride, an aqueous solution of hydrochloric acid, or an aqueous solution of sodium chloride. Subsequently, the mixture solution is mixed with ethyl acetate or diethyl ether and then subjected to an extraction operation so that a surplus base or salt is removed. An additional purification operation such as distillation, recrystallization, or silica gel chromatography allows the compound (6) to have a higher purity.

[Step 2]

The compound (2) can be synthesized by causing the compound (6) to react with 1.0 to 4.0 equivalents, and preferably 1.0 to 1.5 equivalents of a compound (7) under the presence of the base.

The base is exemplified by an inorganic base, such as potassium carbonate, calcium carbonate, sodium carbonate, sodium bicarbonate, potassium bicarbonate, and calcium bicarbonate, and an amine base such as triethylamine and triisobutylamine, and preferably an amine base.

The reaction in the step 2 can be carried out in an atmosphere of air, helium, argon, or nitrogen, preferably in an atmosphere of helium, argon, or nitrogen, and more preferably in an atmosphere of nitrogen or argon.

After the completion of the reaction, the compound (2) may be purified according to need. A method for the purification is exemplified by the following method. The reaction solution is mixed with an aqueous solution of ammonium chloride, an aqueous solution of hydrochloric acid, or an aqueous solution of sodium chloride is added to. Subsequently, the mixture solution is mixed with ethyl acetate or diethyl ether and then subjected to an extraction operation so that a surplus base or salt is removed. An additional purification operation such as distillation, recrystallization, or silica gel chromatography allows the compound (2) to have a higher purity.

The compound (2) can also be obtained by causing the compound (6), which has been produced in a reactor, and the compound (7) to react with each other in the reactor by controlling the reaction condition in the [step 1].

In a case where R¹ is the same as R⁵ (or R⁹ is the same as R¹⁰), R² is the same as R⁶, R³ is the same as R⁷, and R⁴ is the same as R⁸, the compound (2) can be synthesized by mixing the compound (5) and the compound (7) together, and in the presence of a base, reacting the compound (4) with the mixture of 2.0 to 8.0 equivalents, and preferably 2.0 to 4.0 equivalents with respect to the compound (4).

Examples of the compound represented by the general formula (2-1) include the following compounds. However, the compound represented by the general formula (2-1) is not meant to be limited to these compounds.

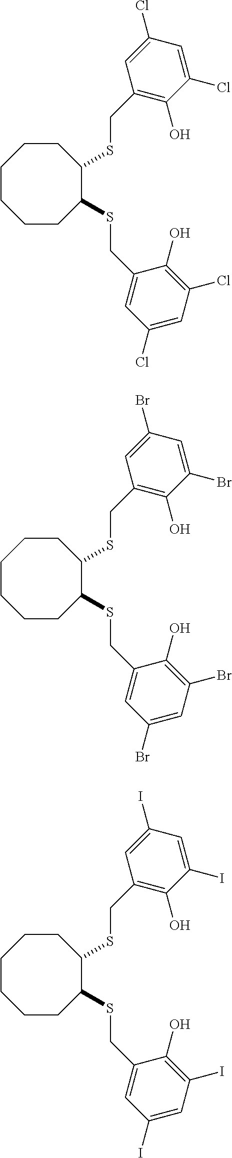

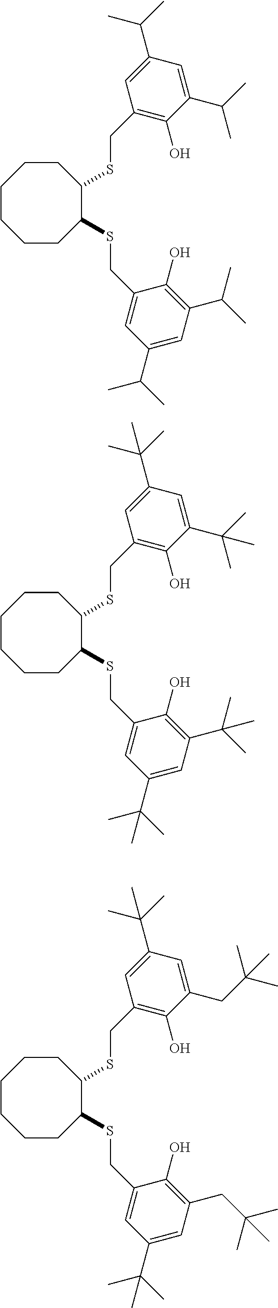

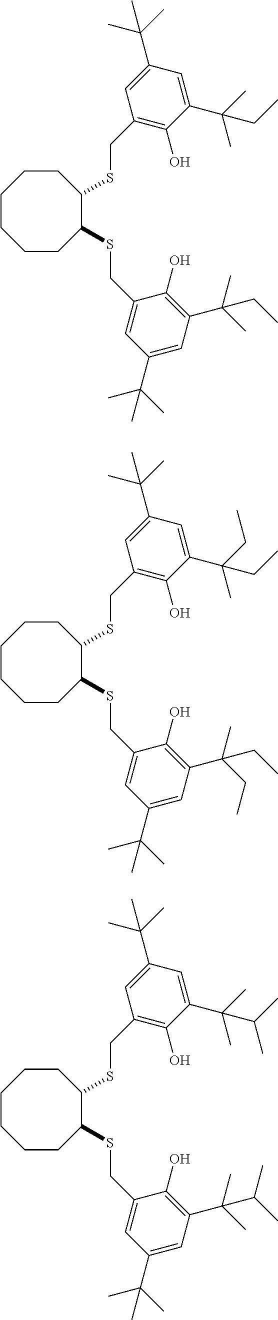

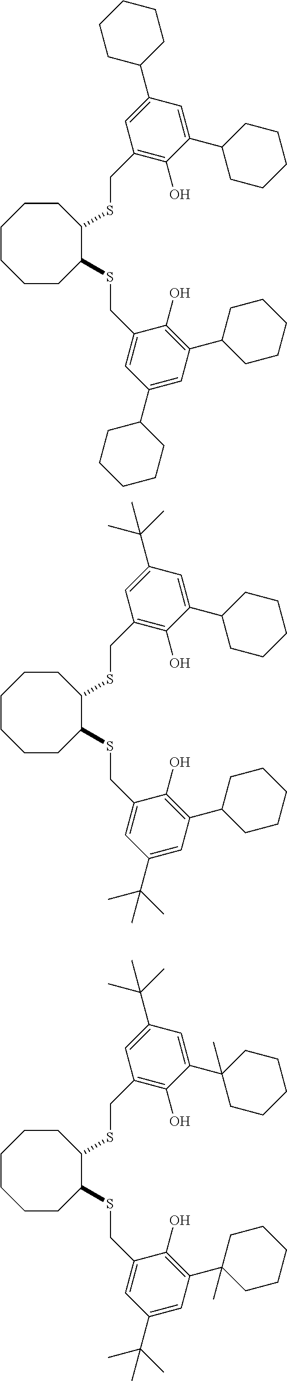

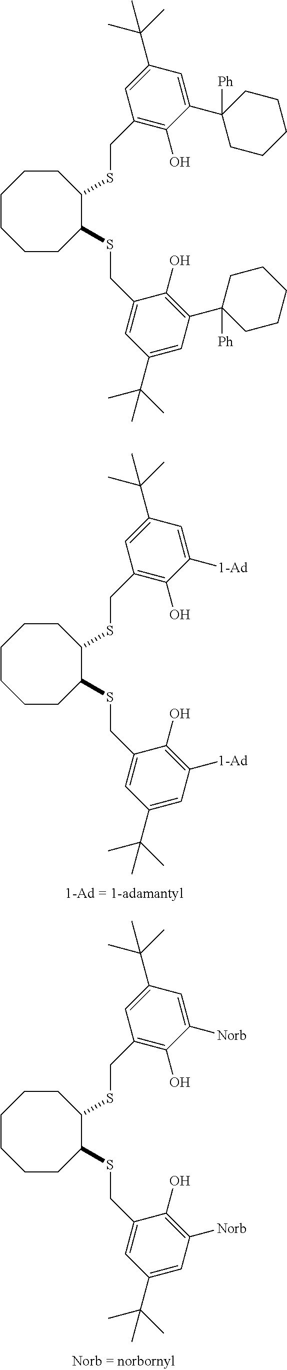

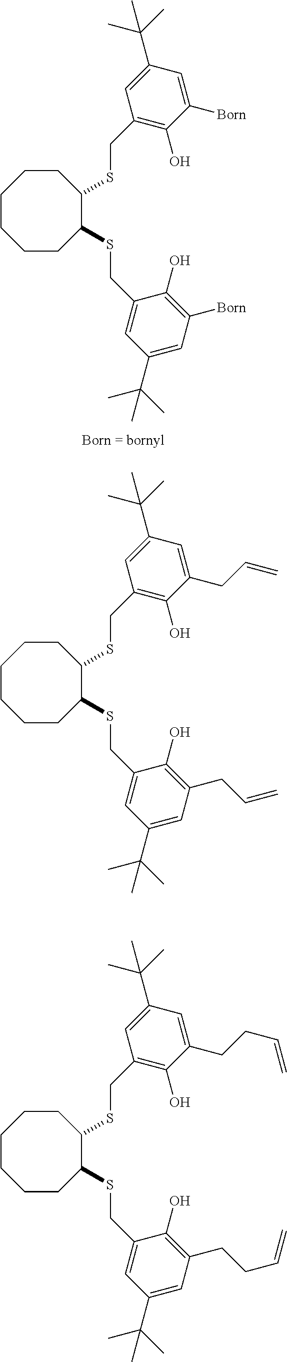

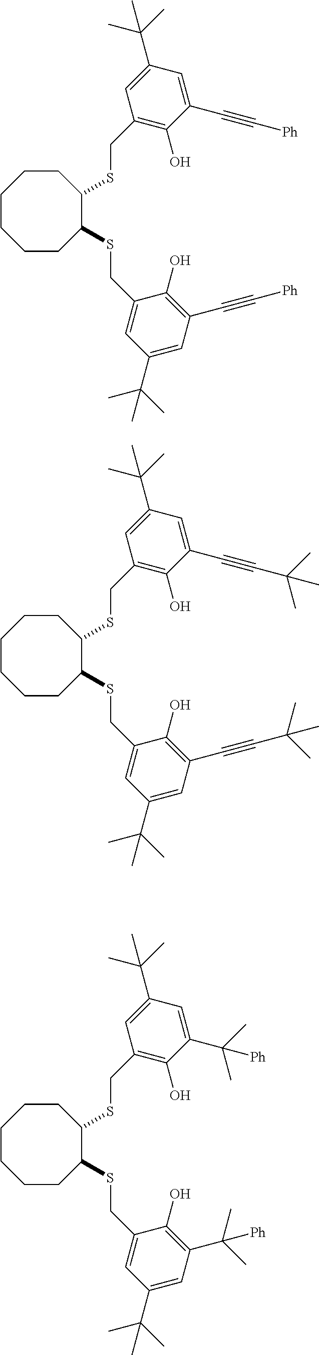

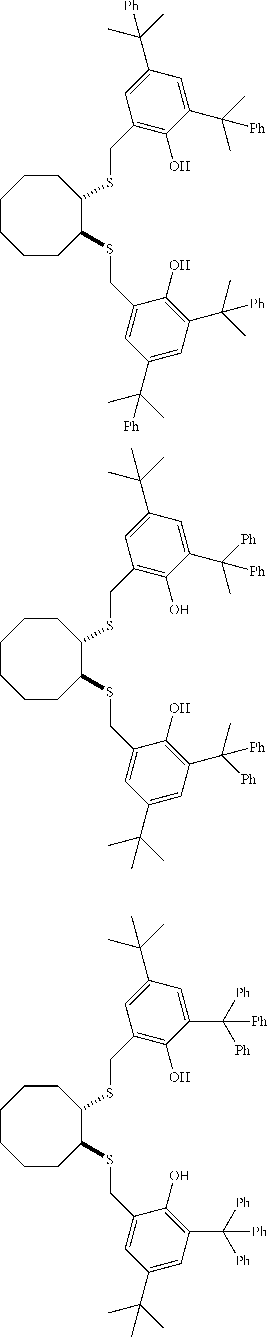

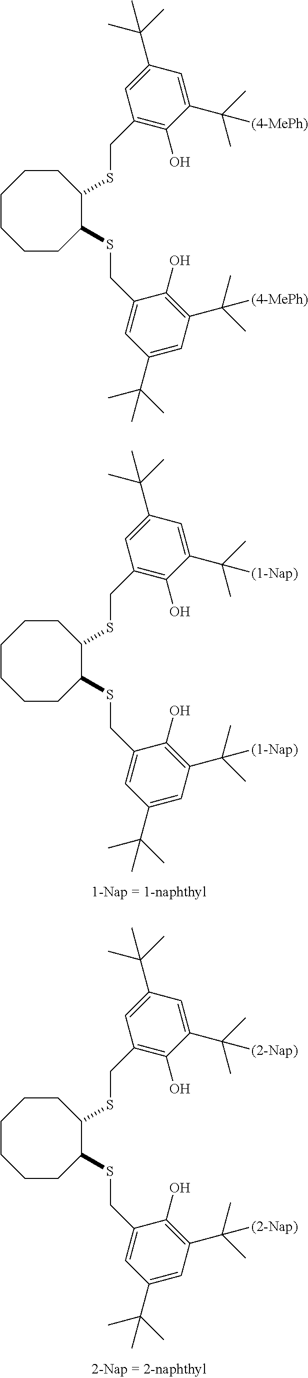

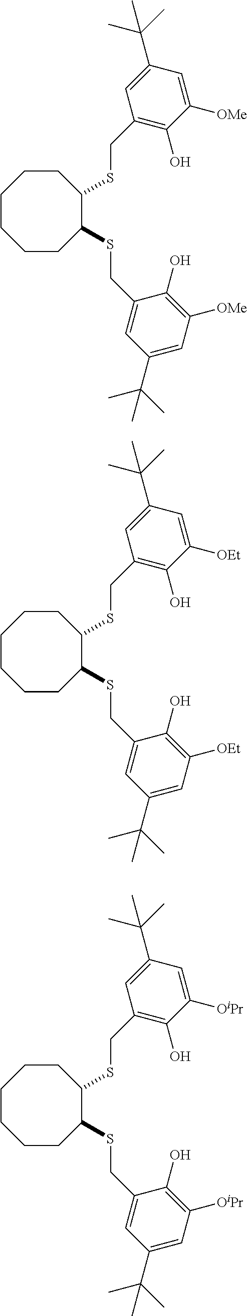

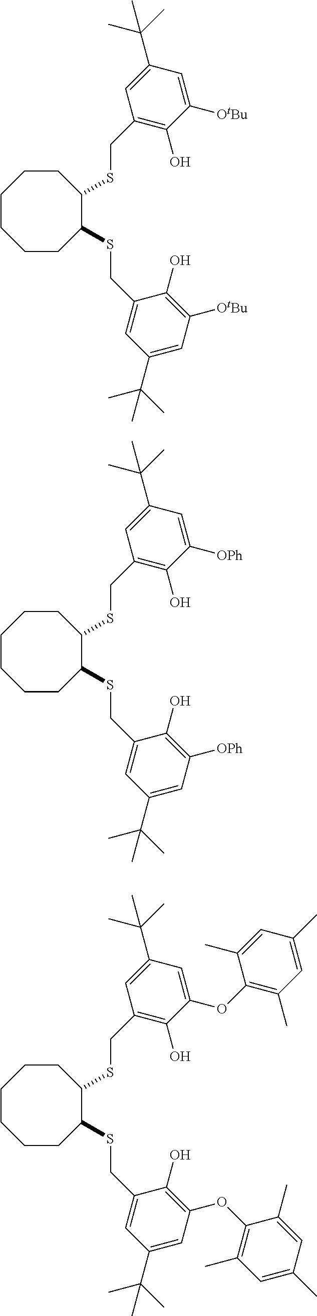

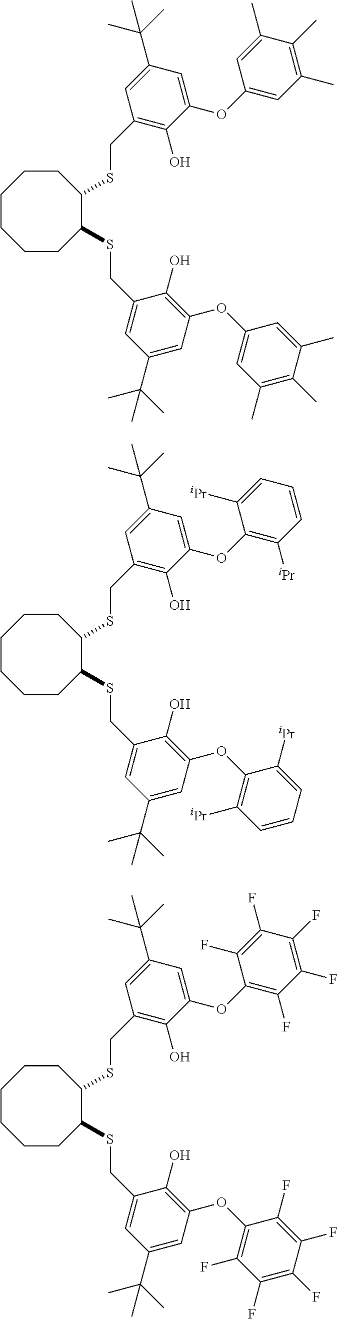

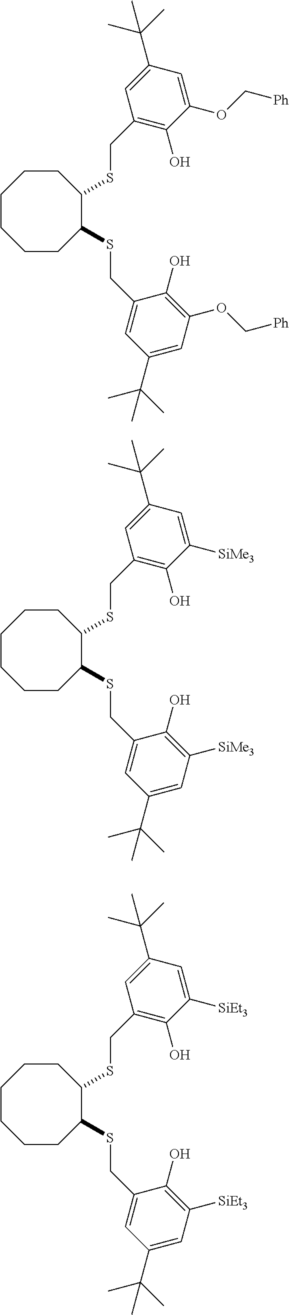

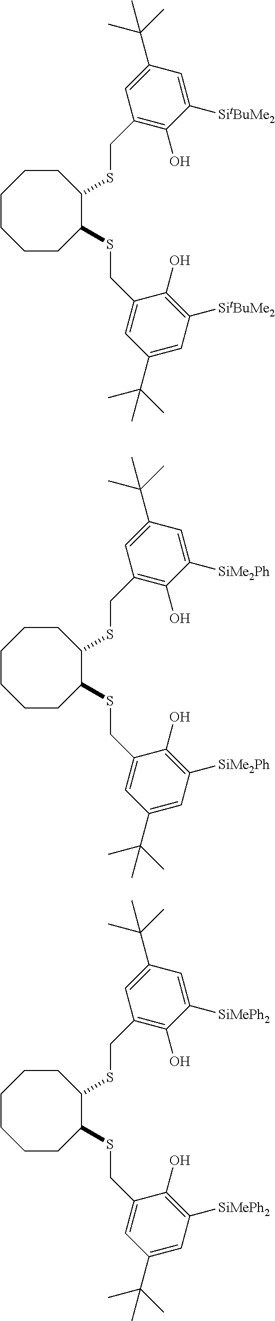

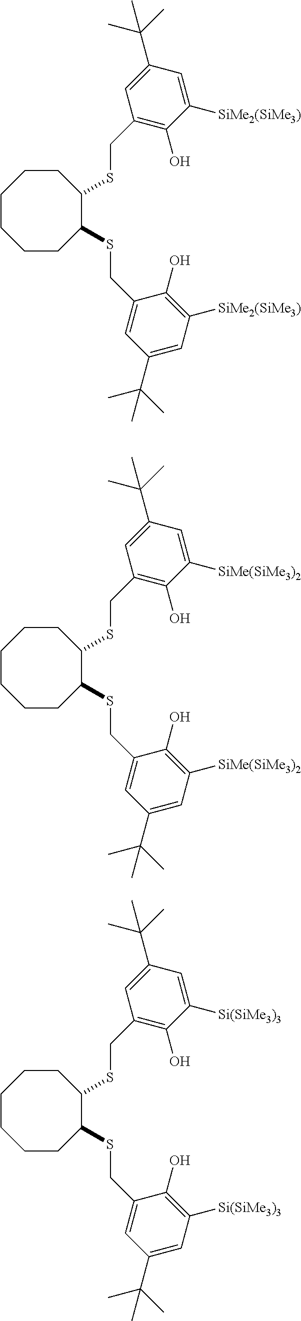

In addition to these compounds as shown above, the compound represented by the general formula (2-1) can be exemplified by compounds obtainable by substituting R³ and R⁷ of these compounds independently with a hydrogen atom or a methyl group.

The compound represented by the general formula (2-1) can also be exemplified by compounds obtainable by substituting the cyclooctane ring bound to the sulfur atoms of these compounds with a cycloheptane ring or a cyclohexane ring.

Examples of the compound represented by the general formula (2-2) include not only the above examples of the compounds (2-1) but also the following compounds and compounds obtainable by modifying these compounds such that R³ and R⁷ are independently a hydrogen atom or a methyl group.

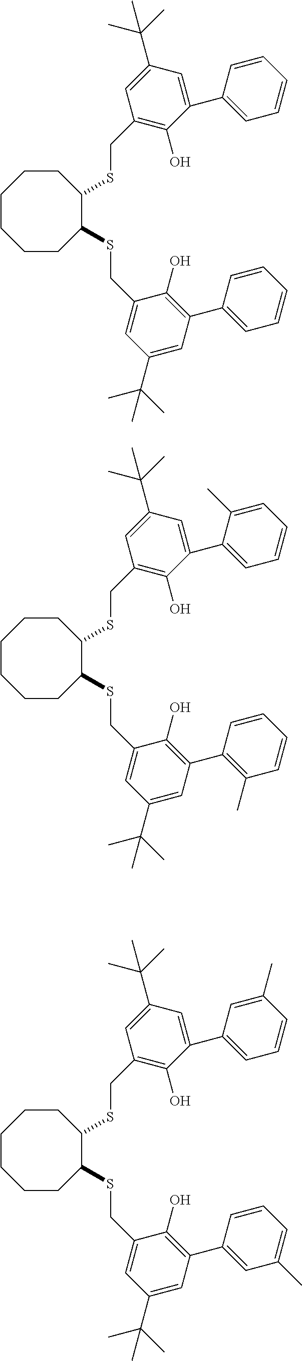

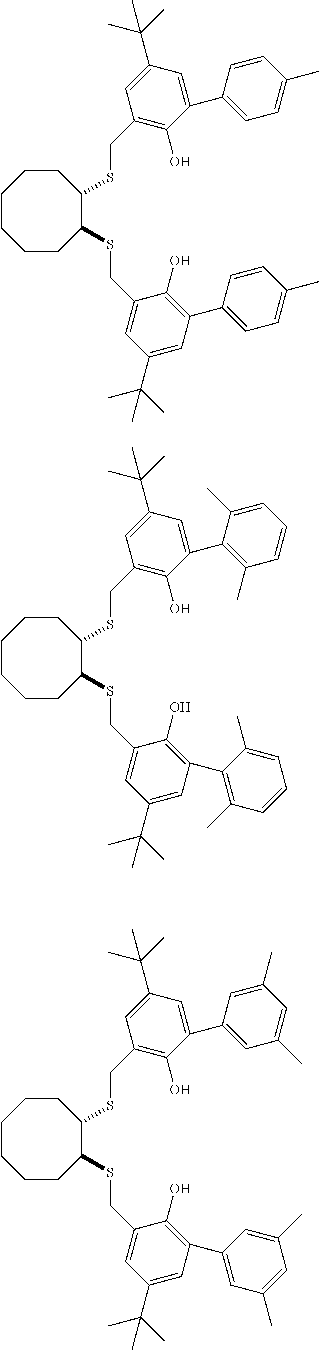

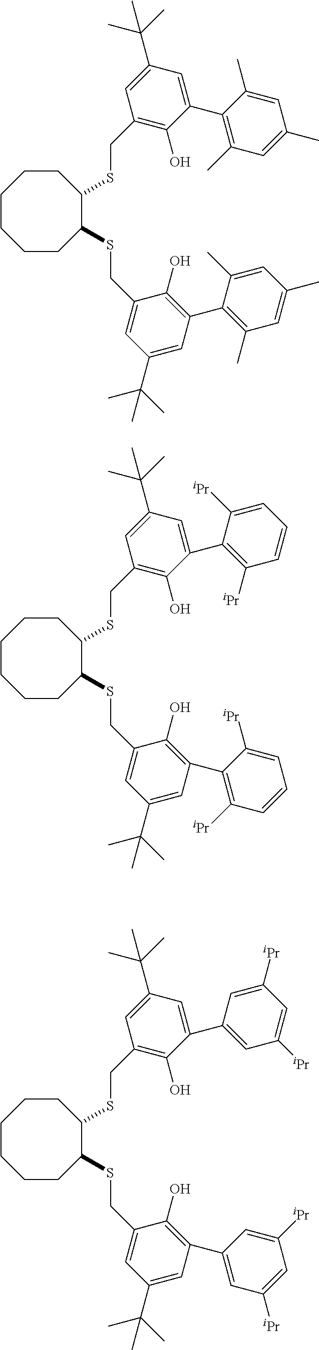

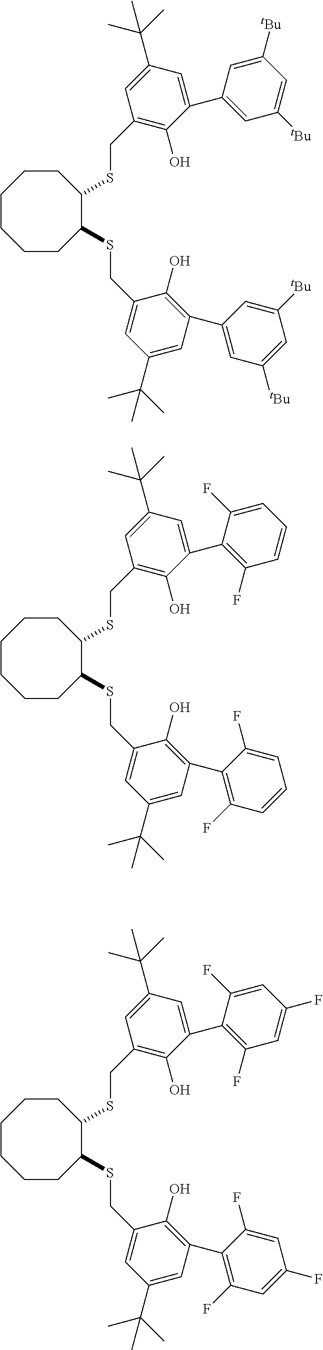

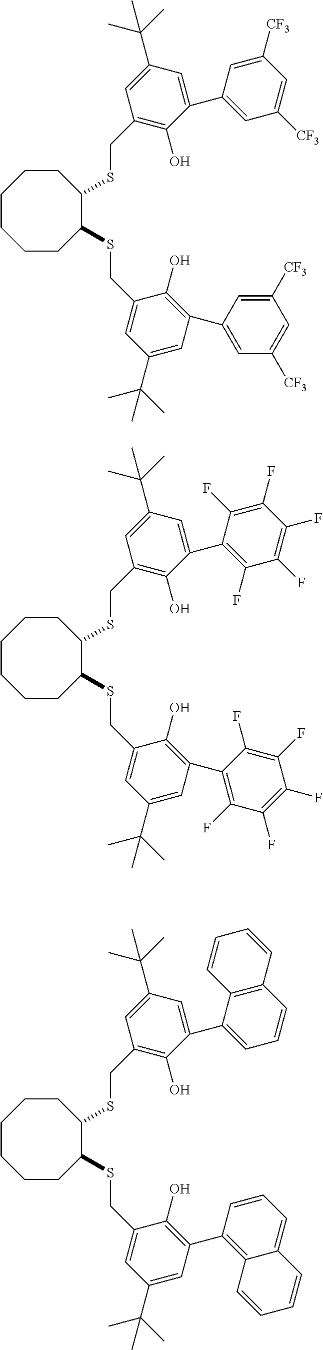

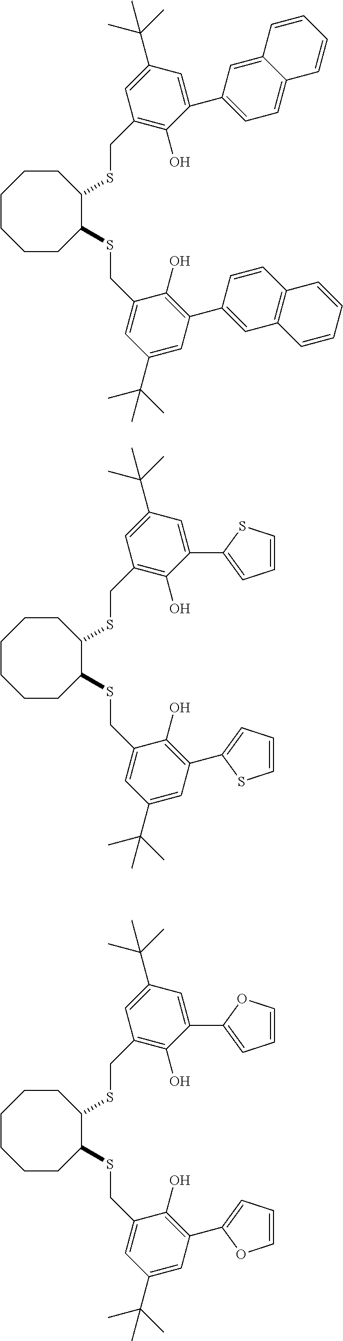

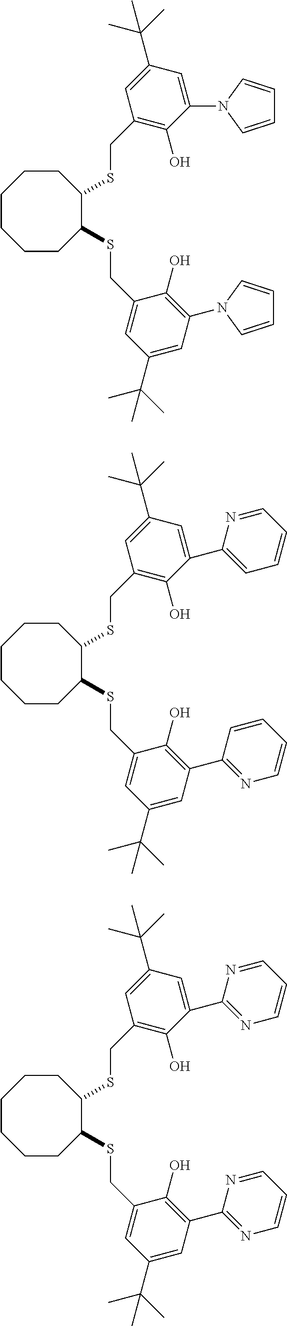

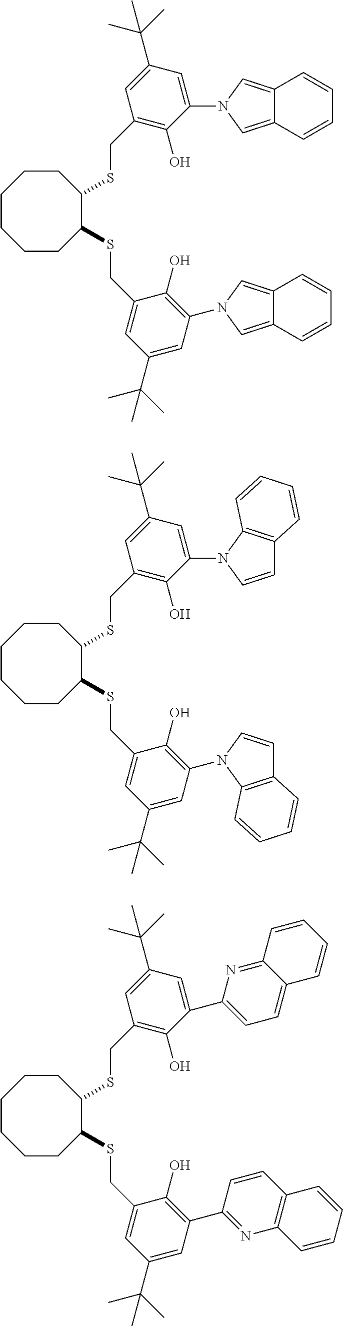

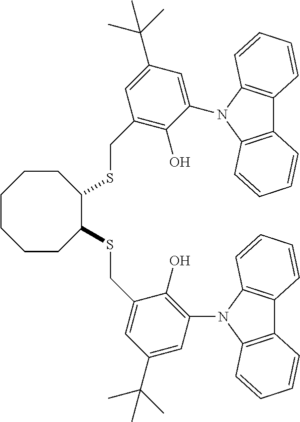

The compound represented by the general formula (2-2) can also be exemplified by compounds obtainable by substituting the cyclooctane ring bound to the sulfur atoms of these compounds with a cycloheptane ring or a cyclohexane ring.

Examples of the compound represented by the general formula (5-1) and the compound represented by the general formula (7-1) include the following compounds. However, the compound represented by the general formula (5-1) and the compound represented by the general formula (7-1) are not meant to be limited to these compounds.

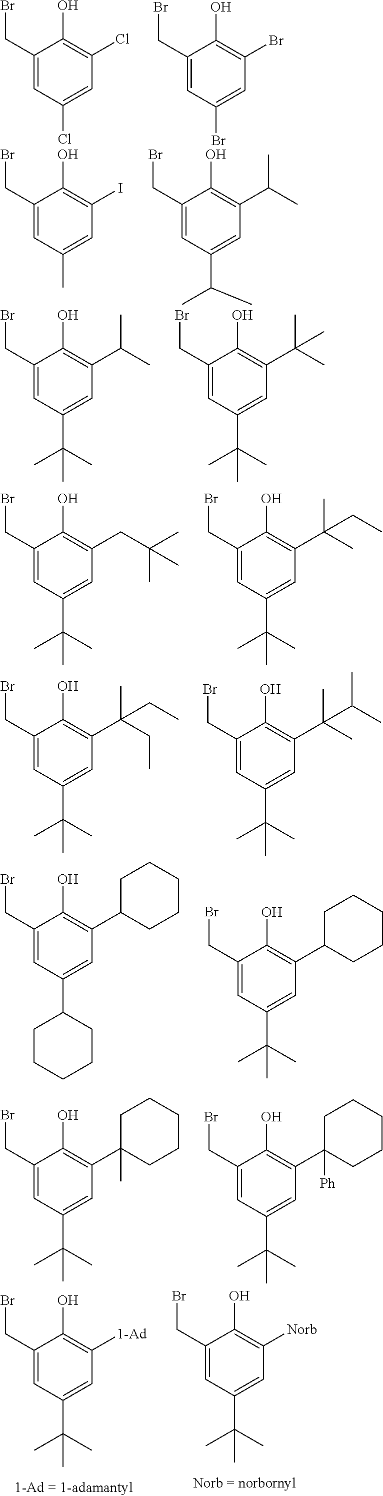

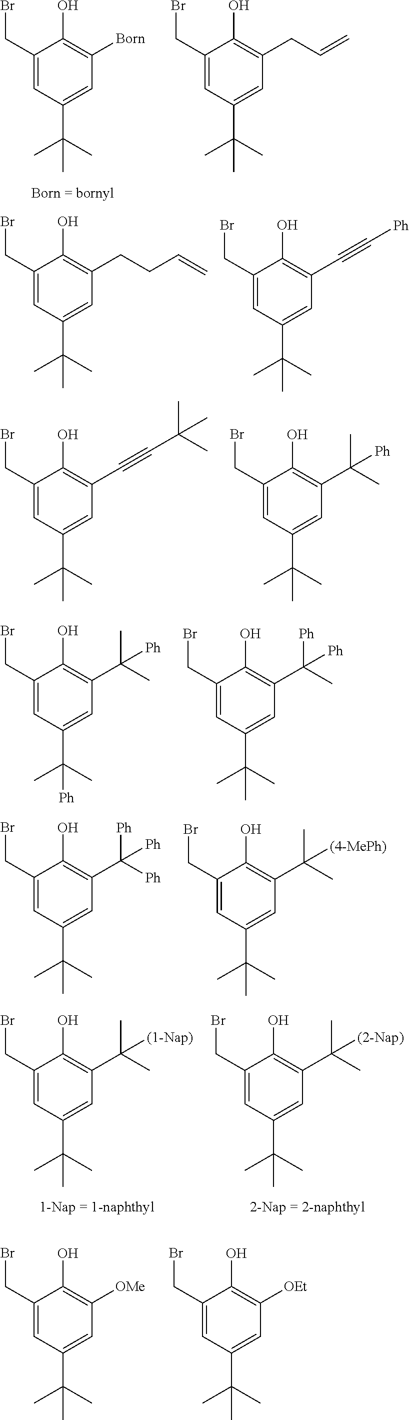

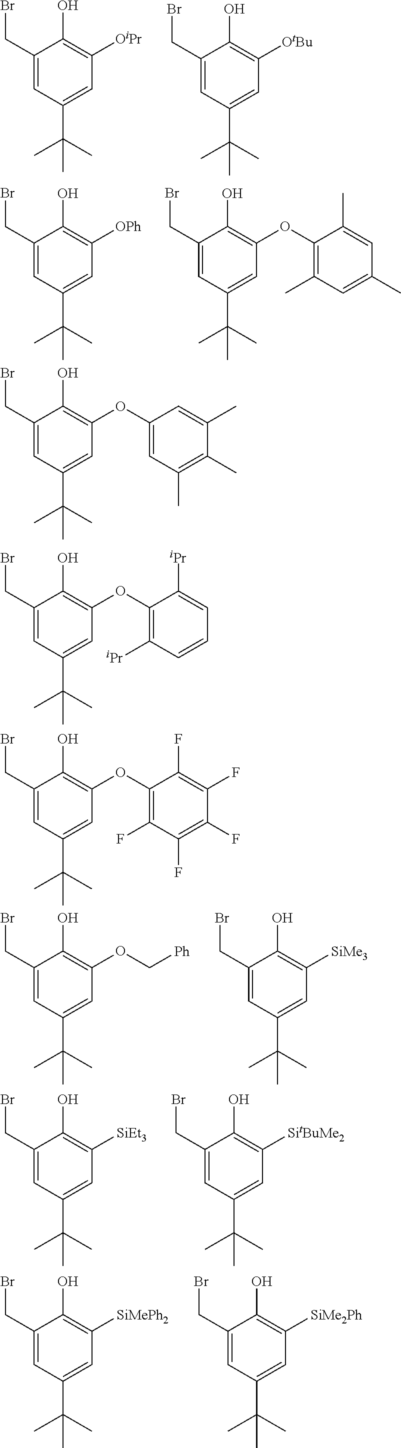

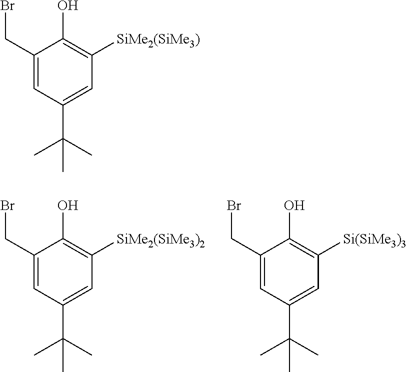

In addition to these compounds as shown above, the compound represented by the general formula (5-1) and the compound represented by the general formula (7-1) can be exemplified by compounds each obtained by modifying the above compounds such that R³ and R⁷ are independently a hydrogen atom or a methyl group.

Examples of the compound represented by the general formula (5-2) and the compound represented by the general formula (7-2) include not only the above specific examples of the compound represented by the general formula (5-1) and the compound represented by the general formula (7-1) but also the following compounds and compounds each obtainable by modifying these compounds such that R³ and R⁷ are independently a hydrogen atom or a methyl group.

Substance (A2)

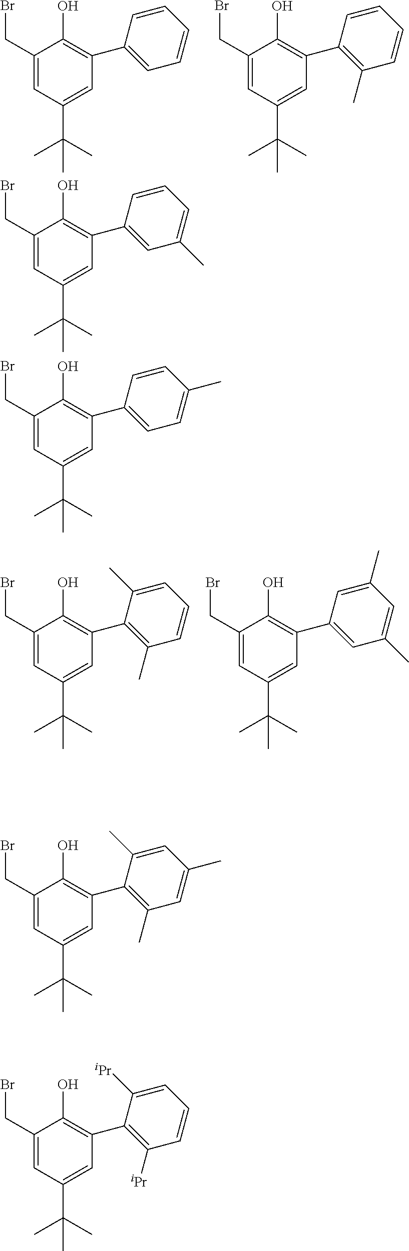

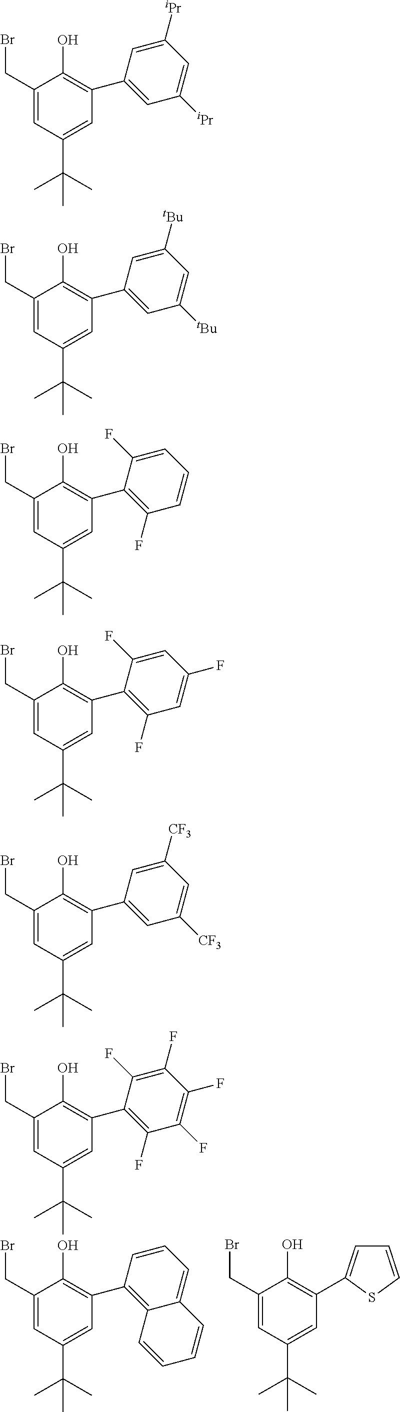

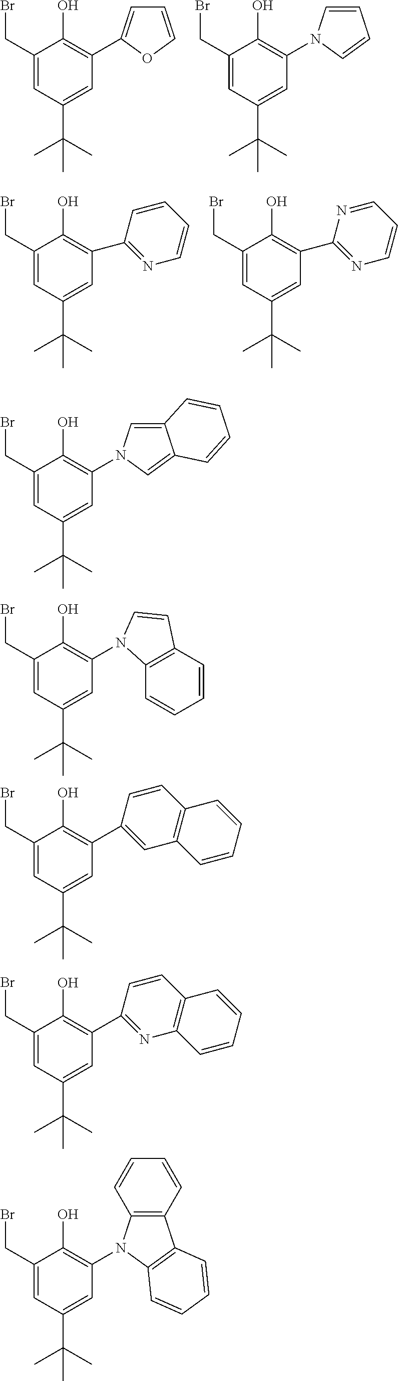

A substance (A2) is described below. The substance (A2) is a transition metal compound represented by the general formula (8) or a μ-oxo-type dimer of a transition metal compound represented by the general formula (8).

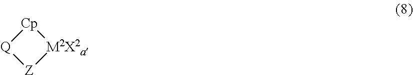

(where: M² is a transition metal atom of any of Groups 4 to 11 of the periodic table of the elements; Cp is a group having a cyclopentadienide skeleton, and Z is a group having a cyclopentadienide skeleton or a group containing a hetero atom; Q is a bridging group which links a cyclopentadienyl group to Z; Cp and Z are the same or different when each of Cp and Z is a group having a cyclopentadienide skeleton;
each X² is independently:
a hydrogen atom,
a halogen atom,
an alkyl group having 1 to 20 carbon atoms,
a cycloalkyl group having 3 to 10 ring carbon atoms,
an alkenyl group having 2 to 20 carbon atoms,
an aralkyl group having 7 to 30 carbon atoms,
an aryl group having 6 to 30 carbon atoms,
an alkoxy group having 1 to 20 carbon atoms,
an aralkyloxy group having 7 to 30 carbon atoms,
an aryloxy group having 6 to 30 carbon atoms,
a substituted silyl group,
a substituted amino group,
a substituted thiolate group, or
a carboxylato group having 1 to 20 carbon atoms; and
a′ is a number which satisfies 1≦a′≦3.)
M² is a transition metal atom of any of Groups 4 to 11 of the periodic table of the elements, preferably a transition metal atom of Group 4, specifically a titanium atom, a zirconium atom, or a hafnium atom, and particularly preferably a titanium atom or a zirconium atom.

The group which has a cyclopentadienide skeleton in Cp or Z is, for example, a substituted or unsubstituted cyclopentadienyl group, a substituted or unsubstituted indenyl group, or a substituted or unsubstituted fluorenyl group. Specific examples of such a group encompass cyclopentadienyl group, methylcyclopentadienyl group, ethylcyclopentadienyl group, n-butylcyclopentadienyl group, tert-butylcyclopentadienyl group, dimethylcyclopentadienyl group, ethyl(methyl)cyclopentadienyl group, tert-butyl(methyl)cyclopentadienyl group, isopropyl(methyl)cyclopentadienyl group, methyl(n-butyl)cyclopentadienyl group, trimethylcyclopentadienyl group, tetramethylcyclopentadienyl group, indenyl group, 4,5,6,7-tetrahydroindenyl group, 2-methylindenyl group, 3-methylindenyl group, 4-methylindenyl group, 5-methylindenyl group, 6-methylindenyl group, 7-methylindenyl group, 2-tert-butylindenyl group, 3-tert-butylindenyl group, 4-tert-butylindenyl group, 5-tert-butylindenyl group, 6-tert-butylindenyl group, 7-tert-butylindenyl group, 2,3-dimethylindenyl group, 4,7-dimethylindenyl group, 2,4,7-trimethylindenyl group, 2-methyl-4-isopropylindenyl group, 4,5-benzindenyl group, 2-methyl-4,5-benzindenyl group, 4-phenylindenyl group, 2-methyl-5-phenylindenyl group, 2-methyl-4-phenylindenyl group, 2-methyl-4-naphthylindenyl group, fluorenyl group, 2,7-dimethylfluorenyl group, and 2,7-di-tert-butylfluorenyl group.

The number of atoms r which the group having a cyclopentadienide skeleton in Cp or Z coordinates to M² may be any value that the group having the cyclopentadienide skeleton can coordinate. The number of atoms qr is preferably 5, 3, or 1, and more preferably 5 or 3.

Cp and Z may be the same or different when Z is a group having a cyclopentadienide skeleton.

Z may be a group containing a hetero atom. Z denotes a group represented by, for example, —O—, —S—, —NRⁱ—, —PRⁱ—, or any one of the following formulae (i) to (iv). Note that an atom which is contained in Z and is coupled with M² is an oxygen atom, a sulfur atom, a nitrogen atom, or a phosphorus atom.

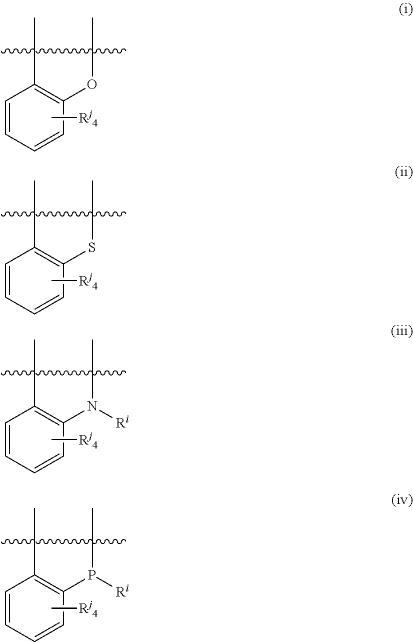

where:
Rⁱ and R^{j} are independently
a hydrogen atom,
a halogen atom,
an alkyl group having 1 to 20 carbon atoms,
a cycloalkyl group having 3 to 10 ring carbon atoms,
an alkenyl group having 2 to 20 carbon atoms,
an alkynyl group having 2 to 20 carbon atoms,
an aralkyl group having 7 to 30 carbon atoms,
an aryl group having 6 to 30 carbon atoms,
an alkoxy group having 1 to 20 carbon atoms,
an aralkyloxy group having 7 to 30 carbon atoms,
an aryloxy group having 6 to 30 carbon atoms,
a substituted silyl group, or
a heterocyclic compound residue having 3 to 20 ring carbon atoms. The alkyl group, the cycloalkyl group, the alkenyl group, the alkynyl group, the aralkyl group, the aryl group, the alkoxy group, the aralkyloxy group, the aryloxy group, and the heterocyclic compound residue represented by Rⁱ and R^{j} may have a substituent.

Rⁱ is preferably a hydrogen atom, a halogen atom, an alkyl group having 1 to 20 carbon atoms, an aralkyl group having 7 to 30 carbon atoms, an aryl group having 6 to 30 carbon atoms, or a substituted silyl group.

R^{j} is preferably a hydrogen atom, a halogen atom, an alkyl group having 1 to 20 carbon atoms, an aralkyl group having 7 to 30 carbon atoms, an aryl group having 6 to 30 carbon atoms, an alkoxy group having 1 to 20 carbon atoms, an aralkyloxy group having 7 to 30 carbon atoms, an aryloxy group having 6 to 30 carbon atoms, or a substituted silyl group. The adjacent two R^{j}′ groups may be linked to each other to form a ring.

A group containing a hetero atom of Z is preferably —NRⁱ— or a group represented by the above formula (i).

Q is a group which bridges Cp and Z, and for example is an alkylene group such as a methylene group, an ethylene group, and a propylene group; a substituted alkylene group such as a dimethylmethylene group (isopropylidene group) and a diphenylmethylene group; a substituted silylene group such as a silylene group, a dimethylsilylene group, a diethylsilylene group, a diphenylsilylene group, a tetramethyldisilylene group, and a dimethoxysilylene group; or a hetero atom, such as a nitrogen atom, an oxygen atom, a sulfur atom, and a phosphorus atom. Preferably, it is a methylene group, an ethylene group, a dimethylmethylene group (isopropylidene group), a diphenylmethylene group, a dimethylsilylene group, a diethylsilylene group, a diphenylsilylene group, or a dimethoxysilylene group.

Examples of a halogen atom of X² include a fluorine atom, a chlorine atom, a bromine atom, and an iodine atom.

Examples of an alkyl group having 1 to 20 carbon atoms of X² are, for example, methyl group, ethyl group, n-propyl group, isopropyl group, n-butyl group, sec-butyl group, tert-butyl group, isobutyl group, n-pentyl, neopentyl group, amyl group, n-hexyl group, n-octyl group, n-decyl group, n-dodecyl group, n-pentadecyl group, and n-eicosyl group; among these, more preferable are methyl group, ethyl group, isopropyl group, tert-butyl group, isobutyl group, or amyl group. Each of these alkyl groups may have a halogen atom such as a fluorine atom, a chlorine atom, a bromine atom, and iodine atoms, as a substituent. Examples of an alkyl group having a halogen atom as a substituent encompass fluoromethyl group, trifluoromethyl group, chloromethyl group, trichloromethyl group, fluoroethyl group, pentafluoroethyl group, perfluoropropyl group, perfluorobutyl group, perfluorohexyl group, perfluorooctyl group, perchloropropyl group, perchlorobutyl group, and perbromopropyl group. Moreover, these alkyl groups may have an alkoxy group such as methoxy group or ethoxy group, an aryloxy group such as phenoxy group, an aralkyloxy group such as benzyloxy group, or like group, as a substituent.

Examples of an aralkyl group having 7 to 30, preferably 7 to 20 carbon atoms of X² include benzyl group, (2-methylphenyl)methyl group, (3-methylphenyl)methyl group, (4-methylphenyl)methyl group, (2,3-dimethylphenyl)methyl group, (2,4-dimethylphenyl)methyl group, (2,5-dimethylphenyl)methyl group, (2,6-dimethylphenyl)methyl group, (3,4-dimethylphenyl)methyl group, (3,5-dimethylphenyl)methyl group, (2,3,4-trimethylphenyl)methyl group, (2,3,5-trimethylphenyl)methyl group, (2,3,6-trimethylphenyl)methyl group, (3,4,5-trimethylphenyl)methyl group, (2,4,6-trimethylphenyl)methyl group, (2,3,4,5-tetramethylphenyl)methyl group, (2,3,4,6-tetramethylphenyl)methyl group, (2,3,5,6-tetramethylphenyl)methyl group, (pentamethylphenyl)methyl group, (ethylphenyl)methyl group, (n-propylphenyl)methyl group, (isopropylphenyl)methyl group, (n-butylphenyl)methyl group, (sec-butylphenyl)methyl group, (tert-butylphenyl)methyl group, (n-pentyl phenyl)methyl group, (neopentylphenyl)methyl group, (n-hexylphenyl)methyl group, (n-octylphenyl)methyl group, (n-decylphenyl)methyl group, (n-dodecylphenyl)methyl group, naphthylmethyl group, and anthracenylmethyl group; benzyl group is more preferable. These aralkyl groups may have, as a substituent, a halogen atom such as a fluorine atom, a chlorine atom, a bromine atom, or an iodine atom, an alkoxy group such as methoxy group or ethoxy group, an aryloxy group such as phenoxy group, or an aralkyloxy group such as benzyloxy group, or like group.

Examples of an aryl group having 6 to 30, preferably 6 to 20 carbon atoms of X² include phenyl group, 2-tolyl group, 3-tolyl group, 4-tolyl group, 2,3-xylyl group, 2,4-xylyl group, 2,5-xylyl group, 2,6-xylyl group, 3,4-xylyl group, 3,5-xylyl group, 2,3,4-trimethylphenyl group, 2,3,5-trimethylphenyl group, 2,3,6-trimethylphenyl group, 2,4,6-trimethylphenyl group, 3,4,5-trimethylphenyl group, 2,3,4,5-tetramethylphenyl group, 2,3,4,6-tetramethylphenyl group, 2,3,5,6-tetramethylphenyl group, pentamethylphenyl group, ethylphenyl group, n-propylphenyl group, isopropylphenyl group, n-butylphenyl group, sec-butylphenyl group, tert-butylphenyl group, n-pentylphenyl group, neopentylphenyl group, n-hexylphenyl group, n-octylphenyl group, n-decylphenyl group, n-dodecylphenyl group, n-tetradecylphenyl group, naphthyl group, and anthracenyl group; more preferably, phenyl group. These aryl groups may have, as a substituent, a halogen atom such as a fluorine atom, a chlorine atom, a bromine atom, or an iodine atom, an alkoxy group such as methoxy group or ethoxy group, an aryloxy group such as phenoxy group, an aralkyloxy group such as benzyloxy group, or like group.

Examples of an alkenyl group having 2 to 20, preferably 3 to 20 carbon atoms of X² include allyl group, methallyl group, crotyl group, and 1,3-diphenyl-2-propenyl group, and among those, allyl group or methallyl group is more preferable.

Examples of an alkoxy group having 1 to 20 carbon atoms of X² include methoxy group, ethoxy group, n-propoxy group, isopropoxy group, n-butoxy group, sec-butoxy group, tert-butoxy group, n-pentoxy group, neopentoxy group, n-hexoxy group, n-octoxy group, n-dodesoxy group, n-pentadesoxy group, and n-icosoxy group; among them, methoxy group, ethoxy group, isopropoxy group, or tert-butoxy group is preferable.

These alkoxy groups may have, as a substituent, a halogen atom such as a fluorine atom, a chlorine atom, a bromine atom, or an iodine atom, an alkoxy group such as methoxy group or ethoxy group, an aryloxy group such as phenoxy group, an aralkyloxy group such as benzyloxy group, or like group.

Examples of an aralkyloxy group having 7 to 30, preferably 7 to 20 carbon atoms of X² include benzyloxy group, (2-methylphenyl)methoxy group, (3-methylphenyl)methoxy group, (4-methylphenyl)methoxy group, (2,3-dimethylphenyl)methoxy group, (2,4-dimethylphenyl)methoxy group, (2,5-dimethylphenyl)methoxy group, (2,6-dimethylphenyl)methoxy group, (3,4-dimethylphenyl)methoxy group, (3,5-dimethylphenyl)methoxy group, (2,3,4-trimethylphenyl)methoxy group, (2,3,5-trimethylphenyl)methoxy group, (2,3,6-trimethylphenyl)methoxy group, (2,4,5-trimethylphenyl)methoxy group, (2,4,6-trimethylphenyl)methoxy group, (3,4,5-trimethylphenyl)methoxy group, (2,3,4,5-tetramethylphenyl)methoxy group, (2,3,4,6-tetramethylphenyl)methoxy group, (2,3,5,6-tetramethylphenyl)methoxy group, (pentamethylphenyl)methoxy group, (ethylphenyl)methoxy group, (n-propylphenyl)methoxy group, (isopropylphenyl)methoxy group, (n-butylphenyl)methoxy group, (sec-butylphenyl)methoxy group, (tert-butylphenyl)methoxy group, (n-hexylphenyl)methoxy group, (n-octylphenyl)methoxy group, (n-decylphenyl)methoxy group, naphthylmethoxy group, and anthracenylmethoxy group; among these, benzyloxy group is more preferable. These aralkyloxy groups may have, as a substituent, a halogen atom such as a fluorine atom, a chlorine atom, a bromine atom, or an iodine atom, an alkoxy group such as methoxy group or ethoxy group, an aryloxy group such as phenoxy group, an aralkyloxy group such as benzyloxy group, or like group.

Examples of an aryloxy group having 6 to 30, preferably 6 to 20 carbon atoms of X² include phenoxy group, 2-methylphenoxy group, 3-methylphenoxy group, 4-methylphenoxy group, 2,3-dimethylphenoxy group, 2,4-dimethylphenoxy group, 2,5-dimethylphenoxy group, 2,6-dimethylphenoxy group, 3,4-dimethylphenoxy group, 3,5-dimethylphenoxy group, 2-tert-butyl-3-methylphenoxy group, 2-tert-butyl-4-methylphenoxy group, 2-tert-butyl-5-methylphenoxy group, 2-tert-butyl-6-methylphenoxy group, 2,3,4-trimethylphenoxy group, 2,3,5-trimethylphenoxy group, 2,3,6-trimethylphenoxy group, 2,4,5-trimethylphenoxy group, 2,4,6-trimethylphenoxy group, 2-tert-butyl-3,4-dimethylphenoxy group, 2-tert-butyl-3,5-dimethylphenoxy group, 2-tert-butyl-3,6-dimethylphenoxy group, 2,6-di-tert-butyl-3-methylphenoxy group, 2-tert-butyl-4,5-dimethylphenoxy group, 2,6-di-tert-butyl-4-methylphenoxy group, 3,4,5-trimethylphenoxy group, 2,3,4,5-tetramethylphenoxy group, 2-tert-butyl-3,4,5-trimethylphenoxy group, 2,3,4,6-tetramethylphenoxy group, 2-tert-butyl-3,4,6-trimethylphenoxy group, 2,6-di-tert-butyl-3,4-dimethylphenoxy group, 2,3,5,6-tetramethylphenoxy group, 2-tert-butyl-3,5,6-trimethylphenoxy group, 2,6-di-tert-butyl-3,5-dimethylphenoxy group, pentamethylphenoxy group, ethylphenoxy group, n-propylphenoxy group, isopropylphenoxy group, n-butylphenoxy group, sec-butylphenoxy group, tert-butylphenoxy group, n-hexylphenoxy group, n-octylphenoxy group, n-decylphenoxy group, n-tetradecylphenoxy group, naphthoxy group, and anthracenoxy group. These aryloxy groups may have, as a substituent, a halogen atom such as a fluorine atom, a chlorine atom, a bromine atom, or an iodine atom, an alkoxy group such as methoxy group or ethoxy group, an aryloxy group such as phenoxy group, an aralkyloxy group such as benzyloxy group, or like group.

Examples of a substituted silyl group of X² include trimethylsilyl group, triethylsilyl group, tri-n-propylsilyl group, triisopropylsilyl group, tri-n-butylsilyl group, triisobutylsilyl group, tert-butyldimethylsilyl group, methyldiphenylsilyl group, dimethyl(phenyl)silyl group, tert-butyldiphenylsilyl group, triphenylsilyl group, methylbis(trimethylsilyl)silyl group, dimethyl(trimethylsilyl)silyl group, and tris(trimethylsilyl)silyl group. Preferable examples include: trialkylsilyl groups having 3 to 20 carbon atoms such as trimethylsilyl group, triethylsilyl group, tri-n-propylsilyl group, triisopropylsilyl group, and tert-butyldimethylsilyl group; and silyl groups having a hydrocarbylsilyl group having 3 to 20 carbon atoms as a substituent, such as methylbis(trimethylsilyl)silyl group, dimethyl(trimethylsilyl)silyl group and tris(trimethylsilyl)silyl group.

Examples of a substituted amino group of X include a hydrocarbylamino group having 2 to 14 carbon atoms such as dimethylamino group, diethylamino group, di-n-butylamino group, di-n-propylamino group, diisopropylamino group, dibenzylamino group or diphenylamino group, and preferably is dimethylamino group, diethylamino group, di-n-propylamino group, diisopropylamino group, or dibenzylamino group.

Examples of a substituted thiolate group of X include hydrocarbylthiolate groups having 6 to 12 carbon atoms such as thiophenoxy group, 2,3,4-trimethylthiophenoxy group, 2,3,5-trimethylthiophenoxy group, 2,3,6-trimethylthiophenoxy group, 2,4,6-trimethylthiophenoxy group, 3,4,5-trimethylthiophenoxy group, 2,3,4,5-tetramethylthiophenoxy group, 2,3,4,6-tetramethylthiophenoxy group, 2,3,5,6-tetramethylphenoxy group, pentamethylphenoxy group, 2-fluorothiophenoxy group, 3-fluorothiophenoxy group, 4-fluorophenoxy group, pentafluorothiophenoxy group, 2-trifluoromethylthiophenoxy group, 3-trifluoromethylthiophenoxy group, 4-trifluoromethylthiophenoxy group, 2,3-difluorothiophenoxy group, 2,4-fluorothiophenoxy group, 2,5-difluorothiophenoxy group, 2-chlorothiophenoxy group, 2,3-dichlorothiophenoxy group, 2,4-dichlorothiophenoxy group, 2,5-dichlorothiophenoxy group, 2-bromothiophenoxy group, 3-bromothiophenoxy group, 4-bromothiophenoxy group, 2,3-dibromothiophenoxy group, 2,4-dibromothiophenoxy group, or 2,5-dibromothiophenoxy group. Preferable examples are the thiophenoxy group, 2,4,6-trimethylthio phenoxy group, 3,4,5-trimethylthiophenoxy group, 2,3,4,5-tetramethylthiophenoxy group, 2,3,4,6-tetramethylthiophenoxy group, 2,3,5,6-tetramethylthiophenoxy group, pentamethylthiophenoxy group, and pentafluorothiophenoxy group.

Examples of a carboxylate group having 1 to 20 carbon atoms of X include acetate group, propionate group, butyrate group, pentanate group, hexanoate group, 2-ethylhexanoate group, or trifluoroacetate group.

Preferably, it is a hydrocarbylcarboxylate group having 2 to 10 carbon atoms, and more preferably is acetate group, propionate group, 2-ethylhexanoate group, or trifluoroacetate group.

Preferable examples of X² include a chlorine atom, methyl group, ethyl group, n-propyl group, isopropyl group, n-butyl group, methoxy group, ethoxy group, n-propoxy group, isopropoxy group, n-butoxy group, trifluoro methoxy group, phenyl group, phenoxy group, 2,6-di-tert-butylphenoxy group, 3,4,5-trifluorophenoxy group, pentafluorophenoxy group, 2,3,5,6-tetrafluoro-4-pentafluorophenylphenoxy group, or benzyl group.

The a′ in a formula (8) is a number which satisfies 1≦a′≦3, and is suitably selected according to a valence of M². When M² is a titanium atom, a zirconium atom, or a hafnium atom, it is preferable that a′ be 2.

Examples of the compound represented by the formula (8), in which a transition metal atom is a titanium atom include: dimethylsilylenebis(cyclopentadienyl)titaniumdichloride, dimethylsilylenebis(2-methylcyclopentadienyl)titaniumdichloride, dimethylsilylenebis(3-methylcyclopentadienyl)titaniumdichloride, dimethylsilylenebis(2-n-butylcyclopentadienyl)titaniumdichloride, dimethylsilylenebis(3-n-butylcyclopentadienyl)titaniumdichloride, dimethylsilylenebis(2,3-dimethylcyclopentadienyl)titaniumdichloride, dimethylsilylenebis(2,4-dimethylcyclopentadienyl)titaniumdichloride, dimethylsilylenebis(2,5-dimethylcyclopentadienyl)titaniumdichloride, dimethylsilylenebis(3,4-dimethylcyclopentadienyl)titaniumdichloride, dimethylsilylenebis(2,3-ethylmethylcyclopentadienyl)titaniumdichloride, dimethylsilylenebis(2,4-ethylmethylcyclopentadienyl)titaniumdichloride, dimethylsilylenebis(2,5-ethylmethylcyclopentadienyl)titaniumdichloride, dimethylsilylenebis(3,5-ethylmethylcyclopentadienyl)titaniumdichloride, dimethylsilylenebis(2,3,4-trimethylcyclopentadienyl)titaniumdichloride, dimethylsilylenebis(2,3,5-trimethylcyclopentadienyl)titaniumdichloride, and dimethylsilylenebis(tetramethylcyclopentadienyl)titanium dichloride, dimethylsilylenebis(indenyl)titaniumdichloride, dimethylsilylenebis(2-methylindenyl)titaniumdichloride, dimethylsilylenebis(2-tert-butylindenyl)titaniumdichloride, dimethylsilylenebis(2,3-dimethylindenyl)titaniumdichloride, dimethylsilylenebis(2,4,7-trimethylindenyl)titaniumdichloride, dimethylsilylenebis(2-methyl-4-isopropylindenyl)titaniumdichloride, dimethylsilylenebis(4,5-benzindenyl)titaniumdichloride, dimethylsilylenebis(2-methyl-4,5-benzindenyl)titaniumdichloride, dimethylsilylenebis(2-phenylindenyl)titaniumdichloride, dimethylsilylenebis(4-phenylindenyl)titaniumdichloride, dimethylsilylenebis(2-methyl-4-phenylindenyl)titanium dichloride, dimethylsilylenebis(2-methyl-5-phenylindenyl)titaniumdichloride, dimethylsilylenebis(2-methyl-4-naphthylindenyl)titaniumdichloride, and dimethylsilylenebis(4,5,6,7-tetrahydroindenyl)titaniumdichloride, dimethylsilylene(cyclopentadienyl)(indenyl)titaniumdichloride, dimethylsilylene(methylcyclopentadienyl)(indenyl)titaniumdichloride, dimethylsilylene(n-butylcyclopentadienyl)(indenyl)titaniumdichloride, dimethylsilylene(tetramethylcyclopentadienyl)(indenyl)titaniumdichloride, dimethylsilylene(cyclopentadienyl)(fluorenyl)titaniumdichloride, dimethylsilylene(methylcyclopentadienyl)(fluorenyl)titani umdichloride, dimethylsilylene(n-butylcyclopentadienyl)(fluorenyl)titaniumdichloride, dimethylsilylene(tetramethylcyclopentadienyl)(indenyl)tit aniumdichloride, dimethylsilylene(indenyl)(fluorenyl)titaniumdichloride, dimethylsilylenebis(fluorenyl)titanium dichloride, dimethylsilylene(cyclopentadienyl)(tetramethylcyclopenta dienyl)titaniumdichloride, and dimethylsilylene(tetramethylcyclopentadienyl)(fluorenyl)titaniumdichloride, dimethylsilylene(cyclopentadienyl) (2-phenoxyl)titaniumdichloride, dimethylsilylene(cyclopentadienyl)(3-methyl-2-phenoxyl)titaniumdichloride, dimethylsilylene(cyclopentadienyl)(3,5-dimethyl-2-phenoxyl)titaniumdichloride, dimethylsilylene(cyclopentadienyl)(3-tert-butyl-2-phenoxyl)titaniumdichloride, dimethylsilylene(cyclopentadienyl)(3-tert-butyl-5-methyl-2-phenoxyl)titaniumdichloride, dimethylsilylene(cyclopentadienyl)(3,5-di-tert-butyl-2-phenoxyl)titaniumdichloride, dimethylsilylene(cyclopentadienyl)(5-methyl-3-phenyl-2-phenoxyl)titaniumdichloride, dimethylsilylene(cyclopentadienyl)(3-tert-butyldimethylsilyl-5-methyl-2-phenoxyl)titaniumdichloride, dimethylsilylene(cyclopentadienyl)(5-methyl-3-trimethylsilyl-2-phenoxyl)titaniumdichloride, dimethylsilylene(cyclopentadienyl)(3-tert-butyl-5-methoxy-2-phenoxyl)titaniumdichloride, dimethylsilylene (cyclopentadienyl)(3-tert-butyl-5-chloro-2-phenoxyl)titaniumdichloride, dimethylsilylene(cyclopentadienyl)(3,5-diamyl-2-phenoxyl)titaniumdichloride, dimethylsilylene(cyclopentadienyl)(3-phenyl-2-phenoxyl)titaniumdichloride, and dimethylsilylene(cyclopentadienyl)(1-naphthoxy-2-yl)titaniumdichloride, dimethylsilylene(methylcyclopentadienyl)(2-phenoxyl)titaniumdichloride, dimethylsilylene(methylcyclopentadienyl)(3-methyl-2-phenoxyl)titaniumdichloride, dimethylsilylene(methylcyclopentadienyl)(3,5-dimethyl-2-phenoxyl)titaniumdichloride, dimethylsilylene(methylcyclopentadienyl)(3-tert-butyl-2-phenoxyl)titaniumdichloride, dimethylsilylene(methylcyclopentadienyl)(3-tert-butyl-5-methyl-2-phenoxyl)titaniumdichloride, dimethylsilylene(methylcyclopentadienyl)(3,5-di-tert-butyl-2-phenoxyl)titaniumdichloride, dimethylsilylene(methylcyclopentadienyl)(5-methyl-3-phenyl-2-phenoxyl)titaniumdichloride, dimethylsilylene(methylcyclopentadienyl)(3-tert-butyldimethylsilyl-5-methyl-2-phenoxyl)titaniumdichloride, dimethylsilylene(methylcyclopentadienyl)(5-methyl-3-trimethylsilyl-2-phenoxyl)titaniumdichloride, dimethylsilylene(methylcyclopentadienyl)(3-tert-butyl-5-methoxy-2-phenoxyl)titaniumdichloride, dimethylsilylene(methylcyclopentadienyl)(3-tert-butyl-5-chloro-2-phenoxyl)titaniumdichloride, dimethylsilylene(methylcyclopentadienyl)(3,5-diamyl-2-phenoxyl)titaniumdichloride, dimethylsilylene(methylcyclopentadienyl)(3-phenyl-2-phenoxyl)titaniumdichloride, and dimethylsilylene(methylcyclopentadienyl)(1-naphthoxy-2-yl)titaniumdichloride, dimethylsilylene(n-butylcyclopentadienyl)(2-phenoxyl)titaniumdichloride, dimethylsilylene(n-butylcyclopentadienyl)(3-methyl-2-phenoxyl)titanium dichloride, dimethylsilylene(n-butylcyclopentadienyl)(3,5-dimethyl-2-phenoxyl)titaniumdichloride, dimethylsilylene(n-butylcyclopentadienyl)(3-tert-butyl-2-phenoxyl)titaniumdichloride, dimethylsilylene(n-butylcyclopentadienyl)(3-tert-butyl-5-methyl-2-phenoxyl)titaniumdichloride, dimethylsilylene(n-butyl cyclopentadienyl)(3,5-di-tert-butyl-2-phenoxyl)titaniumdichloride, dimethylsilylene(n-butylcyclopentadienyl)(5-methyl-3-phenyl-2-phenoxyl)titaniumdichloride, dimethylsilylene(n-butylcyclopentadienyl)(3-tert-butyldimethylsilyl-5-methyl-2-phenoxyl)titaniumdichloride, dimethylsilylene(n-butylcyclopentadienyl)(5-methyl-3-trimethylsilyl-2-phenoxyl)titaniumdichloride, dimethylsilylene(n-butylcyclopentadienyl)(3-tert-butyl-5-methoxy-2-phenoxyl)titaniumdichloride, dimethylsilylene(n-butylcyclopentadienyl)(3-tert-butyl-5-chloro-2-phenoxyl)titaniumdichloride, dimethylsilylene(n-butylcyclopentadienyl)(3,5-diamyl-2-phenoxyl)titaniumdichloride, dimethylsilylene(n-butylcyclopentadienyl)(3-phenyl-2-phenoxyl)titaniumdichloride, and dimethylsilylene(n-butylcyclopentadienyl)(1-naphthoxy-2-yl)titaniumdichloride, dimethylsilylene(tert-butylcyclopentadienyl)(2-phenoxyl)titaniumdichloride, dimethylsilylene(tert-butylcyclopentadienyl)(3-methyl-2-phenoxyl)titaniumdichloride, dimethylsilylene(tert-butylcyclopentadienyl)(3,5-dimethyl-2-phenoxyl)titaniumdichloride, dimethylsilylene(tert-butylcyclopentadienyl)(3-tert-butyl-2-phenoxyl)titaniumdichloride, dimethylsilylene(tert-butylcyclopentadienyl)(3-tert-butyl-5-methyl-2-phenoxyl)titaniumdichloride, dimethylsilylene(tert-butylcyclopentadienyl)(3,5-di-tert-butyl-2-phenoxyl)titaniumdichloride, dimethylsilylene(tert-butylcyclopentadienyl)(5-methyl-3-phenyl-2-phenoxyl)titaniumdichloride, dimethylsilylene(tert-butylcyclopentadienyl)(3-tert-butyldimethylsilyl-5-methyl-2-phenoxyl)titaniumdichloride, dimethylsilylene(tert-butylcyclopentadienyl)(5-methyl-3-trimethylsilyl-2-phenoxyl)titaniumdichloride, dimethylsilylene(tert-butylcyclopentadienyl)(3-tert-butyl-5-methoxy-2-phenoxyl)titaniumdichloride, dimethylsilylene(tert-butylcyclopentadienyl)(3-tert-butyl-5-chloro-2-phenoxyl)titaniumdichloride, dimethylsilylene(tert-butylcyclopentadienyl)(3,5-diamyl-2-phenoxyl)titaniumdichloride, dimethylsilylene(tert-butylcyclopentadienyl)(3-phenyl-2-phenoxyl)titaniumdichloride, and dimethylsilylene(tert-butylcyclopentadienyl)(1-naphthoxy-2-yl)titaniumdichloride, dimethylsilylene(tetramethylcyclopentadienyl)(2-phenoxyl)titaniumdichloride, dimethylsilylene(tetramethylcyclopentadienyl)(3-methyl-2-phenoxyl)titaniumdichloride, dimethylsilylene(tetramethylcyclopentadienyl)(3,5-dimethyl-2-phenoxyl)titaniumdichloride, dimethylsilylene(tetramethylcyclopentadienyl)(3-tert-butyl-2-phenoxyl)titaniumdichloride, dimethylsilylene(tetramethylcyclopentadienyl)(3-tert-butyl-5-methyl-2-phenoxyl)titaniumdichloride, dimethylsilylene(tetramethylcyclopentadienyl)(3,5-di-tert-butyl-2-phenoxyl)titaniumdichloride, dimethylsilylene(tetramethylcyclopentadienyl)(5-methyl-3-phenyl-2-phenoxyl)titaniumdichloride, dimethylsilylene(tetramethylcyclopentadienyl)(3-tert-butyldimethylsilyl-5-methyl-2-phenoxyl)titaniumdichloride, dimethylsilylene(tetramethylcyclopentadienyl)(5-methyl-3-trimethylsilyl-2-phenoxyl)titaniumdichloride, dimethylsilylene(tetramethylcyclopentadienyl)(3-tert-butyl-5-methoxy-2-phenoxyl)titaniumdichloride, dimethylsilylene(tetramethylcyclopentadienyl)(3-tert-butyl-5-chloro-2-phenoxyl)titaniumdichloride, dimethylsilylene(tetramethylcyclopentadienyl)(3,5-diamyl-2-phenoxyl)titaniumdichloride, dimethylsilylene(tetramethylcyclopentadienyl)(3-phenyl-2-phenoxyl)titaniumdichloride, and dimethylsilylene(tetramethylcyclopentadienyl)(1-naphthoxy-2-yl)titaniumdichloride, dimethylsilylene(trimethylsilylcyclopentadienyl)(2-phenoxyl)titaniumdichloride, dimethylsilylene(trimethylsilylcyclopentadienyl)(3-methyl-2-phenoxyl)titaniumdichloride, dimethylsilylene(trimethylsilylcyclopentadienyl)(3,5-dimethyl-2-phenoxyl)titaniumdichloride, dimethylsilylene(trimethylsilylcyclopentadienyl)(3-tert-butyl-2-phenoxyl)titaniumdichloride, dimethylsilylene(trimethylsilylcyclopentadienyl)(3-tert-butyl-5-methyl-2-phenoxyl)titaniumdichloride, dimethylsilylene(trimethylsilylcyclopentadienyl)(3,5-di-tert-butyl-2-phenoxyl)titaniumdichloride, dimethylsilylene(trimethylsilylcyclopentadienyl)(5-methyl-3-phenyl-2-phenoxyl)titaniumdichloride, dimethylsilylene(trimethylsilylcyclopentadienyl)(3-tert-butyldimethylsilyl-5-methyl-2-phenoxyl)titaniumdichloride, dimethylsilylene(trimethylsilylcyclopentadienyl)(5-methyl-3-trimethylsilyl-2-phenoxyl)titaniumdichloride, dimethylsilylene(trimethylsilylcyclopentadienyl)(3-tert-butyl-5-methoxy-2-phenoxyl)titaniumdichloride, dimethylsilylene(trimethylsilylcyclopentadienyl)(3-tert-butyl-5-chloro-2-phenoxyl)titaniumdichloride, dimethylsilylene (trimethylsilylcyclopentadienyl)(3,5-diamyl-2-phenoxyl)titaniumdichloride, dimethylsilylene(trimethylsilylcyclopentadienyl)(3-phenyl-2-phenoxyl)titaniumdichloride, and dimethylsilylene(trimethylsilylcyclopentadienyl)(1-naphthoxy-2-yl)titaniumdichloride, dimethylsilylene(indenyl)(2-phenoxyl)titaniumdichloride, dimethylsilylene(indenyl)(3-methyl-2-phenoxyl)titaniumdichloride, dimethylsilylene(indenyl)(3,5-dimethyl-2-phenoxyl)titaniumdichloride, dimethylsilylene(indenyl)(3-tert-butyl-2-phenoxyl)titaniumdichloride, dimethylsilylene(indenyl)(3-tert-butyl-5-methyl-2-phenoxyl)titaniumdichloride, dimethylsilylene(indenyl)(3,5-di-tert-butyl-2-phenoxyl)titaniumdichloride, dimethylsilylene(indenyl)(5-methyl-3-phenyl-2-phenoxyl)titaniumdichloride, dimethylsilylene(indenyl)(3-tert-butyldimethylsilyl-5-methyl-2-phenoxyl)titaniumdichloride, dimethylsilylene(indenyl)(5-methyl-3-trimethylsilyl-2-phenoxyl)titaniumdichloride, dimethylsilylene(indenyl)(3-tert-butyl-5-methoxy-2-phenoxyl)titaniumdichloride, dimethylsilylene(indenyl)(3-tert-butyl-5-chloro-2-phenoxyl)titaniumdichloride, dimethylsilylene(indenyl)(3,5-diamyl-2-phenoxyl)titaniumdichloride, dimethylsilylene(indenyl)(3-phenyl-2-phenoxyl)titaniumdichloride, and dimethylsilylene(indenyl)(1-naphthoxy-2-yl)titaniumdichloride, dimethylsilylene(fluorenyl)(2-phenoxyl)titaniumdichloride, dimethylsilylene(fluorenyl)(3-methyl-2-phenoxyl)titaniumdichloride, dimethylsilylene(fluorenyl)(3,5-dimethyl-2-phenoxyl)titaniumdichloride, dimethylsilylene(fluorenyl)(3-tert-butyl-2-phenoxyl)titaniumdichloride, dimethylsilylene(fluorenyl)(3-tert-butyl-5-methyl-2-phenoxyl)titaniumdichloride, dimethylsilylene(fluorenyl)(3,5-di-tert-butyl-2-phenoxyl)titaniumdichloride, dimethylsilylene(fluorenyl)(5-methyl-3-phenyl-2-phenoxyl)titaniumdichloride, dimethylsilylene(fluorenyl)(3-tert-butyldimethylsilyl-5-methyl-2-phenoxyl)titaniumdichloride, dimethylsilylene(fluorenyl)(5-methyl-3-trimethylsilyl-2-phenoxyl)titaniumdichloride, dimethylsilylene(fluorenyl)(3-tert-butyl-5-methoxy-2-phenoxyl)titaniumdichloride, dimethylsilylene(fluorenyl)(3-tert-butyl-5-chloro-2-phenoxyl)titaniumdichloride, dimethylsilylene(fluorenyl)(3,5-diamyl-2-phenoxyl)titaniumdichloride, dimethylsilylene(fluorenyl)(3-phenyl-2-phenoxyl)titaniumdichloride, and dimethylsilylene(fluorenyl)(1-naphthoxy-2-yl)titaniumdichloride, (tert-butylamide)tetramethylcyclopentadienyl-1,2-ethanediyltitaniumdichloride, (methylamide)tetramethylcyclopentadienyl-1,2-ethanediyltitaniumdichloride, (ethylamide)tetramethylcyclopentadienyl-1,2-ethanediyltitaniumdichloride, (tert-butylamide)tetramethylcyclopentadienyldimethylsilanetitaniumdichloride, (benzylamide)tetramethylcyclopentadienyldimethylsilanetitaniumdichloride, (phenylphosphide)tetramethylcyclopentadienyldimethylsi lanetitaniumdichloride, (tert-butylamide)indenyl-1,2-ethanediyltitaniumdichloride, (tert-butylamide)tetrahydroindenyl-1,2-ethanediyltitaniumdichloride, (tert-butylamide)fluorenyl-1,2-ethanediyltitaniumdichloride, (tert-butylamide)indenyldimethylsilanetitaniumdichloride, (tert-butylamide)tetrahydroindenyldimethylsilanetitaniumdichloride, and (tert-butylamide)fluorenyldimethylsilanetitaniumdichloride.

Moreover, the examples of the transition metal compound represented by formula (8) encompass compounds in which “titanium” in the above-mentioned compound is substituted with “zirconium” or “hafnium”, compounds in which “(2-phenoxyl)” is substituted with “(3-phenyl-2-phenoxyl)”, “(3-trimethylsilyl-2-phenoxyl)” or “(3-tert-butyldimethylsilyl-2-phenoxyl)”, compounds in which “dimethylsilylene” is substituted with “methylene”, “ethylene”, “dimethylmethylene(isopropylidene)”, “diphenylmethylene”, “diethylsilylene”, “diphenylsilylene”, or “dimethoxysilylene”, and compounds in which “dichloride” is substituted with “difluoride”, “dibromide”, “diiodide”, “dimethyl”, “diethyl”, “diisopropyl”, “diphenyl”, “dibenzyl”, “dimethoxide”, “diethoxide”, “di(n-propoxide)”, “di(isopropoxide)”, “diphenoxide”, or “di(pentafluorophenoxide)”.

One or more transition metal compound represented by formula (8) may be used as the substance (A2).

As the substance (A2) for use in the present invention, a compound wherein M² in formula (8) is zirconium is preferred, or, in particular, a zirconium compound wherein Z in formula (8) is a group having a cyclopentadienide skeleton and Q is an alkylene group, a substituted alkylene group, or a substituted silylene group is preferred.

The transition metal compound represented by formula (8) can be produced by any of the production methods described in Japanese Patent Application Publication, Tokukaihei, No. 6-340684, Japanese Patent Application Publication, Tokukaihei, No. 7-258321, and International Publication No. 95/00562, etc.

Activating Agent (B)

The activating agent (B) is not particularly limited as long as it activates the substance (A1) and the substance (A2) so that they can polymerize olefin monomers. Examples of the activating agent (B) include at least one type of compound selected from the group consisting of an organoaluminum compound (B-1) and a boron compound (B-2).

The organoaluminum compound (B-1) may be a publicly known compound or, more preferably, a compound represented by any of the following formulae or a mixture thereof:
(1) a compound represented by E¹ₐ AlY¹₃₋ₐ (hereinafter, may be referred to as an organoaluminum compound (B-1-1));
(2) a cyclic aluminoxane represented by {—Al(E²)-O-}_{b} (hereinafter, may be referred to as an organoaluminum compound (B-1-2)); and
(3) a linear aluminoxane represented by E³{—Al(E³)—O—}_{c}AlE³₂ (hereinafter, may be referred to as an organoaluminum compound (B-1-3)),
   where E¹, E², and E³ are each a hydrocarbyl group having 1 to 8 carbon atoms, all E₁ groups, E² groups, and E³ groups are the same or different, Y¹ represents a hydrogen atom or a halogen atom, all Y¹ groups are the same or different, a represents a number satisfying 0<a≦3, b represents an integer of 2 or greater, and c represents an integer of 1 or greater.

Examples of the organoaluminum compound (B-1-1) include trialkylaluminum such as trimethylaluminum, triethylaluminum, tripropylaluminum, triisobutylaluminum, and trihexylaluminum; dialkylaluminumchloride such as dimethylaluminumchloride, diethylaluminumchloride, dipropylaluminumchloride, diisobutylaluminumchloride, and dihexylaluminumchloride; alkylaluminumdichloride such as methylaluminumdichloride, ethylaluminumdichloride, propylaluminumdichloride, isobutylaluminumdichloride, and hexylaluminumdichloride; and dialkylaluminumhydride such as dimethylaluminumhydride, diethylaluminumhydride, dipropylaluminumhydride, diisobutylaluminumhydride, and dihexylaluminumhydride. Among them, trialkylaluminum is preferable, and triethylaluminum or triisobutylaluminum is more preferable.

Examples of E² and E³ in the above formula are alkyl groups such as methyl group, ethyl group, n-propyl group, isopropyl group, n-butyl group, isobutyl group, n-penthyl group, and neopenthyl group. Among them, methyl group or isobutyl group is preferable. b is an integer of 2 or more, and preferably an integer of 2 to 40. c is an integer of 1 or more, and preferably an integer of 1 to 40.

The method for producing aluminoxane is not particularly limited, and may be a publicly known method. Examples of the method include a method in which trialkylaluminum (e.g. trimethylaluminum) is dissolved in a suitable organic solution (e.g. benzene or aliphatichydrocarbyl) and the resulting solution is brought into contact with water, and a method in which trialkylaluminum (e.g. trimethylaluminum) is brought into contact with a metal salt containing water of crystallization (e.g. copper sulphate hydrate).

Examples of the above-mentioned boron compound (B-2) include:

(1) boron compound represented by formula BR¹³R¹⁴R¹⁵ (hereinafter, may be referred to as a boron compound (B-2-1));
(2) boron compound represented by formula M³⁺(BR¹³R¹⁴R¹⁵R¹⁶)⁻ (hereinafter, may be referred to as a boron compound (B-2-2)); and
(3) boron compound represented by formula (M⁴-H)⁺(BR¹³R¹⁴R¹⁵R¹⁶)⁻ (hereinafter, may be referred to as a boron compound (B-2-3));
wherein R¹³ to R¹⁶ are independently a halogen atom, a hydrocarbyl group having 1 to 20 carbon atoms, a halogenated hydrocarbyl group having 1 to 20 carbon atoms, a substituted silyl group having 1 to 20 carbon atoms, an alkoxy group having 1 to 20 carbon atoms, or a di-substituted amino group having 2 to 20 carbon atoms, and R¹³ to R¹⁶ are the same or different, and preferably a halogen atom, a hydrocarbyl group having 1 to 20 carbon atoms, or a halogenated hydrocarbyl group having 1 to 20 carbon atoms, and M³⁺ is an inorganic or organic cation, M⁴ is a neutral Lewis base, and (M⁴-H)⁺ is a Bronsted acid.

Examples of the compound represented by the formula (1) include tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, phenylbis(pentafluorophenyl)borane. Among them, tris(pentafluorophenyl)borane is most preferable.

Examples of M³⁺ in the formula (2) include ferrocenium cation, alkyl substituted ferrocenium cation, silver cation, and triphenylmethyl cation. Examples of (BR¹³R¹⁴R¹⁵R¹⁶)⁻ in the formula (2) include tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl)borate, phenylbis(pentafluorophenyl)borate, and tetrakis(3,5-bistrifluoromethylphenyl)borate. Examples of the compound in the formula (2) include ferroceniumtetrakis(pentafluorophenyl)borate, 1,1′-dimethylferroceniumtetrakis(pentafluoropenyl)borate, silvertetrakis(pentafluorophenyl)borate, triphenylmethyltetrakis(pentafluorophenyl)borate, and triphenylmethyltetrakis(3,5-bistrifluoromethylphenyl)borate. Among them, triphenylmethyltetrakis(pentafluorophenyl)borate is most preferable.

Examples of (M⁴-H)⁺ in the formula (3) include trialkyl substituted ammonium, N,N-dialkylanilinium, dialkylammonium, and triarylphosphonium. Examples of (BR¹³R¹⁴R¹⁵R¹⁶)⁻ in the formula (3) are the same as above. Examples of the formula (3) include triethylammoniumtetrakis(pentafluorophenyl)borate, tripropylammoniumtetrakis(pentafluorophenyl)borate, tri(n-butyl)ammoniumtetrakis(pentafluorophenyl)borate, tri(n-butyl)ammoniumtetrakis(3,5-bistrifluoromethylphenyl)borate, N,N-dimethylaniliniumtetrakis(pentafluorophenyl)borate, N,N-diethylaniliniumtetrakis(pentafluorophenyl)borate, N,N-2,4,6-pentamethylaniliniumtetrakis(pentafluorophenyl)borate, N,N-dimethylaniliniumtetrakis(3,5-bistrifluoromethylphenyl)borate, diisopropylammoniumtetrakis(pentafluorophenyl)borate, dicyclohexylammoniumtetrakis(pentafluorophenyl)borate, triphenylphosphoniumtetrakis(pentafluorophenyl)borate, tri(methylphenyl)phosphoniumtetrakis(pentafluorophenyl)borate, and tri(dimethylphenyl)phosphoniumtetrakis(pentafluorophenyl)borate. Among them, tri(n-butyl)ammoniumtetrakis(pentafluorophenyl)borate or N,N-dimethylaniliniumtetrakis(pentafluorophenyl)borate is most preferable.

The activating agent (B) is preferably the organoaluminum compound (B-1-2), the organoaluminum compound (B-1-3), a combination of the organoaluminum compound (B-1-2) and the organoaluminum compound (B-1-3), or a combination of the organoaluminum compound (B-1-1) and a boron compound.

In a case where the polymerization catalyst according to the present invention is applied to polymerization, such as slurry polymerization, vapor phase polymerization, or bulk polymerization, which involves the formation of particles of a polymer, modified particles obtained by bringing an aluminoxane (a) and particles (b) into contact with each other is suitably used as the activating agent (B), for example.

Such an aluminoxane (a) is preferably the organoaluminum compound (B-1-2), the organoaluminum compound (B-1-3), or a mixture of the organoaluminum compound (B-1-2) and the organoaluminum compound (B-1-3).

There is no particular limit on the method for bringing the aluminoxane (a) and the particles (b) into contact with each other. An example of such a method is a method in which the aluminoxane (a) is added into a solvent in which the particles (b) have been dispersed. An example of such a solvent may be any of the solvents as mentioned above, and is preferably a solvent that is not reactive with the aluminoxane (a), or is more preferably a solvent in which the aluminoxane (a) can dissolve. The solvent is preferably an aromatic hydrocarbyl solvent such as benzene, toluene, or xylene or an aliphatic hydrocarbyl solvent such as hexane, heptane, or octane, or is more preferably toluene or xylene.

There is no particular limit on the temperature at or the duration for which the aluminoxane (a) and the particles (b) are in contact. The temperature normally ranges from −100° C. to 200° C., preferably ranges from −50° C. to 150° C., or more preferably ranges from −20° C. to 120° C. In particular, for the purpose of suppressing the generation of heat by the reaction, it is preferable that the aluminoxane (a) and the particles (b) be in contact at a low temperature in the early stage of contact. There is no particular limit on the amounts in which the aluminoxane (a) and the particles (b) are used. The aluminoxane (a) is normally used in an amount of 0.01 to 100 mmol, preferably used in an amount of 0.1 to 20 mmol, or more preferably used in an amount of 1 to 10 mmol per unit gram of the particles (b) in terms of aluminum atoms contained in the aluminoxane used.

Other suitable examples of the modified particles include modified particles described in Japanese Patent Application Publication, Tokukai, No. 2003-171412, those described in Japanese Patent Application Publication, Tokukai, No. 2003-171413, those described in Japanese Patent Application Publication, Tokukai, No. 2005-126627, those described in Japanese Patent Application Publication, Tokukai, No. 2005-126628, those described in Japanese Patent Application Publication, Tokukai, No. 2007-269997, those described in Japanese Patent Application Publication, Tokukai, No. 2012-31154, and those described in Japanese Patent Application Publication, Tokukai, No. 2012-31397.

Method for Producing an Olefin Polymer

The present invention is directed to a method for producing an olefin polymer by polymerizing olefin monomers using the substance (A1), the substance (A2), and the activating agent (B). For example, in the method, a catalyst is formed by bringing the substance (A1), the substance (A2), and the activating agent (B) into contact with each other, and olefin polymerization is performed with use of the catalyst.

The substance (A1), the substance (A2), and the substance (B) may be brought into contact with each other by any means, provided that a catalyst is formed as a result of contacting the substance (A1), the substance (A2), and the substance (B) with each other. Examples of the method include a method in which the substance (A1), the substance (A2), and the substance (B) are brought into contact with each other by mixing the substance (A1), the substance (A2), and the substance (B) together with or without dilution of each substance or a method in which the substance (A1), the substance (A2), and the substance (B) are separately fed into a polymerization tank and brought into contact with each other in the polymerization tank. Where one or more substances (B) are used in combination, some of the substances (B) may be mixed in advance, or each substance (B) may be fed separately into the polymerization tank.

The molar ratio of the substance (A1) to the substance (A2) is not particularly limited, but is preferably from 0.01 to 100, more preferably from 0.05 to 50, even more preferably from 0.1 to 20, or especially preferably from 0.15 to 10.

In a case where the organoaluminum compound (B-1) is used as the substance (B), the molar ratio of the organoaluminum compound (B-1) to the total amount of the substance (A1) and the substance (A2) used is from 0.01 to 10000, or preferably from 1 to 5000. In a case where the boron compound (B-2) is used as the substance (B), the molar ratio of the boron compound (B-2) to the total amount of the substance (A1) and substance (A2) used is from 0.01 to 100, or preferably from 1.0 to 50.

In a case where the catalyst is produced prior to polymerization reaction in the polymerization tank, the concentration of each substance in a case where it is fed in a solution state or while being suspended or slurried in a solvent is appropriately selected depending on conditions such as the performance of an apparatus that feeds that substance.

Generally, the total concentration of the substance (A1) and the substance (A2) is normally 0.0001 to 10000 mol/L, more preferably 0.001 to 1000 mol/L, or even more preferably 0.01 to 100 mol/L. The concentration of the organic aluminum compound (B-1) is normally 0.01 to 10000 mol/L, more preferably 0.05 to 5000 mol/L, or even more preferably 0.1 to 2000 mol/L in terms of A1 atoms. The concentration of the boron compound (B-2) is normally 0.001 to 500 mol/L, more preferably 0.01 to 250 mol/L, or even more preferably 0.05 to 100 mol/L.

When the substance (A1), the substance (A2), and the organoaluminum compound (B-1) are brought into contact with each other, the organoaluminum compound (B-1) is preferably the cyclic aluminoxane (B-1-2), the linear aluminoxane (B-1-3), or a mixture of the cyclic aluminoxane (B-1-2) and the linear aluminoxane (B-1-3).

Alternatively, when the substance (A1), the substance (A2), the organoaluminum compound (B-1), and the boron compound (B-2) are brought into contact with each other, the organoaluminum compound (B-1) is preferably the organoaluminum compound (B-1-1) and the boron compound (B-2) is preferably the boron compound (B-2-1) or the boron compound (B-2-2).

The method for producing an olefin polymer according to the present invention is a method for homopolymerizing or copolymerizing olefin monomers having 2 to 20 carbon atoms using the substance (A1), the substance (A2), and the activating agent (B).

One olefin monomer may be polymerized or one or more olefin monomers may be polymerized. Polymerizing one olefin monomer provides a homopolymer, and polymerizing one or more olefin monomers provides a copolymer. Examples of the combination of olefin monomers used for copolymerization include combinations of ethylene and an α-olefin having 3 to 20 carbon atoms such as a combination of ethylene and propylene, a combination of ethylene and 1-butene, a combination of ethylene and 1-hexene, a combination of ethylene, 1-butene, and 1-hexene.

Examples of the olefin include 1-alkenes having 1 to 20 carbon atoms (which may be branched) such as ethylene, propylene, 1-butene, 1-pentene, 1-hexene, 4-methyl-1-pentene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, and 1-eicosene, and cycloalkenes such as cyclopentene, cyclohexene, 5-methylnorbornene, 5-ethylnorbornene, 5-butylnorbornene, 5-phenylnorbornene, 5-benzylnorbornene, tetracyclododecene, tricyclodecene, tricycloundecene, pentacyclopentadecene, pentacyclohexadecene, 8-methyltetracyclododecene, 8-ethyltetracyclododecene, 5-acetylnorbornene, 5-acetyloxynorbornene, 5-methoxycarbonylnorbornene, 5-ethoxycarbonylnorbornene, 5-methyl-5-methoxycarbonylnorbornene, 5-cyanonorbornene, 8-methoxycarbonyltetracyclododecene, 8-methyl-8-tetracyclododecene, and 8-cyanotetracyclododecene.

Preferable examples of the olefin include ethylene, propylene, 1-butene, 1-pentene, 1-hexene, 1-heptene, 1-octene, 1-nonene, 1-decene, and 4-methyl-1-pentene. More preferable examples include ethylene, propylene, 1-butene, 1-pentene, 1-hexene, 1-octene, 1-decene, and 4-methyl-1-pentene. Still more preferable examples of the olefin include ethylene, propylene, 1-butene, 1-hexene, and 4-methyl-1-pentene.

Examples of the polymerization method include: solvent polymerization that uses as the solvent an aliphatic hydrocarbon such as butane, pentane, hexane, heptane, octane etc., an aromatic hydrocarbon such as toluene, or a halogenated hydrocarbon such as methylenedichloride; slurry polymerization; gas phase polymerization; and bulk polymerization. A gas phase polymerization reaction device used in the gas phase polymerization is typically a device having a fluidized bed reaction tank, and is preferably a device having a fluidized bed reaction tank that has an enlarged section. An agitating element may be disposed inside the reaction tank. Any one of the continuous polymerization or batch polymerization can be performed.

The temperature and time of the polymerization reaction may be determined in consideration of a desirable polymerization average molecular weight and an activity and amount used of the catalyst. The polymerization temperature is typically in a range of −50° C. to 200° C. In particular, the polymerization temperature is preferably in a range of −20° C. to 100° C., and a polymerization pressure is typically preferably in a range of normal pressure to 50 MPa. A polymerization time is typically determined as appropriate depending on the object kind of polymer and a reaction device, and is usually in a range of 1 minute to 20 hours, preferably in a range of 5 minutes to 18 hours. However, there is no intention to limit the polymerization temperature, the polymerization pressure, and the polymerization time to these ranges. Moreover, in the present invention, a chain transfer agent such as hydrogen or the like can be added, to adjust the polymer molecular weight.

When a solvent is used in the polymerization reaction, concentration of each compound in the solvent is not limited in particular. A total concentration of the substance (A1) and the substance (A2) in the solvent, for example, may be selected in a range of 1×10⁻⁸ mmol/L to 10 mol/L, and a concentration of the activating agent (B) can be selected from, for example, a range of 1×10⁻⁸ mmol/L to 10 mol/L. Moreover, an olefin:solvent ratio can be selected in the range of 100:0 to 1:1000 by volume ratio. However, these ranges are merely exemplifications, and do not intend to limited the ranges to any of these. In a case in which no solvent is used, it is possible to set the concentration as appropriate with reference to the foregoing ranges.

A production method of the present invention is not limited in particular as long as the substance (A1), the substance (A2), and the activating agent (B) are used to polymerize olefin monomers. However, a preferable method is a multistage polymerization method including the steps of: polymerizing olefin monomers in the presence of a catalyst obtained by having the substance (A1) be in contact with the activating agent (B) (former stage); and supplying the substance (A2) into a polymerization tank in the presence of a polymer obtained in the former step, to polymerize olefin monomers (latter stage).

A molar ratio ((A1)/(A2)) in the multistage polymerization method, of substance (A1) used in the former stage and substance (A2) used in the latter stage, is not limited in particular. However, this is preferably 0.05 to 10, and is more preferably 0.1 to 5.

It is preferable that olefin monomers polymerized in the former stage of the multistage polymerization method is solely ethylene, or is a combination of ethylene and propylene, ethylene and 1-butene, ethylene and 1-hexene, or ethylene and 1-butene and 1-hexene. It is preferable that olefin monomers polymerized in the latter stage is solely ethylene, or a combination of ethylene and propylene, ethylene and 1-butene, ethylene and 1-hexene, or ethylene and 1-butene and 1-hexene.

The polymerization time of the former stage of the multistage polymerization method is not limited in particular, however is preferably not less than 5 minutes, more preferably not less than 10 minutes, and further preferably not less than 20 minutes.

An olefin partial pressure during polymerization of the former stage of the multistage polymerization method is not limited in particular, however is preferably not less than 0.2 MPa, more preferably not less than 0.4 MPa, and further preferably not less than 0.6 MPa. The olefin partial pressure during polymerization of the latter stage of the multistage polymerization method is not limited in particular, however is preferably not less than 0.05 MPa, more preferably not less than 0.1 MPa, and further preferably not less than 0.2 MPa. It is preferable that the olefin partial pressure during polymerization in the former stage of the multistage polymerization method is equal to or greater than the olefin partial pressure during polymerization in the latter stage of the multistage polymerization method.

Ethylene-Based Polymer

An ethylene-based polymer of the present invention is an ethylene-based polymer including: a monomer unit based on ethylene; and optionally a monomer unit based on an α-olefin having 3 to 20 carbon atoms. The α-olefin include propylene, 1-butene, 1-pentene, 1-hexene, 1-heptane, 1-octene, 1-nonene, 1-decene, 1-dodecene, 4-methyl-1-pentene, 4-methyl-1-hexene, etc., and these may be used solely or two or more α-olefins may be used in combination. The α-olefin is preferably, 1-butene, 1-hexene, 4-methyl-1-pentene, or 1-octene.

The content of the monomer unit based on ethylene in the ethylene-based polymer of the present invention is typically 50 to 100 wt % with respect to a whole weight (100 wt %) of the ethylene-based polymer. Moreover, the content of the monomer unit based on α-olefin is typically 0 to 50 wt % with respect to the whole weight (100 wt %) of the ethylene-based polymer.

It is preferable that the ethylene-based polymer of the present invention is an ethylene homopolymer, or an ethylene-α-olefin copolymer having a monomer unit based on ethylene and a monomer unit based on an α-olefin having 4 to 20 carbon atoms, more preferably is an ethylene homopolymer or an ethylene-α-olefin copolymer having a monomer unit based on ethylene and a monomer unit based on an α-olefin having 5 to 20 carbon atoms, and further preferably is an ethylene homopolymer or an ethylene-α-olefin copolymer having a monomer unit based on ethylene and a monomer unit based on an α-olefin having 6 to 8 carbon atoms.

The ethylene-based polymer of the present invention includes, for example, an ethylene homopolymer, an ethylene-1-butene copolymer, an ethylene-1-hexene copolymer, an ethylene-4-methyl-1-pentene copolymer, an ethylene-1-octene copolymer, an ethylene-1-butene-1-hexene copolymer, an ethylene-1-butene-4-methyl-1-pentene copolymer, an ethylene-1-butene-1-octene copolymer, an ethylene-1-hexene-1-octene copolymer, etc., and preferably is an ethylene homopolymer, an ethylene-1-hexene copolymer, an ethylene-4-methyl-1-pentene copolymer, an ethylene-1-butene-1-hexene copolymer, an ethylene-1-butene-1-octene copolymer, or an ethylene-1-hexene-1-octene copolymer.

The ethylene-based polymer of the present invention satisfies the following requirements (1) to (5):

(1) the density is 850 to 980 kg/m³;
(2) the melt flow rate is within the range of 0.01 to 100 g/10 min, where the melt flow rate is measured by method A provided in JIS K7210-1995 at a temperature of 190° C. under an applied load of 21.18 N;
(3) the molecular weight distribution curve measured by gel permeation chromatography has bimodal molecular weight distribution, the molecular weight distribution curve exhibiting a higher molecular weight peak having a peak top molecular weight of 50,000 or more, and a lower molecular weight peak having a peak top molecular weight of 10,000 or less;
(4) the weight-average molecular weight to number-average molecular weight ratio is from 4 to 55; and
(5) the number of branches having 5 or more carbon atoms measured by ¹³C-NMR is 0.2 to 0.7 per 1000 carbon atoms.

The density of the ethylene-based polymer is 850 to 980 kg/m³, and in terms of improving rigidity of the obtained article, it is preferably not less than 900 kg/m³, more preferably not less than 920 kg/m³, further preferably not less than 940 kg/m³, and particularly preferably not less than 950 kg/m³. In terms of improving mechanical strength of the obtained article, the density of the ethylene-based polymer is preferably not more than 970 kg/m³.

The density is measured in line with the method defined in method A out of methods disclosed in JIS K7112-1980, after carrying out annealing disclosed in JIS K6760-1995. The density of the ethylene-based polymer can be reduced by increasing a proportion of the fed amount of α-olefin with respect to ethylene. The density of the ethylene-based polymer can be reduced by increasing the proportion of used amount of the substance (A1) with respect to the substance (A2).

The meltflow rate of the ethylene-based polymer is 0.01 to 100 g/10 min. In terms of improving moldability, particularly to reduce extruding load, the melt flow rate is preferably not less than 0.05 g/10 min, and is more preferably not less than 0.1 g/10 min. Moreover, in order to improve melt tension, it is preferably not more than 50 g/10 min, more preferably 30 g/10 min, further preferably 20 g/10 min. The melt flow rate is a value measured by method A provided in JIS K7210-1995 at a temperature of 190° C. under an applied load of 21.18 N. The measurement of the melt flow rate typically uses an ethylene-based polymer including in advance an antioxidant of around 1000 ppm. The melt flow rate of the ethylene-based polymer, for example, can be changed by changing the hydrogen concentration or polymerization temperature at the time of polymerization; with a high hydrogen concentration or polymerization temperature, it is possible to increase the melt flow rate of the ethylene-based polymer.

The ethylene-based polymer shows a bimodal molecular weight distribution. In the specification, a bimodal distribution means that a molecular weight curve measured by gel permeation chromatography (GPC) has two peaks and that a minimum value is marked between the two peaks. In case of a unimodal molecular weight distribution, an extruding load increases.

The peak top molecular weight of the higher molecular weight peak on the molecular weight distribution curve of the ethylene-based polymer is not less than 50,000, preferably not less than 60,000, and more preferably not less than 70,000. The peak top molecular weight of the lower molecular weight peak is not more than 10,000, preferably not more than 8,000, and more preferably not more than 7,000. In view of reducing the extruding load, it is preferable to have the two peaks away from each other in distance. In order to improve the take-up property in the extrusion process, it is preferable that the peak top molecular weight on the higher molecular weight peak is not more than 600,000, is more preferable to be not more than 100,000, is further preferable to be not more than 90,000, and is particularly preferable to be not more than 80,000. In view of improving mechanical strength of the article obtained with use of the ethylene-based polymer of the present invention, and in view of reducing the emission of smoke at the time of extrusion process, it is preferable that the peak top molecular weight of the lower molecular weight peak is not less than 1,000, and is more preferable to be not less than 1,500.

Moreover, the peak top molecular weight of the higher molecular weight peak may be changed by changing, for example, hydrogen concentration, or the kind of the substance (A2). When the hydrogen concentration is reduced, the peak top molecular weight of the higher molecular weight peak of the ethylene-based polymer increases, and when the substance (A2) having a low hydrogen-controllability is selected, the peak top molecular weight of the higher molecular weight peak of the ethylene-based polymer increases. The peak top molecular weight of the lower molecular weight peak can be changed by changing, for example, hydrogen concentration or kind of the substance (A1). When the hydrogen concentration is reduced, the peak top molecular weight of the lower molecular weight peak of the ethylene-based polymer increases, and when the substance (A1) having a lower hydrogen controllability is selected, the peak top molecular weight of the lower molecular weight peak of the ethylene-based polymer increases.

In the bimodal molecular weight distribution of the ethylene-based polymer, the peak of the lower molecular weight peak is a peak derived from a polymer mainly obtained using the substance (A1), and the peak of the higher molecular weight peak is a peak derived from a polymer mainly obtained using the substance (A2). The ratio of the peak area of the higher molecular weight peak to the peak area of the lower molecular weight peak in the molecular distribution, was calculated in the following method with use of Excel (Microsoft Inc.).

[1] Having the molecular distribution curve (G) of GPC serve as numerical data of log (molecular weight) and its corresponding dwt/d (log molecular weight), a value that takes away a minimum value of log (molecular weight) from a maximum value of log (molecular weight) is divided by the number of data intervals (=number of data−1).
[2] Having the value obtained in [1] serve as an increment, a continuous data (x) was created, in which a starting value was made to be a minimum value of a log (molecular amount) of the molecular weight distribution curve (G) and a stopping value was made to be a maximum value of the log (molecular weight) of the molecular weight distribution curve (G).
[3] A log (molecular weight) of peak tops of each of the lower molecular weight peak and the higher molecular weight peak were obtained from the molecular weight distribution curve (G).
[4] With use of NORMDIST function, each of the peak top log (molecular weight) in [3] serving as an average, a standard deviation being 0.36, and with the function formula of a probability density function, a regular distribution function of the continuous data (x) calculated in [2] were found for each of the lower molecular weight peak and the higher molecular weight peak, each being f(x)_{A1} and f(x)_{A2}, respectively.
[5] A curve drawn as an addition of f(x)_{A1} and f(X)_{A2} was represented by

G′=a″f(x)_{A1}+b″f(x)_{A2} (a″,b″ are each a coefficient),

and the values of a″ and b″ were found so that the total of (G−G′)² was made minimum with use of Solver.
[6] By use of a″ and b″ obtained in [5], an area ratio of a″f(x)_{A1} with respect to the area of G′ was made to be a ratio of a peak area of the lower molecular weight peak, and an area ratio of b″f(x)_{A2} with respect to the area of G′ was made to be the ratio of the peak area of the higher molecular weight peak.

Further, as to the molecular weight distribution curve found by the GPC method, a ratio of a height of one of the two peaks to the other one of the two peaks is preferably in a range of 0.80≦H/L≦1.50 (where L is a height of a peak on a lower molecular weight peak, and H is a height of a peak on a higher molecular weight peak). In order to increase a mechanical strength of an article obtained by use of an ethylene-based polymer, it is more preferable that the ratio H/L is not less than 0.90. In order to reduce an extrusion load of the ethylene-based polymer, it is more preferable that the ratio H/L is not more than 1.40. It is possible to change the ratio H/L by adjusting, relatively with respect to each other, a used amount of the substance (A1) and a used amount of the substance (A2) for example. By adjusting a used amount of the substance (A2) to be large with respect to a used amount of the substance (A1), it is possible to cause the ratio H/L of the ethylene-based polymer to be large.

The weight-average molecular weight (hereinafter, referred to as “Mw” in some cases) of the ethylene-based polymer to number-average molecular weight (hereinafter, referred to as “Mn” in some cases) of the ethylene-based polymer ratio is within the range of from 4 to 55 (hereinafter, the ratio is referred to as “Mw/Mn” in some cases). In a case where the ratio Mw/Mn is significantly small, an extrusion load in the molding process might be increased. The ratio Mw/Mn is preferably not less than 4.5, more preferably not less than 5.5, still more preferably not less than 6. In order to increase a mechanical strength of an article obtained by use of the ethylene-based polymer, the ratio Mw/Mn is preferably not more than 45, more preferably not more than 40, still more preferably not more than 15.

The Z-average molecular weight (hereinafter, referred to as “Mz” in some cases) of the ethylene-based polymer to Mw ratio is preferably within the range of from 2 to 15 (hereinafter, the ratio is referred to as “Mz/Mw” in some cases). In a case where the ratio Mz/Mw is significantly small, there is a reduction in a melt tension of the ethylene-based polymer. In this case, a moldability of the ethylene-based polymer becomes low. For this reason, it is more preferable that the ratio Mz/Mw is not less than 3. On the other hand, in a case where the ratio Mz/Mw is significantly large, there is an increase in an extrusion lead of the ethylene-based polymer. For this reason, the ratio Mz/Mw is preferably not more than 12, more preferably not more than 10, still more preferably not more than 8.

The ratio Mw/Mn can be found by dividing Mw is by Mn after measuring Mw and Mn by the GPC method. The ratio Mz/Mw can be found by dividing Mz by Mw after measuring Mw and Mz by the GPC method. The ratio Mw/Mn can be changed by changing a hydrogen concentration or the type of the substance (A1) and the substance (A2), for example. An increase in the hydrogen concentration causes the ratio Mw/Mn of the ethylene-based polymer to be smaller. When the substance (A1) is one having a lower hydrogen-controllability, the ratio Mw/Mn of the ethylene-based polymer becomes smaller. When the substance (A2) is one having a higher hydrogen-controllability, the ratio Mw/Mn becomes smaller. Furthermore, by adjusting, relatively with respect to each other, a used amount of the substance (A1) and a used amount of the substance (A2), for example, it is possible to change the ratio Mz/Mw. When the used amount of the substance (A2) is greater than the used amount of the substance (A1), the ratio Mz/Mw of the ethylene-based polymer becomes larger.

The measurement was carried out by the GPC method under the following conditions. A value of a molecular weight of each peak position in the bimodal distribution was found by calibration in terms of polyethylene.

(1) Apparatus: Waters 150C (manufactured by Waters Corporation)
(2) Separation column: TOSOH TSKgel GMH6-HT
(3) Measurement temperature: 140° C.
(4) Carrier: ortho-dichlorobenzene
(5) Flow volume: 1.0 mL/minute
(6) Injection volume: 500 μL
(7) Detector: differential refractometry
(8) Molecular weight reference material: standard polystyrene

The ethylene-based polymer is such that the number of branches each having 5 or more carbon atoms per 1000 carbon atoms constituting the ethylene-based polymer is within the range of 0.2 to 0.7 (hereinafter, the number of branches of the size per 1000 carbon atoms may be referred to as “N_{LCB}” in some cases). In order to have a reduction in extrusion load in the molding process, N_{LCB} is preferably not less than 0.3, more preferably not less than 0.4. In view of an increase in mechanical strength of an article, N_{LCB} is preferably not more than 0.65, more preferably not more than 0.6. In the production method described above, it is possible to change N_{LCB} by, for example, (i) adjusting a hydrogen concentration in polymerization, (ii) adjusting a partial pressure of ethylene in the polymerization, (iii) adjusting a ratio of a used amount of the activating agent (B) to a sum of a used amount of the substance (A1) and a used amount of the substance (A2), or (iv) changing a method of supplying the substance (A1), the substance (A2), and the activating agent (B) into a polymerization tank. A lower hydrogen concentration increases N_{LCB} of the ethylene-based polymer. Further, when the ratio of the used amount of the activating agent (B) is lower to the sum of the used amount of the substance (A1) and the used amount of the substance (A2) to be low, the ethylene-based polymer has a larger N_{LCB}. By (i) supplying the substance (A1) and the activating agent (B) in the polymerization tank separately or simultaneously, so as to carry out the polymerization, and (ii) supplying the substance (A2) into the polymerization tank after a predetermine time period elapses, so as to carry out polymerization, it is possible to increase N_{LCB} of the ethylene-based polymer. By reducing the partial pressure of ethylene during the polymerization, it is also possible to increase N_{LCB} of the ethylene-based polymer.

N_{LCB} can be found in such a manner that (i) a ¹³C-NMR spectrum is measured by a carbon nuclear magnetic resonance (¹³C-NMR) method, and (ii) from the ¹³C-NMR spectrum, an area of a peak derived from methine carbon, to which a branch having 5 or more carbon atoms is bound, is found, while a total of areas of all peaks observed in the range of 5 ppm to 50 ppm is defined as 1000. The peak derived from methine carbon to which a branch having 5 or more carbon atoms is bound is observed in the vicinity of 38.2 ppm (Reference Document: academic document “Macromolecules”, (U.S.), American Chemical Society, 1999, Vol. 32, p. 3817-3819). A position of the peak derived from methine carbon to which a branch having 5 or more carbon atoms is bound might be shifted due to a measurement device and a measurement condition. For this reason, generally, a sample is measured per measurement device and per measurement condition, so as to determine the position of the peak described above. It is preferable to employ, in spectrum analysis, a negative exponential function as a window function.

In order to have an increase in melt tension, a swelling ratio of the ethylene-based polymer is preferably not less than 1.35, more preferably not less than 1.40, still more preferably not less than 1.45. In order to have a high take-up property in the extrusion process, the swelling ratio is preferably not more than 2.5, more preferably not more than 2.0. The swelling ratio can be found in such a manner that (i) the ethylene-based polymer is extruded from an orifice under such a condition that (a) a temperature is 190° C., and (b) an applied load is 21.18N (conveniently in performing the meltflow rate (MFR) measurement), so as to have a strand shape (length: approximately 15 mm to mm), (ii) the strand is cooled in the atmosphere so that a solid strand is obtained with a diameter D (unit: mm), where the diameter D is measured at a position approximately 5 mm away from one end of the solid strand, which end is on an upstream side of the extrusion, and (iii) the diameter D thus measured is divided by an orifice diameter of 2.095 mm (D₀) (i.e., D/D₀). By adjusting a hydrogen concentration, for example, it is possible to adjust the swelling ratio of the ethylene polymer. By causing the hydrogen concentration to be high, it is possible to cause the swelling ratio of the ethylene polymer to be large.

In order to enhance take-up property in extrusion process, a characteristic relaxation time of the ethylene-based polymer is preferably within the range of 0.01 second to 30 seconds. In order to improve appearance of a laminate made from the ethylene-based polymer, the characteristic relaxation time is more preferably not more than 20 seconds, still more preferably not more than 10 seconds. The characteristic relaxation time is an index indicating a length of a long-chain branch of the ethylene-based polymer. The shorter the long-chain branch is, the smaller a value of the characteristic relaxation time becomes. The longer the long-chain branch is, the larger a value of the characteristic relaxation time becomes. By changing a polymerization condition (such as a hydrogen concentration and an ethylene pressure), or adjusting, relatively with respect to each other, a used amount of the substance (A2) and a used amount of the substance (A1), for example, it is possible to change the characteristic relaxation time. When the ethylene pressure in the polymerization is lower, the characteristic relaxation time of the ethylene-based polymer becomes longer. When the used amount of the substance (A2) with respect to the used amount of the substance (A1) becomes smaller, the characteristic relaxation time becomes longer.

The characteristic relaxation time is a numerical value calculated from a master curve indicating dependency of melt complex viscosity (unit: Pa·sec) on angular frequency (unit: rad/sec) (temperature: 190° C.). The master curve is created on the basis of a temperature-time superposition principle. Specifically, a value of the characteristic relaxation time can be calculated in such a manner that (i) a melt complex viscosity-angular frequency curve (a unit of the melt complex viscosity: Pa·sec, a unit of the angular frequency: rad/sec) of the ethylene-based polymer is found at each of temperatures (T, unit: ° C.) of 130° C., 150° C., 170° C., and 190° C., (ii), on the basis of the temperature-time superposition principle, the melt complex viscosity-angular frequency curves found at the temperatures of 130° C., 150° C., and 170° C., are superposed on the melt complex viscosity-angular frequency curve found at the temperature of 190° C., so as to create the master curve, and (iii) the master curve is approximated by the following formula (I):

η=η₀/[1+(τ×ω)ⁿ] (I)
η: melt complex viscosity (unit: Pa·sec)
ω: angular frequency (unit: rad/sec)
τ: characteristic relaxation time (unit: sec)
η₀: constant found per ethylene-based polymer (unit: Pa·sec)
n: constant found per ethylene-based polymer
   The aforementioned calculation can be carried out by use of commercially-available calculation software. Such calculation software may be Rhios V. 4. 4. 4 (manufactured by Rheometrics, Inc.), for example.

In order to have a reduction in extrusion load in the molding process, activation energy of flow (hereinafter, referred to as “Ea” in some cases) of the ethylene-based polymer is preferably not less than 35 kJ/mol, more preferably not less than 40 kJ/mol. In order to enhance take-up property in the extrusion process, Ea is preferably not more than 100 kJ/mol, more preferably not more than 90 kJ/mol, still more preferably not more than 80 kJ/mol, most preferably not more than 70 kJ/mol. Furthermore, by adjusting, relatively with respect to each other, a used amount of the substance (A2) and a used amount of the substance (A1), it is possible to change Ea, for example. By increasing the used amount of the substance (A2) with respect to the used amount of the substance (A1), it is possible to cause Ea of the ethylene-based polymer to be high.

Ea can be calculated by use of Arrhenius equation with a shift factor (a_{T}). The shift factor is obtained in creation of the master curve indicating the dependency of the melt complex viscosity (unit: Pa·sec) on the angular frequency (unit: rad/sec) (temperature: 190° C.) on the basis of the temperature-time superposition principle. Specifically, Ea can be found by the following method. That is, (i) a melt complex viscosity-angular frequency curve (a unit of the melt complex viscosity: Pa·sec, a unit of the angular frequency: rad/sec) of an ethylene-α-olefin copolymer is found at each of temperatures (T, unit: ° C.) of 130° C., 150° C., 170° C., and 190° C., (ii), on the basis of the temperature-time superposition principle, the melt complex viscosity-angular frequency curves found at the temperatures of 130° C., 150° C., and 170° C., are superposed respectively on the melt complex viscosity-angular frequency curve found at the temperature of 190° C., so as to find a shift factor (a_{T}) for each of the temperatures (T), and (iii), on the basis of each of the temperatures (T) and the shift factor (a_{T}) for each of the temperatures (T), a primary approximation formula (the following formula (II)) indicating a relationship between [ln(a_{T})] and [1/(T+273.16)] is calculated by a least-square method. Then, Ea is found by use of inclination m of the primary formula and the following formula (III).

ln(a_{T})=m(1/(T+273.16))+n (II)

Ea=|0.008314×m| (III)
a_{T}: shift factor
Ea: activation energy of flow (unit: kJ/mol)
T: temperature (unit: ° C.)
   The aforementioned calculation can be carried out by use of commercially-available calculation software. Such calculation software may be Rhios V. 4. 4. 4 (manufactured by Rheometrics, Inc). The shift factor (a_{T}) is an amount of such movement that both logarithmic curves of the melt complex viscosity-angular frequency for each of the temperatures (T) is shifted in a log(Y)=−log(X) direction (note, however, that a Y axis indicates a melt complex viscosity, and an X axis indicates an angular frequency), so as to be superposed on the melt complex viscosity-angular frequency curve for the temperature of 190° C. In the superposition, both logarithmic curves of the melt complex viscosity-angular frequency for each of the temperatures (T) are shifted, for each of the curves, so that an angular frequency becomes a_{T} times greater than it was, and a melt complex viscosity becomes 1/a_{T} times greater than it was. Further, a correlation coefficient, used in finding, by the least-square method, the formula (I) by use of the four values for the temperatures of 130° C., 150° C., 170° C., and 190° C., is generally not less than 0.99.

The measurement of the melt complex viscosity-angular frequency curves, used in the calculation of Ea and in the calculation of the characteristic relaxation time, is carried out by use of a viscoelasticity measuring instrument (e.g., Rheometrics Mechanical Spectrometer RMS-800, manufactured by Rheometrics, Inc.), generally under the following conditions: (i) geometry: parallel plate, (ii) plate diameter: 25 mm, (iii) plate gap: 1.5 mm to 2 mm, (iv) strain: 5%, and (v) angular frequency: 0.1 rad/second to 100 rad/second. The measurement is carried out under nitrogen atmosphere. It is preferable that an appropriate amount (e.g., 1000 ppm) of an antioxidant is added to a measurement sample in advance.

In a case where a foam is produced by use of the ethylene-based polymer of the present invention, a melt tension of the ethylene-based polymer is preferably not less than 3 cN in view of an increase in expansion ratio of the foam. In a case where the melt tension is significantly small, breakage of foam is likely to occur in generation of the foam. In this case, it might be impossible to maintain a high expansion ratio. In view of an increase in expansion ratio of the foam, the melt tension is preferably not more than 40 cN, more preferably not more than 30 cN, still more preferably not more than 20 cN. In a case where the melt tension is significantly high, foam is unlikely to expand in growth of the foam by injection of gas. In this case, it tends to be difficult to obtain an article having a high expansion ratio. The melt tension is defined as such a maximum tension that is obtained between (i) start of taking-up of the ethylene-based polymer having a filament shape and (ii) breakage of the ethylene-based polymer having the filament shape in the taking-up, wherein (a) the ethylene-based polymer having the filament shape has been prepared by extruding a melt ethylene-based polymer from an orifice (diameter: 2.095 mm, length: 8 mm) at a temperature of 190° C. at an extrusion speed of 0.32 g/minute, and (b) the taking-up of the melt ethylene-based polymer thus extruded in the filament shape is carried out at a take-up rate increased at a rate of 6.3 (m/minute)/minute. By changing an ethylene pressure in the polymerization, for example, it is possible to change the melt tension. By causing the ethylene pressure in the polymerization to be low, it is possible to cause the melt tension of the ethylene-based polymer to be high. By adjusting, relatively with respect to each other, a used amount of the substance (A2) and a used amount of the substance (A1), it is possible to change the melt tension. By causing the relative used amount of the substance (A2) to be larger, it is possible to cause the melt tension to be high.

A high-speed processability can be evaluated by a maximum take-up rate (MTV) (unit: m/minute). The larger a value of the MTV is, the higher the high-speed processability becomes. The MTV can be found in such a manner that (i) a melt resin with which a barrel of 9.5 mmφ is filled is extruded from an orifice (diameter: 2.09 mmφ, length: 8 mm) at a temperature of 190° C. at a piston descending speed of 5.5 mm/minute, (ii) the melt resin thus extruded is taken-up by use of a take-up roller having a diameter of 150 mmφ, and (iii) a take-up rate is found at a time point when the melt resin is broken in the taking-up at a taking-up rate increased at a rate of 40 rpm/minute. The MTV is preferably not less than 10 m/minute, more preferably not less than 20 m/minute, still more preferably not less than 30 m/minute. In the production method described above, by adjusting, relatively with respect to each other, a used amount of the substance (A1) and a used amount of the substance (A2), or adjusting a hydrogen concentration, for example, it is possible to change the MTV. By increasing the used amount of the substance (A1) with respect to the used amount of the substance (A2), it is possible to cause the MTV of the ethylene-based polymer to be high. By causing the hydrogen concentration in the polymerization to be high, it is possible to cause the MTV of the ethylene-based polymer to be high.

For the ethylene-based polymer of the present invention, a publicly-known process may be used. Examples of such a process include an extrusion process (such as a blown film process, a flat die process, and a lamination film process), an injection molding process, and a compression molding process. Among these, the extrusion process is suitably employed.

The ethylene-based polymer of the present invention is used as articles in various forms. A form of such an article is not particularly limited. Examples of the form of the article include a film, a sheet, and a container (a tray, a bottle, etc.). The article can be also suitably used as (i) a food packing material, (ii) a medical product packing material, (iii) an electronic component packing material used to pack, for example, a semiconductor product, or (iv) a surface protection material, for example.

### EXAMPLES

Details of the present invention are described below more specifically with the following Examples and Comparative Examples. Each of values measured in the following Examples were found in accordance with the following methods.

### (1) Density (d, Unit: Kg/m³)

A density was measured in accordance with a method provided in an A method in JIS K7112-1980. Note that a sample was subjected to annealing described in JIS K6760-1995 before measuring the density.

(2) Melt Flow Rate (MFR, Unit: g/10 Minutes)

A melt flow rate was measured by the A method provided in JIS K7210-1995 at a temperature of 190° C. under an applied load of 21.18N.

### (3) Swelling Ratio (SR)

In the measurement of the melt flow rate described in the above (2), an ethylene-based polymer was extruded from an orifice under such conditions that (i) a temperature was 190° C. and (ii) an applied load was 21.18N, so as to have a strand shape (length: approximately 15 mm to 20 mm). The strand thus obtained was cooled in the atmosphere, so that a solid strand of the ethylene-based polymer was obtained. Next, a diameter D (unit: mm) of the solid strand was measured at a position approximately 5 mm away from one of ends of the solid strand, which one of ends was on an upstream side of the extrusion. The diameter D thus measured was divided by an orifice diameter of 2.095 mm (D₀) (i.e., D/D₀). The D/D₀ thus found was used as the swelling ratio.

(4) Molecular weight distribution (Mw/Mn, Mz/Mw), molecular weight of peak top on higher molecular weight peak, molecular weight of peak top on lower molecular weight peak, height ratio of high peak to low peak (H/L)

By a gel permeation chromatography (GPC) method, a z-average molecular weight (Mz), a weight-average molecular weight (Mw), and a number-average molecular weight (Mn) were measured, and Mw/Mn and Mz/Mw were found. A base line on a chromatogram was a line connecting, to each other, (i) a point in a stable horizontal region whose retention time period was sufficiently shorter than the retention time of the first elution peak of a sample, and (ii) a point in a stable horizontal region whose retention time period is sufficiently longer than the retention time of a solvent elution peak. A value of a molecular weight at each peak position in the bimodal distribution was found by calibration in terms of polyethylene.

(i) Apparatus: Waters 150C (manufactured by Waters Corporation)
(ii) Separation column: TOSOH TSKgel GMH6-HT
(iii) Measurement temperature: 140° C.
(iv) Carrier: ortho-dichlorobenzene
(v) Flow volume: 1.0 mL/minute
(vi) Injection volume: 500 L
(vii) Detector: differential refractometry
(viii) Molecular weight reference material: standard polystyrene
(5) The number of long-chain branches (N_{LCB}, unit: 1/1000 C)
A carbon nuclear magnetic resonance spectrum (¹³C-NMR) was measured by a carbon nuclear resonance method under the following conditions, in accordance with the following calculation method.

### ≦Measurement Conditions>

Apparatus: AVANCE 600 (manufactured by Bruker Corporation)
Measurement solvent: a mixed solution of 1,2-dichlorobenzene/1,2-dichlorobenzene-d4 (=75/25 (volume))
Measurement temperature: 130° C.
Measurement method: proton decoupling method
Pulse width: 45°
Pulse repetition period: 4 seconds
Measurement reference: trimethylsilane
Window function: negative exponential function

### ≦Calculation Method>

A peak area of a peak having a peak top in a range of approximately 38.22 ppm to approximately 38.27 ppm was determined in ratio with respect to a total area of all peaks observed in a range of 5 ppm to 50 ppm, where the total area of all the peaks was set to 1000. The peak area of the peak was defined as an area of a signal in a range from a chemical shift of a valley between the peak and an adjacent peak on a higher magnetic field side, to another chemical shift of a valley between the peak and an adjacent peak on a lower magnetic field side. In the measurement of an ethylene-based polymer under the present condition, a position of a peak top of a peak derived from methine carbon to which a branch having 5 carbon atoms was bound was 38.21 ppm.

(6) Characteristic Relaxation Time (τ) (Unit: sec)

By use of a viscoelasticity measuring instrument (Rheometrics Mechanical Spectrometer RMS-800, manufactured by Rheometrics Inc.), a melt complex viscosity-angular frequency curve was measured at each of temperatures of 130° C., 150° C., 170° C., and 190° C., under the following measurement conditions. Then, by use of calculation software (Rhios V. 4. 4. 4 (manufactured by Rheometrics Inc.), a master curve of the melt complex viscosity-angular frequency curve obtained at the temperature of 190° C. was created on the basis of the melt complex viscosity-angular frequency curves thus measured. A characteristic relaxation time (i) was found on the basis of the master curve.

### ≦Measurement Conditions>

Geometry: parallel plate
Plate diameter: 25 mm

### Plate gap: 1.5 mm to 2 mm

### Strain: 5%

Angular frequency: 0.1 rad/second to 100 rad/second
Measurement atmosphere: nitrogen
(7) Activation Energy of Flow (Ea, Unit: kJ/mol)

By use of a viscoelasticity measuring instrument (Rheometrics Mechanical Spectrometer RMS-800, manufactured by Rheometrics Inc.), a melt complex viscosity-angular frequency curve was measured at each of temperatures of 130° C., 150° C., 170° C., and 190° C., under the following measurement conditions. Then, by use of calculation software (Rhios V. 4. 4. 4 (manufactured by Rheometrics Inc.), a master curve of the melt complex viscosity-angular frequency curve obtained at the temperature of 190° C. was created on the basis of the melt complex viscosity-angular frequency curves thus measured. Ea was found on the basis of the master curve.

≦Measurement conditions>
Geometry: parallel plate
Plate diameter: 25 mm

### Plate gap: 1.5 mm to 2 mm

### Strain: 5%

Angular frequency: 0.1 rad/second to 100 rad/second
Measurement atmosphere: nitrogen

### (8) Melt Tension (MT, Unit: cN)

By use of a melt tension tester (TOYO SEIKI SEISAKU-SHO, LTD), an ethylene-based polymer was melt and extruded from an orifice (diameter: 2.095 mm, length: 8 mm) at a temperature of 190° C. at an extrusion speed of 0.32 g/minute. The melt ethylene-based polymer thus extruded was taken-up in by a take-up roller at a take-up rate increased at a rate of 6.3 (m/minute)/minute, so as to have a filament shape. A tension in the reeling-in was measured. A melt tension was defined as a maximum tension between a time when the realing-in was started and a time when the ethylene-based polymer having a filament shape was broken.

(9) Maximum Take-Up Rate (MTV, Unit: m/minute)

In the measurement of the melt tension in the above (8), a maximum take-up rate was defined as a take-up rate when the ethylene-based polymer having a filament shape was broken. The higher a value of the maximum take-up rate was, the greater a take-up property of an article in an extrusion process was.

### Reference Example 1

### Synthesis of trans-1,2-bis(2-hydroxy-3,5-di-tert-butyl benzylsulfanyl)cycloheptane

Under the presence of argon atmosphere, 1.64 g (10.1 mmol) of trans-cycloheptane-1,2-dithiol (known as described in a document) and 6.04 g (20.2 mmol) of 3,5-di-tert-butyl-2-hydroxybenzyl bromide were dissolved in 110 mL of tetrahydrofuran, and a resultant mixture was cooled to a temperature of 0° C. To the resultant mixture, 2.8 mL (20.2 mmol) of triethylamine was added, and was stirred for 12 hours at a temperature of 0° C. A precipitate thus generated was removed by filtration, and a solution thus filtered was concentrated under reduced pressure. To a residue thus obtained, ether and dilute hydrochloric acid were added. Then, an ether layer was washed with water, and was dried with anhydrous sodium sulfate. After that, a solvent was distilled away under reduced pressure. A residue thus obtained was purified by silica gel column chromatography (developing solvent: hexane-dichloromethane (1:1)), so as to be colorless crystal. As a result, 3.79 g (yield: 63%) of a title compound was obtained.

Melting point: 109-110° C. (decomposition)

¹H-NMR (500 MHz, δ, CDCl₃)

1.14-1.93 (m, 46H), 2.68-2.69 (m, 2H), 3.71-3.79 (m, 4H), 6.80 (s, 2H), 6.89 (d, J=3 Hz, 2H), 7.25 (d, J=3 Hz, 2H).

¹³C-NMR (100.7 MHz, 6, CDCl₃)

25.0, 28.7, 29.7, 31.6, 31.9, 34.2, 34.6, 35.0, 50.3, 121.4, 123.7, 125.1, 137.3, 142.1, 152.1.

Elemental analysis: calculated value (C₃₇H₅₆O₂S₂) C, 74.19%; H, 9.42% Measured value: C, 74.08%; H, 9.84%

### Reference Example 2

### Synthesis of [cycloheptanedyil-trans-1,2-bis(2-oxoyl-3,5-di-tert-butyl benzylsulfanyl)]dichlorozirconium

The following experiment was carried out under the presence of argon atmosphere. In a 100-mL Schlenk flask, 1.00 g (1.67 mmol) of trans-1,2-bis(2-hydroxy-3,5-di-tert-butyl benzylsulfanyl)cycloheptane was dissolved in 15 mL of diethyl ether. Then, to a resultant solution, 2.2 mL (1.67 mol/L, 3.67 mmol) of n-butyllithium was added, and a resultant solution was stirred at a temperature of 0° C. for 1 hour. The solution was dropped, at a temperature of −78° C., to 20 mL of a diethyl ether solution containing 400 mg (1.72 mmol) of tetrachlorozirconium, and then, a solution thus obtained was stirred overnight. A precipitate thus generated was removed by filtration, and a solution thus filtered was concentrated under reduced pressure. A residue thus obtained was washed with 8 mL of hexane, and dried. As a result, 803 mg (yield: 63%) of a title compound was obtained as colorless crystal.

¹H-NMR (500 MHz, δ, ppm, C₆D₆)

0.67-1.95 (m, 46H), 2.37 (s, 2H), 3.17 (d, J=14 Hz, 2H), 4.34 (d, J=14 Hz, 2H), 6.55 (s, 2H), 7.53 (d, J=1 Hz, 2H).

¹³C-NMR (100.7 MHz, δ, ppm, C₆D₆)

25.8, 29.6, 30.5, 31.0, 31.8, 34.4, 35.6, 36.0, 49.7, 120.8, 124.8, 125.8, 138.6, 142.7, 157.2.

### Reference Example 3

### Synthesis of trans-1,2-bis(2-hydroxy-3,5-di-tert-butyl benzylsulfanyl)cyclooctane

Under the presence of argon atmosphere, 2.18 g (12.4 mmol) of trans-cyclooctane-1,2-dithiol and 7.52 g (25.1 mmol) of 3,5-di-t-butyl-2-hydroxybenzyl bromide were dissolved in 80 mL of tetrahydrofuran, and a resultant mixture was cooled to a temperature of 0° C. To the resultant mixture, 3.5 mL (24.9 mmol) of triethylamine was added, and the mixture was stirred for 1 hour at a temperature of 0° C., and then was stirred at room temperature overnight. A precipitate thus generated was removed by filtration, and a solution thus filtered was concentrated under reduced pressure. To a residue thus obtained, ether and a saturated ammonium chloride aqueous solution were added. Then, an ether layer was washed with water, and was dried with anhydrous magnesium sulfate. After that, a solvent was distilled away under reduced pressure. A residue thus obtained was purified by silica gel column chromatography (developing solvent: hexane-dichloromethane (1:1)). As a result, 6.74 g (yield: 89%) of a title compound was obtained as colorless crystal.

Melting point: 122-123° C. (recrystallization from hexane) ¹H-NMR (400 MHz, δ, ppm, CDCl₃)

1.12-1.94 (m, 48H), 2.63-2.65 (m, 2H), 3.81 (d, J=13 Hz, 2H), 3.90 (d, J=13 Hz, 2H), 6.92 (d, J=2 Hz, 2H), 6.95 (s, 2H), 7.26 (d, J=2 Hz, 2H).

¹³C-NMR (100.7 MHz, 6, CDCl₃)

25.7, 25.8, 29.8, 31.2, 31.6, 34.2, 35.0, 35.4, 49.6, 121.6, 123.7, 125.4, 137.4, 142.0, 152.2.

Elemental analysis: calculated value (C₃₈H₆₀O₂S₂) C, 74.45%; H, 9.87%.

Measured value: C, 74.39%; H, 10.09%.

Document: A. Ishii, A. Ono, N. Nakata, J. Sulf. Chem. 2009, 30, 236-244.

### Reference Example 4

### Synthesis of [cyclooctanediyl-trans-1,2-bis(2-oxovl-3,5-di-tert-butyl benzyvlsulfanyl)]dichlorozirconium

In a 50-mL Schlenk flask, 1.00 g (1.63 mmol) of trans-1,2-bis(2-hydroxy-3,5-di-tert-butyl benzylsulfanyl)cyclooctane and 12 mL of diethyl ether were provided, and ice-chilled. Under an ice-chilled condition, 2.2 mL of n-butyl lithium (a 1.6 M hexane solution, 3.5 mmol) was added to a resultant solution. Then, the solution was heated to room temperature and was stirred for 1 hour. The solution was dropped to a diethyl ether suspending solution (whose temperature had been cooled to −78° C.) of zirconium tetrachloride. A resultant solution was heated to room temperature, and was stirred overnight. After a volatile component was distilled away under reduced pressure, a white solid thus obtained was extracted with the use of dichloromethane, and was filtered. A solution thus filtered was concentrated under reduced pressure. To the solution, hexane was added in an amount three times more than that of the solution, and then the solution was further concentrated until a volume of the solution was reduced to approximately ⅓. A white solid separated out was collected, and dried under reduced pressure. As a result, 0.94 g (yield: 75%) of [cyclooctanedyil-trans-1,2-bis(2-oxoyl-3,5-di-tert-butyl benzylsulfanyl)]dichlorozirconium.0.6CH₂Cl₂ was obtained as white powder.

¹H-NMR (400 MHz, δ, ppm, CDCl₃)

0.80-1.85 (m, 12H), 1.26 (s, 18H), 1.56 (s, 18H), 2.58 (m, 2H), 3.84 (d, J=14 Hz, 2H), 4.47 (d, J=14 Hz, 2H), 6.87 (d, J=2 Hz, 2H), 7.37 (d, J=2 Hz, 2H).

### Example 1

After drying under reduced pressure, a 5 L autoclave with a stirrer, in which air had been replaced by argon, was vacuumized. Then, 500 ml of toluene serving as a solvent was fed into the autoclave and the temperature of the autoclave was raised to 70° C. After that, ethylene was added to the autoclave so that its partial pressure was 0.6 MPa, and pressure inside the system was stabilized. To the autoclave, 2.0 ml of a toluene solution of methylaluminoxane, which had been prepared so as to have a concentration of 2.5 mmol/ml, was added. Next, 0.50 ml of a toluene solution of [cycloheptanediyl-trans-1,2-bis(2-oxoyl-3,5-di-tert-butyl benzylsulfanyl)]dichlorozirconium (A1) obtained in Reference Example 2, which had been prepared so as to have a concentration of 1.0 μmol/ml, was added to the mixture, and the mixture was subjected to first-stage polymerization for 30 minutes at 70° C. while ethylene was fed so that the total pressure was kept constant. After that, ethylene was purged from the autoclave until its partial pressure was 0.2 MPa. Then, 0.50 ml of a toluene solution of racemic ethylenebis (indenyl)zirconium diphenoxide (A2), which had been prepared so as to have a concentration of 1.0 μmol/ml, was added. The mixture was subjected to second-stage polymerization for 30 minutes at 70° C. while ethylene was fed so that the total pressure was kept constant. As a result, 67.1 g of an ethylene-based polymer was obtained. The polymerization activity of the sum of the substance (A1) and the substance (A2) was 0.7×10⁸ g/mol. The physical properties of the ethylene-based polymer thus obtained are shown in Table 1.

### Comparative Example 1

After drying under reduced pressure, a 5 L autoclave with a stirrer, in which air had been replaced by argon, was vacuumized. Then, 500 ml of toluene serving as a solvent was fed into the autoclave and the temperature of the autoclave was raised to 70° C. After that, ethylene was added to the autoclave so that its partial pressure was 0.6 MPa, and pressure inside the system was stabilized. To the autoclave, 2.0 ml of a toluene solution of methylaluminoxane, which had been prepared so as to have a concentration of 2.5 mmol/ml, was added. Next, 0.50 ml of a toluene solution of [cycloheptanediyl-trans-1,2-bis(2-oxoyl-3,5-di-tert-butyl benzylsulfanyl)]dichlorozirconium (A1) obtained in Reference Example 2, which had been prepared so as to have a concentration of 1.0 μmol/ml, was added to the mixture, and the mixture was subjected to first-stage polymerization for 30 minutes at 70° C. while ethylene was fed so that the total pressure was kept constant. After that, ethylene was purged from the autoclave until its partial pressure was 0.2 MPa. Then, the mixture was subjected to second-stage polymerization for 30 minutes at 70° C. while ethylene was fed so that the total pressure was kept constant. As a result, 38.3 g of an ethylene-based polymer was obtained. The polymerization activity of the substance (A1) was 0.8×10⁸ g/mol. The physical properties of the ethylene-based polymer thus obtained are shown in Table 1.

### Comparative Example 2

After drying under reduced pressure, a 5 L autoclave with a stirrer, in which air had been replaced by argon, was vacuumized. Then, 500 ml of toluene serving as a solvent was fed into the autoclave and the temperature of the autoclave was raised to 70° C. After that, ethylene was added to the autoclave so that its partial pressure was 0.2 MPa, and pressure inside the system was stabilized. To the autoclave, 2.0 ml of a toluene solution of methylaluminoxane, which had been prepared so as to have a concentration of 2.5 mmol/ml, was added. Next, 0.50 ml of a toluene solution of racemic ethylenebis (indenyl)zirconium diphenoxide (A2), which had been prepared so as to have a concentration of 1.0 μmol/ml, was added to the mixture, and the mixture was polymerized for 30 minutes at 70° C. while ethylene was fed so that the total pressure was kept constant. As a result, 23.6 g of an ethylene-based polymer was obtained. The polymerization activity of the substance (A2) was 0.5×10⁸ g/mol. The physical properties of the ethylene-based polymer thus obtained are shown in Table 1.

TABLE 1

| | | | | Comparative | Comparative |
|---|---|---|---|---|---|
| | | | Example 1 | Example 1 | Example 2 |
| First-stage | Substance | Complex | a | a | — |
| polymerization | (A1) | species | | | |
| | | μmol | 0.5 | 0.5 | — |
| | Ethylene | MPa | 0.6 | 0.6 | — |
| | partial | | | | |
| | pressure | | | | |
| | Polymerization | minutes | 30 | 30 | — |
| | time | | | | |
| Second-stage | Substance (A2) | Complex | b | — | b |
| polymerization | | species | | | |
| | | μmol | 0.5 | — | 0.5 |
| | Ethylene | MPa | 0.2 | 0.2 | 0.2 |
| | partial | | | | |
| | pressure | | | | |
| | Polymerization | minutes | 30 | 30 | 30 |
| | time | | | | |

| | | | | |
|---|---|---|---|---|
| Density | kg/m³ | 965 | — | 961 |
| MFR | g/10 min. | 2.8 | —*1 | 0.15 |
| Molecular weight | | | | |
| distribution | | | | |
| Mw/Mn | — | 10.7 | 2.7 | 2.0 |
| Mz/Mw | | 3.5 | 2.6 | 1.8 |
| H/L | — | 1.19 | — | — |
| Peak molecular weight on | ×10³ | 73.3 | — | — |
| higher molecular weight | | | | |
| peak | | | | |
| Peak molecular weight on | ×10³ | 5.9 | — | — |
| lower molecular weight peak | | | | |
| Difference between peak | ×10³ | 67.4 | — | — |
| molecular weight on higher | | | | |
| molecular weight peak and | | | | |
| that on lower molecular | | | | |
| weight peak | | | | |
| Percentage of the area of | % | 55 | — | — |
| peak on higher molecular | | | | |
| weight peak | | | | |
| Percentage of the area of | % | 45 | — | — |
| peak on lower molecular | | | | |
| weight peak | | | | |
| SR | — | 1.54 | —*1 | 1.07 |
| MT | cN | 3.6 | —*1 | 6.9 |
| MTV | m/min. | 40.4 | —*1 | 32.5 |
| Characteristic relaxation | s | 4.4 | —*1 | 24.2 |
| time τ | | | | |
| Ea | kJ/molK | 70.4 | —*1 | 71.4 |
| N_{LCB} | 1/1000 C. | 0.41 | 0.23 | 0.01 |

a: [Cycloheptanediyl-trans-1,2-bis (2-oxoyl-3,5-di-tert-butyl benzylsulfanyl)] dichlorozirconium
b: Racemic ethylenebis (indenyl) zirconium diphenoxide
*1Not measurable because of too low molecular weight

According to the results shown in Table 1, if the polymer obtained in Example 1 is a simple mixture of a polymer derived from the substance (A1) and a polymer derived from the substance (A2), the N_{LCB} of the polymer obtained in Example 1 should be 0.11.

0.23(N_{LCB} of polymer obtained only with substance(A1))×0.45(percentage of the area of peak on lower molecular weight peak)+0.01(N_{LCB} of polymer obtained only with substance(A2))×0.55(percentage of the area of peak on higher molecular weight peak)=0.11

However, the N_{LCB} of the polymer obtained in Example 1 is 0.41, which is significantly larger than would be expected for a simple mixture.

### Example 2

After drying under reduced pressure, a 5 L autoclave with a stirrer, in which air had been replaced by argon, was vacuumized. Then, 500 ml of toluene serving as a solvent was fed into the autoclave, and the temperature of the autoclave was raised to 70° C. After that, ethylene was added to the autoclave so that its partial pressure was 0.6 MPa, and pressure inside the system was stabilized. To the autoclave, 2.0 ml of a toluene solution of methylaluminoxane, which had been prepared so as to have a concentration of 2.5 mmol/ml, was added. Next, 0.50 ml of a toluene solution of [cyclooctanediyl-trans-1,2-bis(2-oxoyl-3,5-di-tert-butyl benzylsulfanyl)]dichlorozirconium (A1) obtained in Reference Example 4, which had been prepared so as to have a concentration of 1.0 μmol/ml, was added to the mixture, and the mixture was subjected to first-stage polymerization for 30 minutes at 70° C. while ethylene was fed so that the total pressure was kept constant. After that, ethylene was purged from the autoclave until its partial pressure was 0.2 MPa. Then, 0.50 ml of a toluene solution of a racemic ethylenebis(indenyl)zirconium diphenoxide (A2), which had been prepared so as to have a concentration of 1.0 μmol/ml, was added. The mixture was subjected to second-stage polymerization for 30 minutes at 70° C. while ethylene was fed so that the total pressure was kept constant. As a result, 121.3 g of an ethylene-based polymer was obtained. The polymerization activity of the sum of the substance (A1) and the substance (A2) was 1.2×10⁸ g/mol. The physical properties of the ethylene-based polymer thus obtained are shown in Table 2.

### Comparative Example 3

After drying under reduced pressure, a 5 L autoclave with a stirrer, in which air had been replaced by argon, was vacuumized. Then, 500 ml of toluene serving as a solvent was fed into the autoclave, and the temperature of the autoclave was raised to 70° C. After that, ethylene was added to the autoclave so that its partial pressure was 0.6 MPa, and pressure inside the system was stabilized. To the autoclave, 2.0 ml of a toluene solution of methylaluminoxane, which had been prepared so as to have a concentration of 2.5 mmol/ml, was added. Next, 0.50 ml of a toluene solution of [cyclooctanediyl-trans-1,2-bis(2-oxoyl-3,5-di-tert-butyl benzylsulfanyl)]dichlorozirconium (A1) obtained in Reference Example 4, which had been prepared so as to have a concentration of 1.0 μmol/ml, was added to the mixture, and the mixture was subjected to first-stage polymerization for 30 minutes at 70° C. while ethylene was fed so that the total pressure was kept constant. After that, ethylene was purged from the autoclave until its partial pressure was 0.2 MPa. Then, the mixture was subjected to second-stage polymerization for 30 minutes at 70° C. while ethylene was fed so that the total pressure was kept constant. As a result, 78.7 g of an ethylene-based polymer was obtained. The polymerization activity of the substance (A1) was 1.6×10⁸ g/mol. The physical properties of the ethylene-based polymer thus obtained are shown in Table 2.

TABLE 2

| | | | | Comparative | Comparative |
|---|---|---|---|---|---|
| | | | Example 2 | Example 3 | Example 2 |
| First-stage | Substance (A1) | Complex | c | c | — |
| polymerization | | species | | | |
| | | μmol | 0.5 | 0.5 | — |
| | Ethylene partial | MPa | 0.6 | 0.6 | — |
| | pressure | | | | |
| | Polymerization time | minutes | 30 | 30 | — |
| Second-stage | Substance (A2) | Complex | b | — | b |
| polymerization | | species | | | |
| | | μmol | 0.5 | — | 0.5 |
| | Ethylene partial | MPa | 0.2 | 0.2 | 0.2 |
| | pressure | | | | |
| | Polymerization time | minutes | 30 | 30 | 30 |

| | | | | |
|---|---|---|---|---|
| Density | kg/m³ | 965 | — | 961 |
| MFR | g/10 min. | 40 | —*1 | 0.15 |
| Molecular weight | | | | |
| distribution | | | | |
| Mw/Mn | — | 14.2 | 4.1 | 2.0 |
| Mz/Mw | | 5.3 | 3.5 | 1.8 |
| H/L | — | 0.71 | — | — |
| Peak molecular weight on | ×10³ | 57.4 | — | — |
| higher molecular weight peak | | | | |
| Peak molecular weight on lower | ×10³ | 5.7 | — | — |
| molecular weight peak | | | | |
| Difference between peak | ×10³ | 51.7 | — | — |
| molecular weight on higher | | | | |
| molecular weight peak and that | | | | |
| on lower molecular weight peak | | | | |
| Percentage of the area of peak | % | 42 | — | — |
| on higher molecular weight | | | | |
| peak | | | | |
| Percentage of the area of peak | % | 58 | — | — |
| on lower molecular weight peak | | | | |
| SR | — | —*1 | —*1 | 1.07 |
| MT | cN | —*1 | —*1 | 6.9 |
| MTV | m/min. | —*1 | —*1 | 32.5 |
| Characteristic relaxation time τ | s | 0.2 | —*1 | 24.2 |
| Ea | kJ/molK | 54.1 | —*1 | 71.4 |
| N_{LCB} | 1/1000 C. | 0.63 | 0.63 | 0.01 |

c: [Cyclooctanediyl-trans-1,2-bis (2-oxoyl-3,5-di-tert-butyl benzylsulfanyl)] dichlorozirconium
b: Racemic ethylenebis (indenyl) zirconium diphenoxide
*1Not measurable because of too low molecular weight

According to the results shown in Table 2, if the polymer obtained in Example 2 is a simple mixture of a polymer derived from the substance (A1) and a polymer derived from the substance (A2), the N_{LCB} of the polymer obtained in Example 2 should be as follows:

0.63(N_{LCB} of polymer obtained only with substance(A1))×0.58(percentage of the area of peak on lower molecular weight peak)+0.01(N_{LCB} of polymer obtained only with substance(A2))×0.42(percentage of the area of peak on higher molecular weight peak)=0.37.

However, the N_{LCB} of the polymer obtained in Example 2 is 0.63, which is significantly larger than would be expected for a simple mixture.

### Example 3

After drying under reduced pressure, a 5 L autoclave with a stirrer, in which air had been replaced by argon, was vacuumized. Then, 500 ml of toluene serving as a solvent was fed into the autoclave, and the temperature of the autoclave was raised to 70° C. After that, ethylene was added to the autoclave so that its partial pressure was 0.6 MPa, and pressure inside the system was stabilized. To the autoclave, 2.0 ml of a toluene solution of methylaluminoxane, which had been prepared so as to have a concentration of 2.5 mmol/ml, was added. Next, 0.50 ml of a toluene solution of [cycloheptanediyl-trans-1,2-bis(2-oxoyl-3,5-di-tert-butyl benzylsulfanyl)]dichlorozirconium (A1) obtained in Reference Example 2, which had been prepared so as to have a concentration of 1.0 μmol/ml, was added to the mixture, and the mixture was subjected to first-stage polymerization for 30 minutes at 70° C. while ethylene was fed so that the total pressure was kept constant. After that, ethylene was purged from the autoclave until its partial pressure was 0.2 MPa. Then, 3.0 ml of a toluene solution of dimethylsilylene tetramethyl cyclopentadienyl(tert-butylamide)titanium dichloride (A2), which had been prepared so as to have a concentration of 1.0 μmol/ml, was added. The mixture was subjected to second-stage polymerization for 30 minutes at 70° C. while ethylene was fed so that the total pressure was kept constant. As a result, 30.0 g of an ethylene-based polymer was obtained. The polymerization activity of the sum of the substance (A1) and the substance (A2) was 0.09×10⁸ g/mol. The physical properties of the ethylene-based polymer thus obtained are shown in Table 3.

### Comparative Example 4

After drying under reduced pressure, a 5 L autoclave with a stirrer, in which air had been replaced by argon, was vacuumized. Then, 500 ml of toluene serving as a solvent was fed into the autoclave, and the temperature of the autoclave was raised to 70° C. After that, ethylene was added to the autoclave so that its partial pressure was 0.2 MPa, and pressure inside the system was stabilized. To the autoclave, 2.0 ml of a toluene solution of methylaluminoxane, which had been prepared so as to have a concentration of 2.5 mmol/ml, was added. Next, 3.0 ml of a toluene solution of [dimethylsilylene tetramethyl cyclopentadienyl(tert-butylamide)titanium dichloride (A2), which had been prepared so as to have a concentration of 1.0 μmol/ml, was added to the mixture, and the mixture was polymerized for 30 minutes at 70° C. while ethylene was fed so that the total pressure was kept constant. As a result, 11.1 g of an ethylene-based polymer was obtained. The polymerization activity of the substance (A2) was 0.04×10⁸ g/mol. The physical properties of the ethylene-based polymer thus obtained are shown in Table 3.

TABLE 3

| | | | | Comparative | Comparative |
|---|---|---|---|---|---|
| | | | Example 3 | Example 1 | Example 4 |
| First-stage | Substance (A1) | Complex | a | a | — |
| polymerization | | species | | | |
| | | μmol | 0.5 | 0.5 | — |
| | Ethylene | MPa | 0.6 | 0.6 | — |
| | partial | | | | |
| | pressure | | | | |
| | Polymerization time | minutes | 30 | 30 | — |
| Second-stage | Substance (A2) | Complex | d | — | d |
| polymerization | | species | | | |
| | | μmol | 3.0 | — | 3.0 |
| | Ethylene | MPa | 0.2 | 0.2 | 0.2 |
| | partial | | | | |
| | pressure | | | | |
| | Polymerization time | minutes | 30 | 30 | 30 |

| | | | | |
|---|---|---|---|---|
| Density | kg/m³ | 975 | — | 961 |
| MFR | g/10 min. | 0.033 | —*1 | —*2 |
| Molecular weight distribution | | | | |
| Mw/Mn | — | 50.8 | 2.7 | 2.1 |
| Mz/Mw | | 12.0 | 2.6 | 1.8 |
| H/L | — | 0.19 | — | — |
| Peak molecular weight on | ×10³ | 528.4 | — | — |
| higher molecular weight peak | | | | |
| Peak molecular weight on lower | ×10³ | 4.1 | — | — |
| molecular weight peak | | | | |
| Difference between peak | ×10³ | 524.3 | — | — |
| molecular weight on higher | | | | |
| molecular weight peak and that | | | | |
| on lower molecular weight peak | | | | |
| Percentage of the area of peak | % | 18 | — | — |
| on higher molecular weight | | | | |
| peak | | | | |
| Percentage of the area of peak | % | 82 | — | — |
| on lower molecular weight peak | | | | |
| SR | — | 1.09 | —*1 | —*2 |
| MT | cN | 8.5 | —*1 | —*2 |
| MTV | m/min. | 15.7 | —*1 | —*2 |
| Characteristic relaxation time τ | s | 28.2 | —*1 | 8.4 |
| Ea | kJ/molK | 40.8 | —*1 | 36.9 |
| N_{LCB} | 1/1000 C. | 0.32 | 0.23 | 0.00 |

a: [Cycloheptanediyl-trans-1,2-bis (2-oxoyl-3,5-di-tert-butyl benzylsulfanyl)] dichlorozirconium
d: Dimethylsilylene tetramethyl cyclopentadienyl (tert-butylamide) titanium dichloride
*1Not measurable because of too low molecular weight
*2Not measurable because of too high molecular weight

According to the results shown in Table 3, if the polymer obtained in Example 3 is a simple mixture of a polymer derived from the substance (A1) and a polymer derived from the substance (A2), the N_{LCB} of the polymer obtained in Example 3 should be as follows:

0.23(N_{LCB} of polymer obtained only with substance(A1))×0.82(percentage of the area of peak on lower molecular weight peak)+0.00(N_{LCB} of polymer obtained only with substance(A2))×0.18(percentage of the area of peak on higher molecular weight peak)=0.19.

However, the N_{LCB} of the polymer obtained in Example 3 is 0.32, which is significantly larger than would be expected for a simple mixture.

### Example 4

After drying under reduced pressure, a 5 L autoclave with a stirrer, in which air had been replaced by argon, was vacuumized. Then, 500 ml of toluene serving as a solvent was fed into the autoclave, and the temperature of the autoclave was raised to 70° C. After that, ethylene was added to the autoclave so that its partial pressure was 0.6 MPa, and pressure inside the system was stabilized. To the autoclave, 2.0 ml of a toluene solution of methylaluminoxane, which had been prepared so as to have a concentration of 2.5 mmol/ml, was added. Next, 0.25 ml of a toluene solution of [cycloheptanediyl-trans-1,2-bis(2-oxoyl-3,5-di-tert-butyl benzylsulfanyl)]dichlorozirconium (A1) obtained (in Reference Example 2), which had been prepared so as to have a concentration of 1.0 μmol/ml, and 0.25 ml of a toluene solution of racemic ethylenebis(indenyl)zirconium diphenoxide (A2), which had been prepared so as to have a concentration of 1.0 μmol/ml, were added to the mixture. The mixture was polymerized for 30 minutes at 70° C. while ethylene was fed so that the total pressure was kept constant. As a result, 94.2 g of an ethylene-based polymer was obtained. The polymerization activity of the sum of the substance (A1) and the substance (A2) was 1.9×10⁸ g/mol. The physical properties of the ethylene-based polymer thus obtained are shown in Table 4.

### Example 5

Polymerization was carried out in the same manner as in Example 1 except that 0.4 ml of a toluene solution of [cycloheptanediyl-trans-1,2-bis(2-oxoyl-3,5-di-tert-butyl benzylsulfanyl)]dichlorozirconium (A1), which had been prepared so as to have a concentration of 1.0 μmol/ml, and 0.1 ml of a toluene solution of racemic ethylenebis (indenyl)zirconium diphenoxide (A2), which had been prepared so as to have a concentration of 1.0 μmol/ml, were used. As a result, 39.0 g of an ethylene-based polymer was obtained. The polymerization activity of the sum of the substance (A1) and the substance (A2) was 0.8×10⁸ g/mol. The physical properties of the ethylene-based polymer thus obtained are shown in Table 4.

### Example 6

Polymerization was carried out in the same manner as in Example 1 except that 0.1 ml of a toluene solution of [cycloheptanediyl-trans-1,2-bis(2-oxoyl-3,5-di-tert-butyl benzylsulfanyl)]dichlorozirconium (A1), which had been prepared so as to have a concentration of 1.0 μmol/ml, and 0.4 ml of a toluene solution of racemic ethylenebis (indenyl)zirconium diphenoxide (A2), which had been prepared so as to have a concentration of 1.0 μmol/ml, were used. As a result, 45.4 g of an ethylene-based polymer was obtained. The polymerization activity of the sum of the substance (A1) and the substance (A2) was 0.9×10⁸ g/mol. The physical properties of the ethylene-based polymer thus obtained are shown in Table 4.

TABLE 4

| | | Example 4 | Example 5 | Example 6 |
|---|---|---|---|---|
| Substance (A1) | Complex | a | a | a |
| | species | | | |
| | μmol | 0.25 | 0.4 | 0.1 |
| Substance (A2) | Complex | b | b | b |
| | species | | | |
| | μmol | 0.25 | 0.1 | 0.4 |
| Ethylene partial | MPa | 0.6 | 0.6 | 0.6 |
| pressure | | | | |
| Density | kg/m³ | 966 | — | 965 |
| MFR | g/10 min. | 10.1 | —*1 | 3.9 |
| Molecular weight | — | | | |
| distribution | | | | |
| Mw/Mn | | 6.9 | 7.1 | 7.7 |
| Mz/Mw | | 2.4 | 3.4 | 2.0 |
| H/L | — | 2.0 | 0.62 | 3.9 |
| Peak molecular weight | ×10³ | 69.7 | 67.1 | 70.1 |
| on higher molecular | | | | |
| weight peak | | | | |
| Peak molecular weight | ×10³ | 5.7 | 4.4 | 2.9 |
| on lower molecular | | | | |
| weight peak | | | | |
| Difference between | ×10³ | 64.0 | 62.7 | 67.2 |
| peak molecular weight | | | | |
| on higher molecular | | | | |
| weight peak and that | | | | |
| on lower molecular | | | | |
| weight peak | | | | |
| SR | — | 1.23 | —*1 | 1.19 |
| Characteristic | s | 0.1 | —*1 | 0.6 |
| relaxation time τ | | | | |
| Ea | kJ/molK | 46.8 | —*1 | 50.9 |
| N_{LCB} | 1/1000 C. | 0.12 | 0.13 | 0.06 |

a: [Cycloheptanediyl-trans-1,2-bis (2-oxoyl-3,5-di-tert-butyl benzylsulfanyl)] dichlorozirconium
b: Racemic ethylenebis (indenyl) zirconium diphenoxide
*1Not measurable because of too low molecular weight

### Comparative Example 5

### (1) Preparing Solid Catalyst Component

To a reactor with a stirrer in which air had been replaced by nitrogen, 2.8 kg of silica (Sylopo1948, produced by Davison), which had been subjected to a heat treatment at 300° C. in flowing nitrogen, and 24 kg of toluene were put and were stirred. After that, the mixture was cooled to 5° C., and thereafter a mixed solution of 0.9 kg of 1,1,1,3,3,3-hexamethyldisilazane and 1.4 kg of toluene was dropped to the mixture over 30 minutes while the temperature of the reactor was kept at 5° C. After completion of the dropping, the mixture was stirred at 5° C. for 1 hour, heated to 95° C., stirred at 95° C. for 3 hours, and then filtered. A resultant solid product was washed 6 times with 20.8 kg of toluene. After that, 7.1 kg of toluene was added to the solid product to form slurry, and the slurry was allowed to stand overnight.

To the slurry thus obtained, 1.73 kg of a hexane solution of diethyl zinc (concentration of diethyl zinc: 50 wt. %) and 1.02 kg of hexane were added, and the mixture was stirred. After that, the mixture was cooled to 5° C., and thereafter a mixed solution of 0.78 kg of 3,4,5-trifluorophenol and 1.44 kg of toluene was dropped to the mixture over 60 minutes while the temperature of the reactor was kept at 5° C. After completion of the dropping, the mixture was stirred at 5° C. for 1 hour, heated to 40° C., and then stirred at 40° C. for 1 hour. After that, the mixture was cooled to 22° C., and 0.11 kg of H₂O was dropped to the mixture over 1.5 hours while the temperature of the reactor was kept at 22° C. After completion of the dropping, the mixture was stirred at 22° C. for 1.5 hours, heated to 40° C., stirred at 40° C. for 2 hours, further heated to 80° C., and then stirred at 80° C. for 2 hours. After the stirring, supernatant was removed at room temperature until the amount of the remaining mixture was 16 L, and 11.6 kg of toluene was added. Then, the mixture was heated to 95° C., and stirred for 4 hours. After the stirring, supernatant was removed at room temperature. In this way, a solid product was obtained. The solid product thus obtained, was washed 4 times with 20.8 kg of toluene, and washed 3 times with 24 L of hexane. After that, the solid product was dried to yield a solid catalyst component.

### (2) Polymerization

After drying under reduced pressure, a 3-L autoclave with a stirrer, in which air had been replaced by argon, was vacuumized. Then, hydrogen was added so that its partial pressure was 0.01 MPa. Then, 30 g of 1-butene and 720 g of butane serving as a polymerization solvent were fed, and the temperature of the autoclave was raised to 70° C. After that, ethylene was added so that its partial pressure was 1.6 MPa, and pressure inside the system was stabilized. A gas chromatography analysis of the mixture showed that the gas composition in the system was as follows: hydrogen=0.36 mol % and 1-butene=1.58 mol %. To the mixture, 0.9 ml of a hexane solution of triisobutylaluminum serving as an organoaluminum compound, which had been prepared so as to have a concentration of 1 mol/l, was added. Then, 1.5 ml of a toluene solution of dimethylsilanediylbis (cyclopentadienyl)zirconiumdichloride, which had been prepared so as to have a concentration of 10 μmol/ml, and 0.25 ml of a toluene solution of racemic ethylenebis(1-indenyl)zirconium diphenoxide, which had been prepared so as to have a concentration of 2 μmol/ml, were added, and subsequently 148.8 mg of the solid catalyst component obtained in the above (1) was added. The mixture was polymerized at 70° C. for 60 minutes while being continuously supplied with ethylene gas so that the total pressure was kept constant. After that, butane, ethylene and hydrogen were purged to yield 188 g of an ethylene-1-butene copolymer. The polymerization activity of the sum of dimethylsilanediylbis(cyclopentadienyl)zirconiumdichloride and racemic ethylenebis(1-indenyl)zirconium diphenoxide was 0.1×10⁸ g/mol. The physical properties of the copolymer thus obtained are shown in Table 5.

TABLE 5

| | | Comparative |
|---|---|---|
| | | Example 5 |
| Complex e | μmol | 15 |
| Complex b | μmol | 0.5 |
| Ethylene partial | MPa | 1.6 |
| pressure | | |
| Density | kg/m³ | 930 |
| MFR | g/10 min. | 0.99 |
| Molecular weight distribution | | |
| Mw/Mn | — | 7.9 |
| Mz/Mw | | 3.3 |
| H/L | — | 0.66 |
| Peak molecular weight on | ×10³ | 280 |
| higher molecular weight peak | | |
| Peak molecular weight on lower | ×10³ | 47 |
| molecular weight peak | | |
| Difference between peak | ×10³ | 233 |
| molecular weight on higher | | |
| molecular weight peak and that | | |
| on lower molecular weight peak | | |
| SR | — | 1.13 |
| MT | cN | 13.8 |
| MTV | m/min. | 1.0 |
| Characteristic relaxation time τ | s | 0.2 |
| Ea | kJ/molK | 55.0 |
| N_{LCB} | 1/1000 C. | — |

Complex b: Racemic ethylenebis (indenyl) zirconium diphenoxide
Complex e: Dimethylsilanediylbis (cyclopentadienyl) zirconiumdichloride

1. A method for producing an olefin polymer, the method comprising:
polymerizing olefin monomers using the following substance (A1), the following substance (A2), and an activating agent (B),
the substance (A1) being a complex represented by the following general formula (1-1) or (1-2), 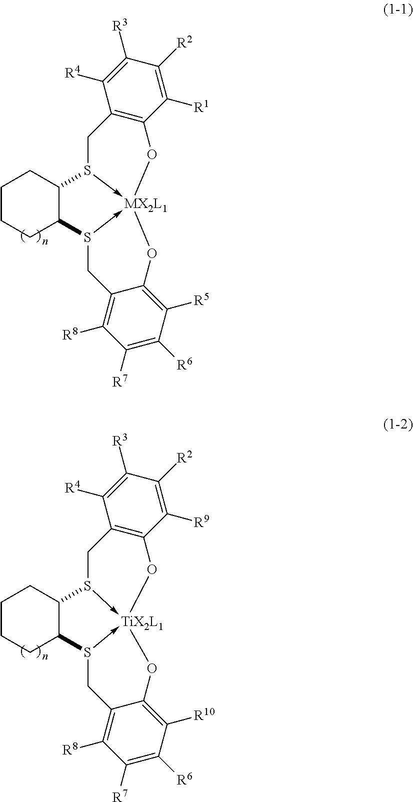
where:
n is 1, 2, or 3;
M is a zirconium atom or a hafnium atom;
R¹ and R⁵ are independently:
a hydrogen atom,
a halogen atom,
an alkyl group having 1 to 20 carbon atoms,
a cycloalkyl group having 3 to 10 ring carbon atoms,
an alkenyl group having 2 to 20 carbon atoms,
an alkynyl group having 2 to 20 carbon atoms,
an aralkyl group having 7 to 30 carbon atoms,
an alkoxy group having 1 to 20 carbon atoms,
an aralkyloxy group having 7 to 30 carbon atoms,
an aryloxy group having 6 to 30 carbon atoms, or
a substituted silyl group;
R² to R⁴ and R⁶ to R¹⁰ are independently
a hydrogen atom,
a halogen atom,
an alkyl group having 1 to 20 carbon atoms,
a cycloalkyl group having 3 to 10 ring carbon atoms,
an alkenyl group having 2 to 20 carbon atoms,
an alkynyl group having 2 to 20 carbon atoms,
an aralkyl group having 7 to 30 carbon atoms,
an aryl group having 6 to 30 carbon atoms,
an alkoxy group having 1 to 20 carbon atoms,
an aralkyloxy group having 7 to 30 carbon atoms,
an aryloxy group having 6 to 30 carbon atoms,
a substituted silyl group, or
a heterocyclic compound residue having 3 to ring carbon atoms;
the alkyl groups, the cycloalkyl groups, the alkenyl groups, the alkynyl groups, the aralkyl groups, the aryl groups, the alkoxy groups, the aralkyloxy groups, the aryloxy groups, and the heterocyclic compound residues represented by R¹ to R¹⁰ each may have a substituent;
notwithstanding the above definitions of R¹ to R¹⁰, at least one pair of groups selected from among the following pairs, R¹ and R², R² and R³, R³ and R⁴, R⁵ and R⁶, R⁶ and R⁷, R⁷ and R⁸, R² and R⁹, and R⁶ and R¹⁰, may be linked to form a ring which may have a substituent;
each x is independently:
a hydrogen atom,
a halogen atom,
an alkyl group having 1 to 20 carbon atoms,
a cycloalkyl group 3 to 10 ring carbon atoms,
an alkenyl group having 2 to 20 carbon atoms,
an aralkyl group having 7 to 30 carbon atoms,
an aryl group having 6 to 30 carbon atoms,
an alkoxy group having 1 to 20 carbon atoms,
an aralkyloxy group having 7 to 30 carbon atoms,
an aryloxy group having 6 to 30 carbon atoms,
a substituted silyl group,
a substituted amino group,
a substituted thiolate group, or
a carboxylato group having 1 to 20 carbon atoms;
the alkyl group, the cycloalkyl group, the alkenyl group, the aralkyl group, the aryl group, the alkoxy group, the aralkyloxy group, and the aryloxy group represented by X may have a substituent;
adjacent X groups may be linked to each other to form a ring;
L is independently a neutral Lewis base, and 1 is 0, 1, or 2; when 1 is 2, the L groups are the same or different, and,
the substance (A2) being a transition metal compound represented by the general formula (8) or a μ-oxo-type dimer of a transition metal compound represented by the general formula (8): 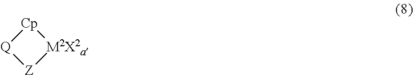
where:
M² is a transition metal atom of any of Groups 4 to 11 of the periodic table of the elements;
Cp is a group having a cyclopentadienide skeleton, and Z is a group having a cyclopentadienide skeleton or a group containing a hetero atom;
Q is a bridging group which links a cyclopentadienyl group to Z; Cp and Z are the same or different when each of Cp and Z is a group having a cyclopentadienide skeleton;
each X² is independently:
a hydrogen atom,
a halogen atom,
an alkyl group having 1 to 20 carbon atoms,
a cycloalkyl group having 3 to 10 ring carbon atoms,
an alkenyl group having 2 to 20 carbon atoms,
an aralkyl group having 7 to 30 carbon atoms,
an aryl group having 6 to 30 carbon atoms,
an alkoxy group having 1 to 20 carbon atoms,
an aralkyloxy group having 7 to 30 carbon atoms,
an aryloxy group having 6 to 30 carbon atoms,
a substituted silyl group,
a substituted amino group,
a substituted thiolate group, or
a carboxylato group having 1 to 20 carbon atoms; and
a′ is a number which satisfies 1≦a′≦3.

2. The method as set forth in claim 1, wherein in the step of polymerizing olefin monomers,
olefin monomers are polymerized using the substance (A1) and the activating agent (B); and then
olefin monomers are polymerized using the substance (A2) and the activating agent (B).

3. The method as set forth in claim 1, wherein the activating agent (B) is a boron compound or an organoaluminum compound.

4. The method as set forth in claim 1, wherein
R¹ and R⁵ in the general formula (1-1) are independently:
a halogen atom,
an alkyl group having 1 to 20 carbon atoms,
a cycloalkyl group having 3 to 10 carbon atoms,
an aralkyl group having 7 to 30 carbon atoms, or
a substituted silyl group.

5. The method as set forth in claim 1, wherein
R⁹ and R¹⁰ in the general formula (1-2) are independently:
a halogen atom,
an alkyl group having 1 to 20 carbon atoms,
a cycloalkyl group having 3 to 10 carbon atoms,
an aralkyl group having 7 to 30 carbon atoms,
an aryl group having 6 to 30 carbon atoms,
a substituted silyl group, or
a heterocyclic compound residue having 3 to 20 carbon atoms.

6. The method as set forth in claim 1, wherein the olefin monomers are only ethylene monomers.

7. The method as set forth in claim 1, wherein the olefin monomers comprise ethylene monomers and α-olefin monomers having 3 to 20 carbon atoms.

8. An ethylene-based polymer that satisfies the following requirements (1) to (5):
(1) the density is 850 to 980 kg/m³;
(2) the melt flow rate is within the range of 0.01 to 100 g/10 min, where the melt flow rate is measured by method A provided in JIS K7210-1995 at a temperature of 190° C. under an applied load of 21.18 N;
(3) the molecular weight distribution curve measured by gel permeation chromatography has bimodal molecular weight distribution, the molecular weight distribution curve exhibiting a higher molecular weight peak having a peak top molecular weight of 50,000 or more, and a lower molecular weight peak having a peak top molecular weight of 10,000 or less;
(4) the weight-average molecular weight to number-average molecular weight ratio is from 4 to 55; and
(5) the number of branches having 5 or more carbon atoms measured by ¹³C-NMR is 0.2 to 0.7 per 1000 carbon atoms.

9. An article produced by extruding the ethylene-based polymer as set forth in claim 8.
